(19) United States
(12) Patent Application Publication
(10) Pub. No.: US 2026/0040040 A1
(43) Pub. Date: Feb. 5, 2026

(54) MANAGING, TRACKING, AND COMMUNICATING OF STATE OF COMPONENTS ASSOCIATED WITH AN UNPOWERED VEHICLE

(71) Applicant: Charles M. Link, II, Atlanta, GA (US)

(72) Inventor: Charles M. Link, II, Atlanta, GA (US)

(21) Appl. No.: 19/284,249

(22) Filed: Jul. 29, 2025

Related U.S. Application Data
(60) Provisional application No. 63/677,203, filed on Jul. 30, 2024.

(51) Int. Cl. H04W 4/38; H04W 4/40; H04W 4/80

(52) U.S. Cl. CPC H04W 4/38; H04W 4/40; H04W 4/80

(57) ABSTRACT

A taillight assembly comprising long-range radio module/circuitry, GNSS location determination circuitry, and secondary short-range radio module/circuitry may be configured to receive messages from various sensors, equipment, and cargo to verify proper operating conditions, determine or notify of potential theft, and facilitate cargo carriage. The short-range and long-range modules may comprise authentication checking to authenticate messages and the priority of messages. Sensors of the taillight assembly may be used to determine removal of, or damage to, the taillight assembly. Remote sensors may be used to transmit, to the short-range module, information indicative of removal or theft of the trailer from a towing vehicle or other condition, and the long-range circuitry may transmit an indication of the theft, removal, or condition, to a third party. Circuitry of the taillight assembly may be powered by a battery within the taillight assembly that is charged during operation of the taillight.

### REFERENCE TO RELATED APPLICATIONS

The subject patent application claims priority under 35 USC § 119 to U.S. Provisional Patent Application No. 63/677,203, filed Jul. 30, 2024, and entitled “METHOD AND SYSTEM FOR EFFECTIVE MANAGEMENT AND TRACKING OF AN UNPOWERED, NON-AUTOMOTIVE VEHICLES AND ASSOCIATED ASPECTS OF VEHICLE”, the entirety of which application is hereby incorporated by reference herein.

### BACKGROUND

Telematics refers to the integrated use of telecommunications devices and systems and information storage, usage, transmitting, receiving, and processing. More simply, telematics refers to sending, receiving and storing, information via telecommunication devices. In addition, telematics devices and systems have been applied alongside Global Positioning System (“GPS”) technology integrated with computers and mobile communications technology in vehicle information and navigation systems.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise receiving, by at least one wireless communication device comprising at least one processor from at least one sensor, at least one sensor signal corresponding to a vehicle and analyzing, by the at least one wireless communication device, the at least one sensor signal with respect to at least one sensor signal criterion to result in at least one analyzed sensor signal. Based on the at least one analyzed sensor signal being determined to satisfy the at least one sensor signal criterion, the method may further comprise performing, by the at least one wireless communication device, at least one action with respect to the vehicle. In an example embodiment, the at least one sensor may be a sensor that is part of the at least one wireless communication device. In an example embodiment, the at least one sensor may be a sensor that is remote from the at least one wireless communication device. The at least one remote sensor may transmit signals to the at least one wireless communication device at least one signal indicative of a condition corresponding to the vehicle. The at least one sensor signal criterion may correspond to the at least one sensor signal comprising information indicative of an adverse condition corresponding to the vehicle, such as, for example, the vehicle or a component corresponding thereto being stolen, a maintenance criterion being violated, or that violation of the maintenance criterion is imminent based on the adverse condition, a configured location or location coordinates, or the at least one sensor signal comprising information indicative of a sensitive or urgent condition corresponding to the vehicle. In an example embodiment, the at least one sensor signal criterion may be satisfied if a determination is made that the at least one signal comprises information related to, or pertinent to, the vehicle and that is not related to another vehicle or another wireless communication device that may be within a short range wireless communication link range of the at least one wireless communication device. In an example embodiment, the at least one sensor signal criterion may correspond to a configured periodicity according to which sensor signals are to be transmitted by the at least one wireless communication device. In an example embodiment, the at least one sensor signal criterion may correspond to, or may be based on, a battery charge level corresponding to the at least one wireless communication device.

In an example embodiment, tampering with, or movement of the at least one wireless communication device with respect to the vehicle, may cause the at least one sensor signal to be generated, changed, or altered by the at least one sensor. The at least one sensor may be a hall effect sensor located with respect to a magnet search that movement of the at least one wireless communication device with respect to the vehicle causes a disturbance of magnetic field measured by the hall effect sensor and this causes the at least one hall effect sensor to communicate the at least one sensor signal to the at least one wireless communication device.

In an example embodiment, the at least one sensor may comprise at least one hall-effect sensor and wherein the at least one sensor signal is generated, changed, or altered by the at least one hall-effect sensor being moved within a magnetic field. In example embodiment, the at least one wireless communication device may comprise the at least one hall-effect sensor.

In an example embodiment, the at least one wireless communication device may comprise a magnetic component, such as a magnet, that is configured or located to produce the magnetic field detectable by the at least one hall-effect sensor.

In an example embodiment, the vehicle produces or affects the magnetic field. Movement of the at least one wireless communication device with respect to the vehicle and within a changing magnetic field caused by the movement may cause the at least one hall-effect sensor to output an electrical signal indicative of the movement.

In an example embodiment, the at least one wireless communication device comprises at least one component that produces the magnetic field.

In an example embodiment, a vehicle light assembly comprises the at least one wireless communication device. In example embodiment, the vehicle light assembly comprises a taillight assembly.

In an example embodiment, the at least one sensor signal may be indicative of at least one pressure corresponding to the tampering with the at least one wireless device, and wherein the at least one sensor signal criterion corresponds to a configured change in the at least one pressure.

In an example embodiment, the performing of the at least one tracking action may comprise transmitting, via a long-range wireless communication network, an alert signal indicative of the tampering with, or movement with respect to the vehicle of, the at least one wireless communication device.

In another example embodiment, a light device may comprise at least one processor configured to process executable instructions that, when executed by the at least one processor, facilitate performance of operations that may comprise receiving, from at least one sensor, at least one sensor signal associated with a vehicle and analyzing the at least one sensor signal with respect to at least one sensor signal criterion to result in at least one analyzed sensor signal. Based on the at least one analyzed sensor signal being determined to satisfy the at least one sensor signal criterion, the operations may further comprise facilitating directing, via a long-range wireless communication network to a telematics application, at least one alert message indicative of at least one state of at least one component associated with the vehicle.

In an example embodiment, the light device may be coupled to the vehicle. The light device may comprise the at least one sensor. The at least one sensor may comprise at least one hall effect sensor or at least one pressure sensor. The light device may be configured to detect removal of the light device from the vehicle based on movement of the hall effect sensor within a magnetic field that is altered by the removal of the light device from the vehicle or by a change in pressure inside a sealed volume of the light device detected by the pressure sensor. The at least one analyzed sensor signal may be determined to satisfy the at least one sensor signal criterion if a change of a magnetic field magnitude corresponding to the magnetic field is determined by the processor to equal or exceed a magnetic field magnitude change criterion value.

In an example embodiment, the light device may define a sealed inner volume, wherein the inner volume is configured to maintain an internal pressure, wherein the light device comprises the at least one sensor inside the inner volume, wherein the at least one sensor comprises at least one barometric pressure sensor, and wherein the at least one analyzed sensor signal being determined to satisfy the at least one sensor signal criterion corresponds to the internal pressure changing by an amount equal to, or greater than, a configured pressure change value.

In an example embodiment, the at least one sensor signal may be received via a short-range wireless signal. In an example embodiment, the short-range wireless signal may be a Bluetooth Low Energy beacon signal. In an example embodiment, the short-range wireless signal may be a Bluetooth connection signal that is received via a Bluetooth device paired to a short-range module of the light device. In an example embodiment, the short-range wireless signal may be received via a connectionless wireless communication protocol.

In an example embodiment, the vehicle may comprise a trailer. The trailer may comprise the at least one sensor. The at least one component may be at least one component of the trailer. The at least one sensor signal is indicative of the at least one state or condition corresponding to the at least one component of the trailer.

In an example embodiment, the vehicle may comprise a trailer. A towing vehicle may be coupled to the trailer. The towing vehicle may comprise the at least one sensor. The at least one component may be at least one component of the towing vehicle. The at least one sensor signal may be indicative of at least one state or condition corresponding to at least one component of the towing vehicle.

In yet another example embodiment, a non-transitory machine-readable medium may comprise executable instructions that, when executed by at least one processor of at least one taillight telematics control unit associated with a vehicle, facilitate performance of operations, that may comprise receiving, from at least one sensor, at least one sensor signal indicative of at least one condition associated with the vehicle. Responsive to the at least one sensor signal, the operations may further comprise directing, via a long-range wireless communication network to a telematics application, at least one message indictive of the at least one condition. The telematics application may be operative on, or executed by, at least one computing component corresponding to a telematics operations center server.

In an example embodiment, the at least one taillight telematics control unit may comprise the at least one sensor. The at least one condition may be, or may correspond to, at least one of: removal of the at least one taillight telematics control unit from being coupled to, or installed on, the vehicle or tampering with the at least one taillight telematics control unit while the at least one taillight telematics control unit is coupled to, or installed on, the vehicle.

In an example embodiment, the vehicle may comprise a trailer. A tow vehicle may be coupled with the vehicle. The tow vehicle may comprise the at least one sensor. The at least one sensor signal may be received via a short-range wireless signal. The at least one sensor signal may be indicative of at least one condition corresponding to the tow vehicle.

### BRIEF DESCRIPTION OF THE DRAWINGS

FIG. 1 illustrates wireless communication system environment.

FIG. 2A and FIG. 2B illustrate example wiring diagrams for simple trailer lighting that meets typical minimum government highway use requirements.

FIG. 3 illustrates an example wiring diagram for a semi-trailer.

FIG. 4 illustrates an example semi-trailer.

FIG. 5 illustrates an example container chassis.

FIG. 6 illustrates a flow diagram of an example embodiment method to process signals generated by sensors that are remote with respect to a taillight telematics control unit.

FIG. 7 illustrates universal marking standards typically used by intermodal shipping industry participants to facilitate marking intermodal containers.

FIG. 8 illustrates a typical light utility trailer taillight.

FIG. 9 illustrates a typical 4-inch round trailer taillight used by a semi-trailer.

FIG. 10 illustrates a typical oval trailer taillight that might be used on a box trailer.

FIG. 11 illustrates a flow diagram of an example embodiment method to use a vehicle light assembly to receive and transmit information corresponding to a vehicle.

FIG. 12 illustrates a component block diagram of an example embodiment vehicle light assembly with at least one Hall effect sensor and a power supply system.

FIG. 13A illustrates a Bluetooth packet format usable to transmit example embodiment messages via a beacon.

FIG. 13B illustrates an example embodiment message format usable to transmit example embodiment message information from sensors remote from a taillight telematics control unit to the taillight telematics control unit.

FIG. 14 illustrates a 53-foot semi-trailer side view with sensor points of interest.

FIG. 15 illustrates a back view of a semi-trailer showing a possible location for a taillight tracking device with example Bluetooth gateway and additional sensor points of interest on the back of the trailer.

FIG. 16 illustrates a light utility trailer with mounting location for a taillight tracking device with example embodiment Bluetooth gateway and additional sensor points of interest for a light utility trailer.

FIG. 17 illustrates a taillight typically used with a light utility trailer.

FIG. 18 illustrates a box trailer.

FIG. 19 illustrates and external view of an example embodiment oval taillight tracker.

FIG. 20 illustrates an example embodiment Bluetooth-enabled Kingpin lock.

FIG. 21 illustrates an example embodiment Bluetooth-enabled landing gear tampering detection embodiment.

FIG. 22 illustrates a Bluetooth TPMS sensor with a pressure sensor that incorporates a 2-axis accelerometer for wheel accumulated tick counting and tire pressure, tire temperature, and sensor battery voltage.

FIG. 23 illustrates external tire pressure sensors.

FIG. 24 illustrates a Bluetooth-enabled brake temperature sensor assembly usable on a semi-tractor/trailer rig to indicate brake maladjustment and overheating.

FIG. 25 illustrates example embodiment Bluetooth-enabled air scales to detect trailer loading conditions.

FIG. 26 illustrates typical semi-truck air suspension components at the rear of a semi-truck/semi-tractor.

FIG. 27 illustrates typical semi-trailer suspension components that facilitate air suspension on the trailer.

FIG. 28 illustrates an example embodiment Bluetooth-enabled wheel bearing temperature sensor that may be used with light utility trailers and boat trailers.

FIG. 29 illustrates a Bluetooth-enabled door sensor usable to facilitate alerting owners/operators of trucks and intermodal containers with respect to container door openings and closings.

FIG. 30 illustrates a Bluetooth-enabled 60 GHz pulse radar device that is mountable on a rear door of a trailer and that may be used to measure physical loading of freight objects that might be loaded in a trailer.

FIG. 31 illustrates a Bluetooth-enabled temperature and humidity sensor.

FIG. 32 illustrates a typical light duty trailer hitch coupler and trailer hitch components.

FIG. 33 illustrates use of a typical light duty tailer hitch coupler.

FIG. 34 illustrates the front view of an example embodiment Bluetooth-enabled universal trailer hitch lock to facilitate alerting trailer owners regarding tampering or removal of the hitch lock.

FIG. 35 illustrates side and back views of an example embodiment Bluetooth-enabled universal trailer hitch lock with a positioned hall effect sensor.

FIG. 36 illustrates a vibration sensor usable on a trailer to facilitate generating or transmitting alerts regarding to vehicle tire problems, or other problems, that manifest as vibration.

FIG. 37 illustrates a Bluetooth-enabled bolt removal alarm usable to facilitate alerting of removal of an outboard motor from a boat.

FIG. 38 illustrates a Bluetooth-enabled bolt removal alarm installed on an outboard motor securing bolt.

FIG. 39 illustrates an advanced pallet whereupon a Bluetooth-enabled sensor containing an accelerometer, and a temperature/humidity sensor could be advantageously installed.

FIG. 40 illustrates a traditional wooden pallet location where a Bluetooth enabled sensor containing an accelerometer and a temperature/humidity sensor could be advantageously installed.

FIG. 41 illustrates an example Bluetooth-enabled pallet tracking device.

FIG. 42 illustrates an example Bluetooth-enabled tag device.

FIG. 43 illustrates the inside of a container door where a Bluetooth-enabled door opening sensor could be advantageously installed.

FIG. 44 illustrates a 40-foot container chassis that an intermodal company might use for large loads that are transported on a railroad or container ship before being delivered to a shipping destination.

FIG. 45 illustrates a typical semi-trailer equipped with at least one refrigeration cooling unit.

FIG. 46 illustrates a typical refrigeration cooling unit used on a container or trailer.

FIG. 47 illustrates a Bluetooth-enabled passive CAN bus sensor that is usable to decode messages on a CAN bus of a refrigeration unit on a tractor trailer to facilitate indication of trailer or refrigeration unit operation status or fuel quantity.

FIG. 48 illustrates a bar magnet and magnetic field lines indicative of magnetic field, corresponding to the magnet, in free space.

FIG. 49A illustrates an example embodiment Hall-effect chip and small magnet arrangement with respect to a ferromagnetic material.

FIG. 49B illustrates another example embodiment Hall-effect chip and small magnet arrangement with respect to a ferromagnetic material.

FIG. 50 illustrates magnetic field lines corresponding to magnetic field, created by a small magnet, in free space.

FIG. 51 illustrates magnetic field lines corresponding to magnetic field, created by a small magnet, in free space and modified or disturbed by a ferromagnetic material, which a trailer may constructed of, that is proximate the small magnet.

FIG. 52 illustrates an example embodiment combination arrangement of at least one Hall-effect sensor and at least one magnet.

FIG. 53 illustrates simple Bluetooth advertising signaling.

FIGS. 54A and 54B illustrate the effect of increasing time between sensor advertisements.

FIG. 55 illustrates an example of a poor selection of intervals for sensors and Bluetooth Low Energy intervals.

FIG. 56 illustrates a block diagram and an interworking diagram of an example accelerometer.

FIG. 57 illustrates force vectors that are detectable by an example 3-axis accelerometer.

FIG. 58 illustrates components of an accelerometer chip.

FIG. 59 illustrates light sensor circuitry.

FIG. 60 illustrates simple Bluetooth frequency hopping usable to minimize effects of noise with respect to communication between Bluetooth slaves and a Bluetooth scanning master gateway.

FIG. 61 illustrates a block diagram of an example method embodiment.

FIG. 62 illustrates a block diagram of an example light device.

FIG. 63 illustrates a block diagram of an example non-transitory machine-readable medium embodiment.

FIG. 64 illustrates a block diagram of an example wireless user equipment.

FIG. 65 illustrates an example computer environment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

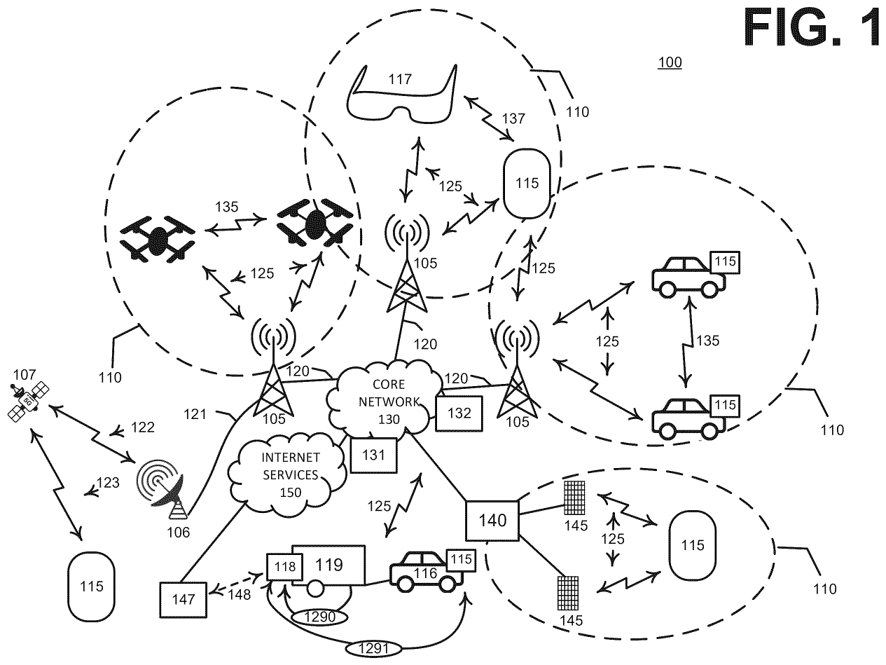

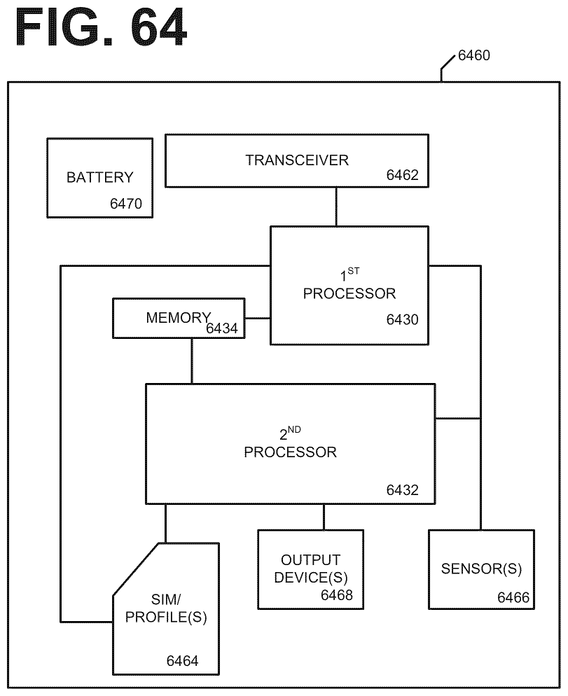

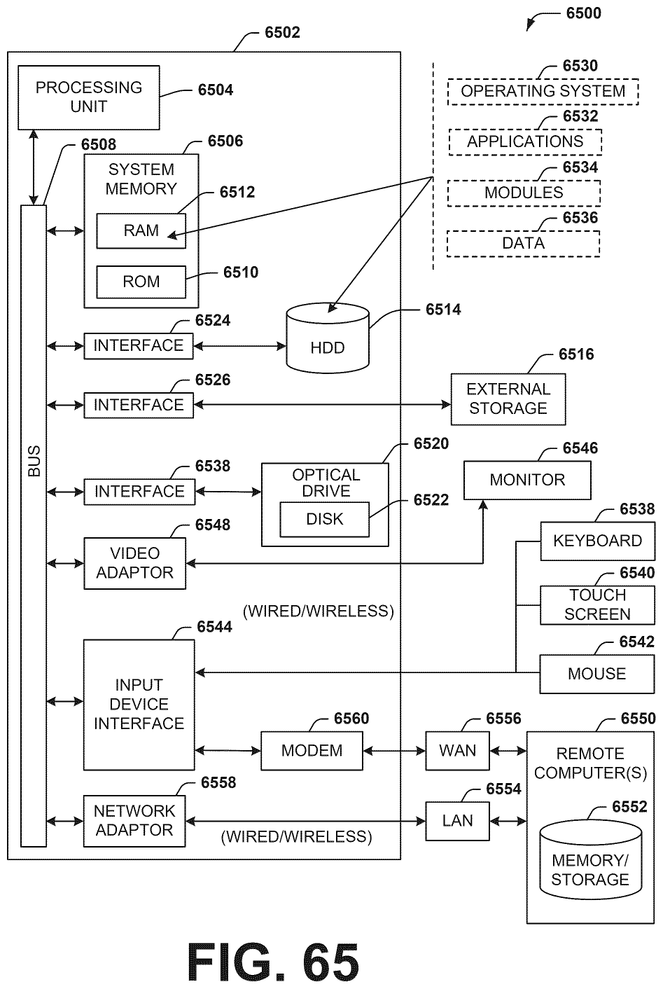

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, such as extended reality (“XR”) appliance 117, may transmit or receive wireless signals with a RAN base station 105 via a long-range wireless link 125, or the UE/XR appliance may receive or transmit wireless signals via a short-range wireless link 137, which may comprise a wireless link with a UE device 115, such as a Bluetooth link, a Wi-Fi link, and the like. A UE may simultaneously communicate via multiple wireless links, such as over a link 125 with a RAN base station 105 and over a short-range wireless link. XR appliance 117 may also communicate with a wireless UE via a cable, or other wired connection. An XR appliance 117 may offload processing functionality or functionality related to communicating with a RAN, to a user equipment 115, which may be referred to as an intermediate user equipment or an XR processing unit. A TCU, a tracking device, an XR processing unit, or a RAN, or a component thereof, may be implemented by one or more computer components that may be described in reference to FIG. 65 and may comprise components described in reference to FIG. 64.

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHZ)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IOT), enhanced mobile broadband (cMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

In FIG. 1, vehicle 116, which may comprise a UE/telematics control unit 115, such as, for example, a telematics control unit located inside a vehicle light assembly such as a tail light or a boat stern light, is shown towing vehicle/trailer UE 118, which may comprise at least one tracking device 118, such as, for example, at least one taillight tracking device described herein according to at least one example embodiment. Vehicle UE telematics control unit (“TCU”) 115 or tracking device 118 may be wirelessly connected to a RAN 105 directly or via at least one sidelink relay to in-RAN-coverage-range vehicle UE. A vehicle TCU 115 or Taillight TCU 118 may communicate messages generated internally by the TCU or that may be received via short range wireless communication (e.g., Bluetooth, Bluetooth Low Energy, Wi-Fi, sidelink, and the like) from a sensor located on vehicle 116 or trailer 119 to a cloud-based server 147, which may be referred to as a telematics operations center (“TOC”), that may provide fleet telematics and management services with respect to vehicle 116 or trailer 119. TCU 118 may receive power, for example 12-volt direct current power, from a lighting harness corresponding to trailer 119 when the trailer is coupled to vehicle 116 and when the lighting harness is coupled to a tail light plug, socket, adapter, connector, or other similar means for providing electricity to operate tail lights, brake lights, running lights, etc. corresponding to the trailer when an operator of vehicle 116 turns on tail lights of the vehicle, applies brakes of the vehicle, turns on running lights of the vehicle, etc. 12-volt power received by TCU 118 via a lighting harness corresponding to trailer 119 may be used to charge at least one battery of the TCU. It will be appreciated that circuitry corresponding to TCU 118 may be enclosed by a housing comprising a tail light lens, or other light lens, and an opaque portion that together with the lens may form a sealed chamber. An example embodiment lighting assembly comprising TCU 118 may be installed in place of a conventional lighting assembly, for example an example embodiment tail light assembly as described elsewhere herein may be used to replace a conventional tail light assembly that provides lighting functionality but that does not comprise other novel Functionality as described elsewhere herein. TCU 118 or TCU 115 may communicate via long range wireless communication link 125 to a radio access network node 105. Messages transmitted to or received from a radio access network node 105 may be directed to or directed from TOC cloud server 147 via Internet 150 and core network 130. Virtual link 148 shown in FIG. 1 is illustrated using dashed lines to indicate that TCU 118 or TCU 115 does not communicate directly with TOC cloud server 147 but that, according to example embodiments disclosed herein, messages processed by TCU 118 or TCU 115 may be communicated with the cloud server 147 via a RAN node 105, core network 130 and internet 150. TCU 118, or TCU 115, may receive vehicle information signals 1290 that may be generated by various sensors placed on, located on, located in, or otherwise corresponding to trailer 119 or vehicle 116. Signals 1290 may be transmitted via short range wireless communication links according to at least one short range wireless communication protocol such as, for example, Bluetooth Low Energy (“BLE”), Ultra Wide Band, Wi-Fi, EnOcean, Zigbee, Nearfield (“NFC”), LPWAN, IEEE 802.15.4, Classic Bluetooth, Z-Wave, Infrared Radiation (“IR”), IEEE 802.22, 6LoWPAN, RFID, Thread or any other unnamed short range wireless communication protocol. At least one signal 1290 may comprise information indicative of at least one vehicle condition corresponding to trailer 119 or vehicle 116. It will be appreciated that trailer 119 may be referred to herein as a vehicle or a towed vehicle and that vehicle 116 may be referred to here-in as a towing vehicle. In an example embodiment, TCU 118 corresponding to towed vehicle 119 may be configured to communicate at least one signal 1291 with TCU 115 corresponding to towing vehicle 116. For example, at least one accelerometer and/or gyroscope sensor that may be part of TCU 118 may detect sway, or ‘fishtailing’, of towed vehicle 119 and may direct, via a wireless communication link, at least one information signal indicative of the fish tailing to TCU 115. TCU 115 may determine at least one action to take to mitigate, or minimize, the fish tailing by, for example, initiating at least one anti-lock braking action or at least one traction control action to be performed by towing vehicle 116 or towed vehicle 119. Such an example embodiment may be included in, or may be facilitated by, a ‘trailering app’ that may be accessed via a display in a cab or cabin corresponding to towing vehicle 116. Another example embodiment, circuitry corresponding to TCU 118 may comprise at least one camera that may generate at least one signal that may be usable to, for example, mitigate fish tailing, or that may be usable to facilitate ‘backing’ towed vehicle 119 by towing vehicle 116. A signal generated by the at least one camera may be directed to TCU 115 via at least one signal 1291.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105 and thus may facilitate efficient TN-NTN system integration without private terrestrial network information being shared with a non-terrestrial network, and vice versa.

Turning now to FIG. 64, the figure illustrates a block diagram of an example user equipment device 6460, for example a smartphone, a table, or a tracking device, such as, for example, a taillight tracking device 1200 as disclosed herein. UE 6460 may comprise a smart phone, a wireless tablet, a laptop computer with wireless capability, a wearable device, a machine device that may facilitate vehicle telematics, and the like. UE 6460 comprises a first processor 6430, a second processor 6432, and a shared memory 6434. UE 6460 includes radio front end circuitry 6462, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 6462 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 64, UE 6460 may also include a SIM 6464, or a SIM profile, which may comprise information stored in a memory (memory 34 or a separate memory portion), for facilitating wireless communication with RAN 105 or core network 130 shown in FIG. 1. FIG. 64 shows SIM 6464 as a single component in the shape of a conventional SIM card, but it will be appreciated that SIM 6464 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 6464 and another device, which may be a component of RAN 105 or core network 130 shown in FIG. 1). A SIM profile 6464 may also comprise identifying information that is unique to the SIM, or SIM profile, such as, for example, an International Mobile Subscriber Identity (“IMSI”) or information that may make up an IMSI.

SIM 6464 is shown coupled to both the first processor portion 6430 and the second processor portion 6432. Such an implementation may provide an advantage that first processor portion 6430 may not need to request or receive information or data from SIM 6464 that second processor 6432 may request, thus eliminating the use of the first processor acting as a ‘go-between’ when the second processor uses information from the SIM in performing its functions and in executing applications. First processor 6430, which may be a modem processor or baseband processor, is shown smaller than processor 6432, which may be a more sophisticated application processor, to visually indicate the relative levels of sophistication (i.e., processing capability and performance) and corresponding relative levels of operating power consumption levels between the two processor portions. Keeping the second processor portion 6432 asleep/inactive/in a low power state when UE 6460 does not request (or invoke or need) it for executing applications and processing data related to an application provides an advantage of reducing power consumption when the UE only requests (or needs) to use the first processor portion 6430 while in listening mode for monitoring routine configured bearer management and mobility management/maintenance procedures, or for monitoring search spaces that the UE has been configured to monitor while the second processor portion remains inactive/asleep.

UE 6460 may also include sensors 6466, such as, for example, temperature sensors, accelerometers, gyroscopes, barometers, moisture sensors, and the like that may provide signals to the first processor 6430 or second processor 6432. Output devices 6468 may comprise, for example, one or more visual displays (e.g., computer monitors, VR appliances, and the like), acoustic transducers, such as speakers or microphones, vibration components, and the like. Output devices 6468 may comprise software that interfaces with output devices, for example, visual displays, speakers, microphones, touch sensation devices, smell or taste devices, and the like, that are external to UE 6460. Battery 6470 may be rechargeable and may provide power for various components and circuitry corresponding to 6460.

Other than the convergence of telecommunications and information processing, the term telematics may also refer to automation of various processes relating to the driving and using of vehicles. For example, a telematics system can report operational issues to the cloud-based servers to provide important user and driver notification of situations of interest using a wireless communications network, or a message sent electronically over a network, including a wireless communications network and the internet. Telematics also includes services such as GPS tracking, wireless safety communications such as tire pressure and brake temperature.

In the world of connected devices, almost all modern powered vehicles have some sort of telematics communications system. Nearly every automobile manufactured in the last few years has some kind of communications device that provides connectivity options enabling everything from stolen vehicle tracking to over-the-air software updates. Nearly every semi-truck (also known as tractor) has connectivity to the vehicle, ranging from Electronic Logging Devices (“ELD”)] and Hours of Service (“HOS”) recording to real-time dash cams to record operational aspects of both the vehicle's driver but more importantly the events outside the cab, including front, side and rear views of the vehicle. In many industries, liability insurance is nearly impossible to purchase unless the real-time dash cams are present and operational.

Most of the systems installed in powered vehicles are significantly, if not exclusively, for the purpose of managing the towing vehicle. Rarely do the systems extend beyond the towing vehicle. Even with important system requiring nearly continuous monitoring, such as refrigerated trailers, the towing vehicle's system rarely extends beyond the domain of the towing tractor. Semi-trailers are rarely connected with any communications equipment, even to the semi-truck doing the towing. Refrigerated trailers depend on separate monitoring systems installed as part of the cooling equipment, providing operational and informational notifications for the cooling equipment but little else.

Trailers range in size from small two wheeled “tag-along” motorcycle trailers to nearly 60-foot-long semi-trailers. A semi-trailer is named as such because it is a trailer without a front axle. In some countries like Canada, doubles or twins can operate with two standard 53-foot semi-trailers pulled by a single semi-truck. The size does not matter much as operation is nearly the same on all the trailers. Many of the larger trailers are enclosed or flatbed trailers but the smaller trailers may be open more often than not. In the United States there are over 45 million registered trailers used for everything from lawn mowers and other landscaping equipment to leisure and fishing boats to heavy equipment. Small enclosed box trailers are used for many purposes ranging from hauling furniture and accessories and other belongings from state to state (e.g., u-Haul) to small mobile workshops used by the trades to store tools and other equipment that might be used on a job site.

Virtually every trailer has common elements. A hitching mechanism to attach the non-powered vehicle to a powered vehicle for moving the trailer from place to place. Another common feature is tires. Many semi-trailers have eight wheels while a few semi-trailers contain more or less depending upon the weight carried by the trailer. A few special purpose trailers contain just one tire. And the last common feature is lights on the sides and rear of the trailer. Taillights and brake lights are required for all trailers in the US. Turn indicator lights (turn signals) are required if the towing vehicle signal lights are not visible.

The power and control for the taillights, brake lights and turn signal lights is provided by the towing vehicle. Continuous voltage is generally not provided to the trailer, just intermittent power for specific light activations based on the required indications of the towing vehicle. Any time the taillight for the towing vehicle is activated, a corresponding voltage is sent to the light connector to activate the taillight on the trailer. The brake lights on the towing vehicle are active any time the brakes are activated. Similar to the taillight, there is a corresponding voltage sent down the brake light wire and received by the taillights to indicate the application of the brakes on the towing vehicle. Turn signal light indications are indicated by on a voltage impressed on the light connector when the turn signal is activated in the towing vehicle.

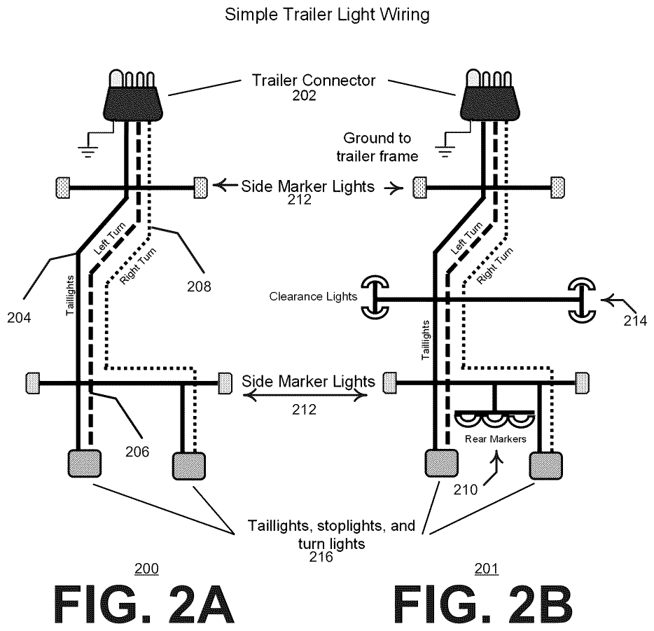

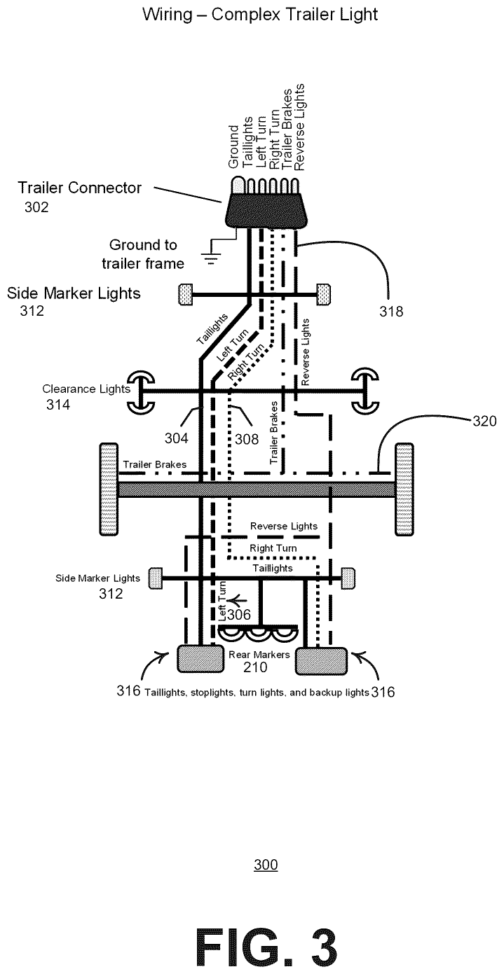

Most trailers have a standardized wiring arrangement and connector that provides trailer light power while the lights are supposed to be on. Some trailers are much more sophisticated than others and the complexity of the wiring is directly related to the sophistication of the trailer. FIG. 2A shows the most common light duty trailer wiring and connections to the towing vehicle. The towing vehicle has a four-pin connector with one ground pin and three signal pins. The ground is required because the hitch might not provide perfect ground continuity between the chassis ground of the towing vehicle and the chassis ground of the trailer. The three additional signal wires are positive voltages for turning on the low intensity trailer lights, the right high intensity taillight and the left high intensity taillight. The low intensity trailer light voltage might also power side, clearance and tail running lights. Depending on the size and width of the trailer, multiple running lights may be required. The left diagram shows the simplest of the simple trailers while the right diagram shows a more complex trailer among the simple trailers. Note that in both cases, there is a discrete high intensity left and right light power wire that is used to indicate brake application and turn signal indication.

The control for the trailer light operation is managed by the towing vehicle. For example, if the brake lights are applied and a turn signal is also activated, the intensity and flashing of the light are managed by the towing vehicle and depend on controlling the independent signal for each side. When brakes are activated without a turn indicator, then both signals supply a voltage for the high intensity lights on the rear of the trailer.

Trailers smaller than semi-trailers have a few options that are not important to the elements of this patent. For example, heavier trailers, or trailers that weigh more than 3000 lbs. should have auxiliary brakes. Typically, those brakes are managed through electricity, and an additional electric brake control wire is typically used for electric brake control. An additional wire may provide auxiliary power to the trailer, perhaps for use by the brake controller or to charge the breakaway battery. Another additional wire may provide power to a backup light, as required by government regulations.

Semi-trailers are a completely different trailer type with their own set of requirements. Generally speaking, the requirements and wiring for semi-trailers are standardized across the US. Outside the US, especially in Europe and Asia, the requirement varies, but the goals are generally the same as the lighting for light duty trailers. Tail light (or running lights), brake lights and turn signals all must indicate the status and intentions of the driver in the towing vehicle.

FIG. 2B indicates a standard wiring diagram for a semi-trailer. This diagram shows a typical wiring diagram for the standardized 7-pin plug that connects the electrical circuits from the semi-truck (tractor) to the semi-trailer. As compared to the operation of lights on a light-duty trailer, operation of lights on a semi-trailer are similar but more complex. For example, the taillight circuit and the side marker and ID lights have different meanings. A brown taillight circuit is generally used only for the license plate light while the black side marker and ID light circuit is used for most of the static lights on the trailer. For example, the side marker and ID light circuit powers front-side amber marker lights, the side amber marker lights, the rear-side red marker lights, the rear taillights (those shared with the brake and turn signal fixtures) as well as the rear red marker lights. One aspect of the wiring in a semi-trailer, or any other trailer, is that the wiring is the minimum required to light the lights and no additional wires are usually available for any other accessory or lights that are not required by government regulations.

The number of trailers and other unpowered vehicles are many and rarely are they always paired with a single powered towing vehicle, especially commercial trailers. Commercial trailers may be leased or rented to a variety of parties and not always returned to the leasing party. Commercial trailers are sometimes rented to companies to be used at on-site storage with the expectation that the trailer won't be used for over-the-road transportation of freight. With modern workloads and scheduling, a driver may deliver a full trailer to a delivery location and disconnect the trailer from the towing vehicle (e.g., a semi-truck) before driving away from the delivery location. With a wide variety of users and no specific ownership accountability, a trailer, after being unloaded, may get pushed to the back of a parking lot and forgotten for a period.

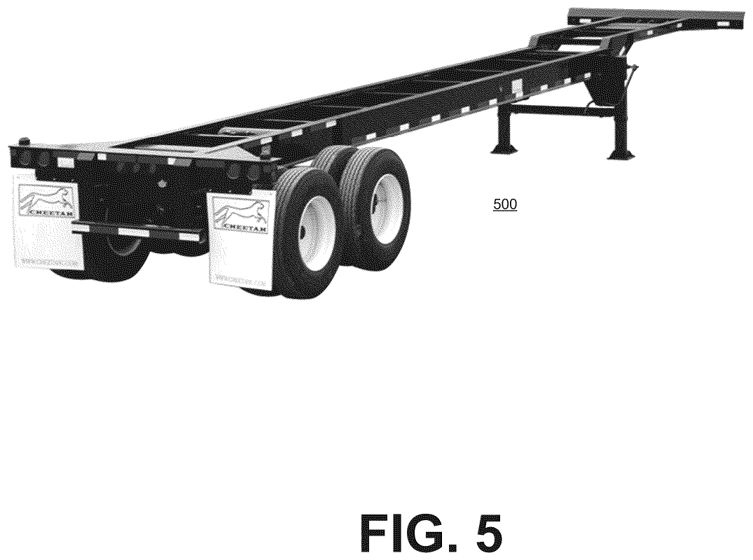

Container chassis 500 shown in FIG. 5, is another type of unpowered vehicle used heavily in the commercial freight transportation industry. Container chassis are used in the intermodal transportation industry. The term ‘drayage’ is a form of trucking service that connects the different modes of shipping (intermodal), such as ocean freight, railroad or air freight. Drayage typically comprises at least one short-haul trip that transports goods from one place to another, usually before or after a long-haul shipping process corresponding to the goods. Typically, a drayage operator may receive a container 4400, as shown in FIG. 44, at a port or railroad freight transportation hub and deliver the container to a freight delivery destination. A container 4400 and a chassis 500 may be paired and left at a delivery destination due to typical destinations not having equipment needed to unload the container from the chassis. After a container 4400 is unloaded from a chassis 500, both the container and the chassis are typically pushed to the back of a parking lot unless either the chassis owner (typically the drayage carrier) or the container owner take responsibility to relocate the container to a drop off point.

Drayage carriers typically: Pick up and deliver containers at seaports; pick up and deliver containers at intermodal ramps; shuttle containers between intermodal ramps when they need to switch railroads (called a “rubber wheel interchange”); or cross-dock or transload freight from international containers into dry van trailers or domestic containers. A typical drayage typically performs a service of moving containers over the road that may also be shipped via other modes of transportation (e.g., ship or railroad). Since it is impossible to drive a container ship or a freight train up to most loading docks, a drayage carrier facilitates completing shipments.

Through all the shuffle of the supply chain for logistics operations, goods and logistics transportation equipment may get lost, or the location or condition thereof may be indeterminate using conventional techniques. It is highly desirable to manage goods with the expectation of safe transport. Further it is highly desirable to manage equipment with the expectation of safe usage without worry of theft and inadvertent loss. Many different companies own the assets used by the logistics industry. Containers themselves are owned by a variety of different companies, from the COC or “carrier-owned container” which is owned by a shipping company to a “shipper-owned container”, also known as a container, owned by a leasing company, a non-vessel carrier or a freight forwarder. Commercial semi-trailers are a different asset, but the variety of owners is quite as diverse. Some trailers are owned by owner/operators. In this ownership model, the trailers are usually associated with a single tractor. Many times the ownership is small partnerships that own one or just a few vehicles. Other examples are FedEx and UPS who own their own tractors and their own trailers. In the case of large companies, like FedEx and UPS, the trailers are not usually paired with a tractor but tracking, management and servicing may be handled through the corporate entity. These trailers get lost through asset management errors, with most losses most likely a trailer sitting on a company lot but not assigned to a load.

Conventionally, Global Positioning Satellite (“GPS”) and Global Navigation satellite System (“GNSS”) tracking is well understood and used for tracking and managing of trailers, cargo containers, container chassis, light utility trailers, or small cargo trailers. A conventional asset management company uses trip starting point and trip ending point to map trip mileage. Simply setting up a trip route between the starting point and ending point, using any of the mapping services, may result in a determined mileage value that can be accumulated to determine if/when maintenance including tire and brake replacement is required. GNSS devices can be battery powered or powered via batteries with solar cell battery charging. GNSS devices can provide notifications of movement and no movement by monitoring an accelerometer. Conventional GNSS devices can provide periodic location updates at regular intervals based on movement with respect to movable assets such as trailers.

However, powering a GNSS device on a trailer using conventional techniques has always been a challenge. Most non-powered vehicles do not have continuous power sources. The rare exception are those small trailers with electric brakes and an emergency break away system. On large trailers, brakes are typically operated by a reverse braking system using air pressure from the tractor. If the trailer breaks away from tractor, the air pressure is cut off and the brakes are applied. An exception to trailers typically not having a corresponding power supply is a refrigerated trailer, or a “reefer.” Reefers have a full cooling system, generally diesel fuel powered, with a 12-volt battery system for starting. Because of the critical nature of reefer's cargo, reefers usually have a connected telematics system to report outages and fuel levels on the cooling system. Typical reefer systems are very limited in functionality and capability. For example, a conventional refer trailer typically is not equipped to monitor auxiliary functions like light outages, door openings, and tire pressures using the 12-volt battery starting system.

Installing a conventional GNSS device on a large trailer is also a challenge. Although the inside of a trailer comprises ample space to locate a tracking or telematics device, the inside of a full size 53-foot trailer is designed specifically to hold twenty-six standard size pallets on the floor, or perhaps fifty-two if the pallets are stackable. Putting anything on the walls or floor is a hazard to the cargo and the tracker. Furthermore, locating a conventional GNSS racking device inside a trailer typically results in degraded RF performance with respect to communication of satellite and long-range wireless/cellular signals. Ideally a tracking device should be located to have a clear view of the sky and reasonable outside ‘view’ for cellular coverage. Although some semi-trailers have fiberglass ceilings that can pass GNSS signals and the cellular signals without significant attenuation, it is desirable to locate a tracking device to avoid interference with cargo, especially while being loaded or unloaded, and to avoid exposure of the tracking device to possible damage if bumped by cargo or cargo-handling equipment, while loading or unloading.

Trailers are typically unpowered vehicles designed to be towed by other vehicles. To solve the problem of a tracking device associated with an unpowered trailer typically not having access to a power source, example embodiments disclosed herein enable trailers to have features only found on powered vehicles. Example embodiments disclosed herein facilitate significant operational enhancements to unpowered vehicles and also facilitate additional features that change the entire freight transportation industry.

The trailer industry is very broad, covering many different physical sized trailers and the trailer industry also touches many different verticals. Categorizing the trailer industry between light utility trailers and heavy-duty semi-trailers probably is not enough categories-light utility trailers may be used to haul everything from horses to boats to automobiles. Semi-trailers are equally diverse with trailers ranging from flatbed trailers to intermodal containers on chassis. Examples embodiments disclosed herein, comprising hardware form factors that may be different with respect to different verticals, the same or similar electronic hardware, firmware, and software may be used with, and useful with respect to, the different vertical use cases.

According to conventional techniques, installing a tracking device, which may be referred to as a ‘tracker, or a telematics device on the underside of a trailer results in several compromises. For example, radio frequency (“RF”) performance, especially for the GNSS will be limited unless a remote antenna is attached to the unit. GNSS reception will work in areas where a reflected GNSS signal can be captured. Areas where buildings, especially metal buildings or other nearby metal trucks are present will provide a workable GNSS signal. However, rural areas where no nearby objects are present will make receiving GNSS signals very difficult. The secondary problem with the underside of the truck is possible vandalism. If the GNSS or telematics box has any value of reuse by others if stolen, it becomes a target of thieves. If the box is protecting the semi-trailer by providing its location, then disabling it becomes advantageous to the trailer thief.

According to conventional techniques, tracking devices may be solar powered and may be magnetically or mechanically attached or located on the outside of truck. Installing the tracker on the roof exposes tracking devices to weather and potentially other damaging elements as well as vandalism although reaching the top of a trailer is always difficult. Furthermore, operating in locations with cold climates where snow covers the tops of trailers for months may result in inadequate tracker device performance.

A conventional solution for GNSS tracking is to install a generally covert device that can leverage some form of energy harvesting, have nearly clear visibility to the sky for GNSS reception, and have a reasonable non-shielded (outside of the metal trailer shell) location to facilitate cellular communications. Example embodiments disclosed herein facilitate providing advanced functionality that may be configurable to a trailer owner's requirements, may not require significant efforts or time to install, and are extremely low cost to facilitate wide installation while adding significant value to a trailer owner.

In an example embodiment disclosed herein, an example tracking device may be usable with respect to unpowered vehicles designed to be towed by other vehicles. In an example embodiment, an unpowered vehicle may be a trailer being towed, or pulled, by a vehicle such as a car, a pickup truck, or a heavy-duty tractor/truck. In an example embodiment, an example tracking device may provide a range of communication services similar to a telematics control unit used with respect to powered vehicles. In an example embodiment, an example tracking device may be configured to be usable with respect to an unpowered towed vehicle (e.g., a trailer) without requiring significant modification to the un-powered trailer and without requiring significant installation efforts. In an example embodiment, an example tracking device does not require a continuous power supply to operate for extended periods of time while providing nearly continuous operational information.

An example embodiment comprises a method to locate and track non-powered vehicles (trailers). An example embodiment comprises a method to detect theft of trailers. An example embodiment comprises a method to detect necessary maintenance of trailers. An example embodiment comprises a method to detect excessive weight on the freight of trailers. An example embodiment comprises a method to detect mileage of use of trailers. An example embodiment comprises a method to detect the removal of theft prevention locks on trailers. An example embodiment comprises a method to detect lowering or raising of accessory landing gear. An example embodiment comprises a method to detect incorrect tire pressure or tire blowouts. An example embodiment comprises a method to detect inadequate lubrication on moving parts. An example embodiment comprises a method to detect theft of valuable associated assets. An example embodiment comprises a method to detect operating hours for associated assets. An example embodiment comprises a method to detect unbalanced or out of round tires or other problematic vibrations in the trailer. An example embodiment comprises a method to detect cargo loading. An example embodiment comprises a method to detect attachment to powered towing vehicle. An example embodiment comprises a method to detect brake or bearing overheating. An example embodiment comprises a method to detect doors opening or closing. An example embodiment comprises a method to detect freight carriage. An example embodiment comprises a method to detect freight temperature values out of range. An example embodiment comprises a method to detect refrigeration unit operation or non-operation operation through a contactless CAN bus monitor or engine heat detection.

As discussed in the Background section hereof, the term ‘telematics’ may refer to integration and use of telecommunication devices and systems and information storage, usage, transmitting, receiving, and processing. The term ‘telematics’ is often used in the context of determining, transmitting, or receiving, vehicle information corresponding to use, operation, or ownership of a vehicle. Although a simple GNSS asset tracking system might meet this definition, example embodiments provide more extensive functionality than a simple asset tracker. A telematics device according to example embodiments disclosed herein may be referred to as a ‘TailLight Telematics Control Unit’ (“TLTCU”). A TLTCU may be referred to herein as a light device.

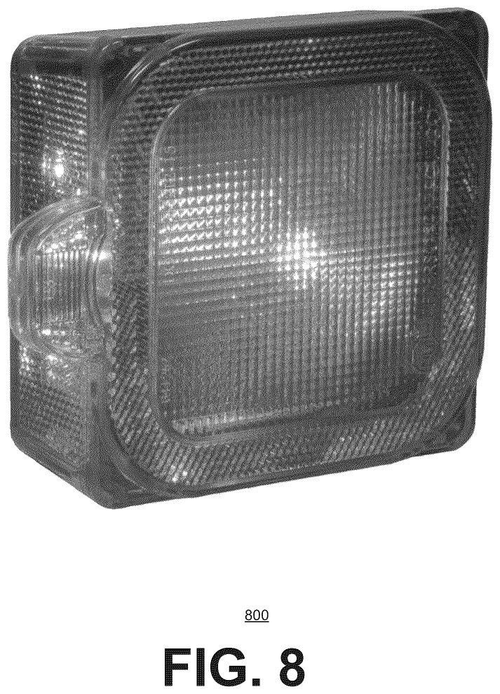

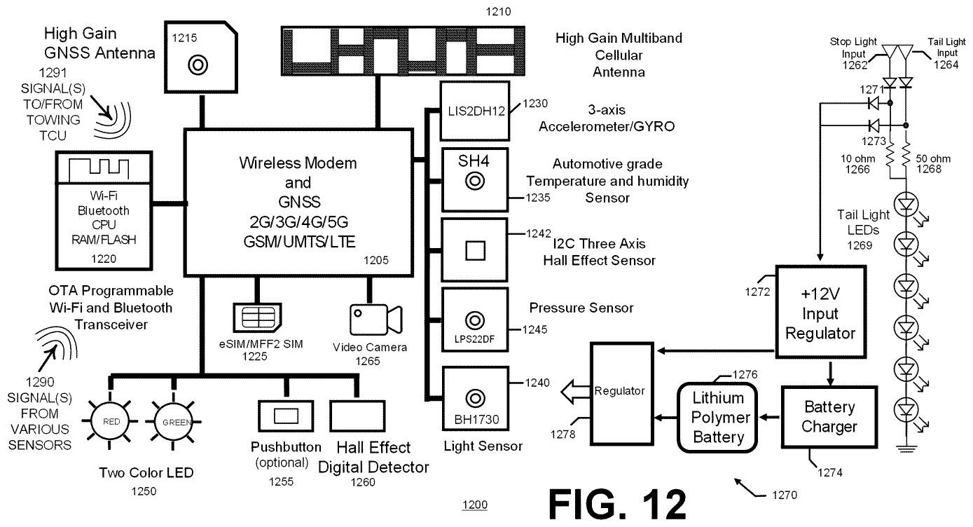

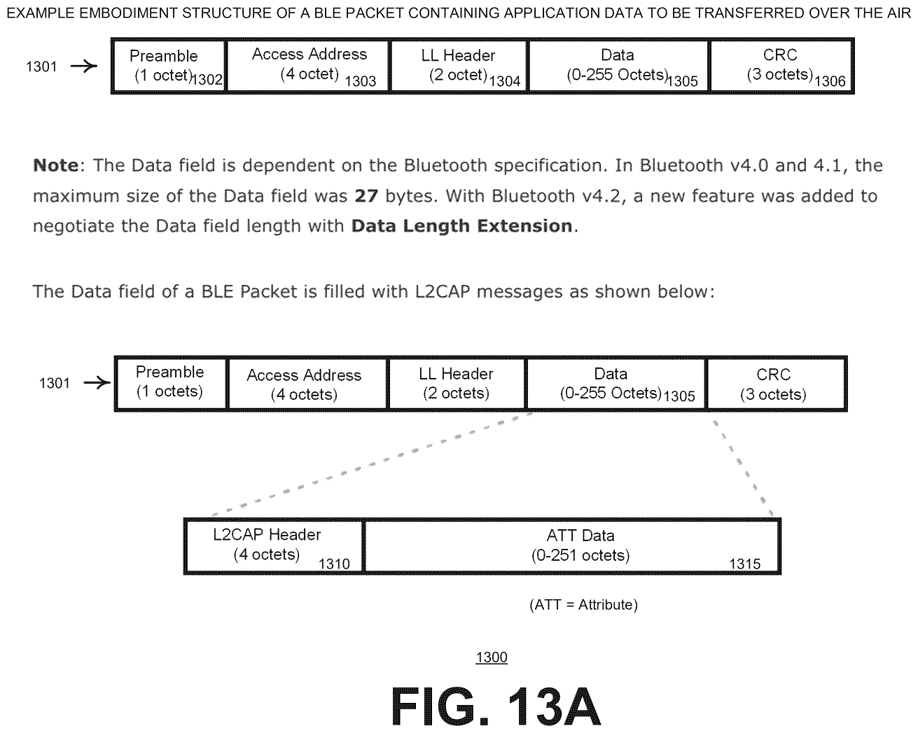

According to at least one example embodiment, a TLTCU may be installed in place of a single taillight (or both taillights) on a non-powered vehicle (e.g., a trailer without its own electrical power source). Different TLTCU physical models may be described herein for use in different use cases, including models shown in FIGS. 8, 9, and 10. Despite different physical appearances of different TLTCU models, internal circuitry corresponding to a given example TLTCU embodiment disclosed herein is similar with respect to internal circuitry corresponding to other TLTCU example embodiments disclosed herein. It should be noted that example embodiments shown in, for example, FIGS. 8, 9, and 10 are simply example embodiments and the disclosure herein in no way defines the shapes of future implementations of a TLTCU. Additional models for taillights, or other light assemblies used with respect to vehicles, may be specified for use in different countries or regions that may also comprise functionality similar to functionality corresponding to example TLTCU embodiments disclosed herein. In another example embodiment, TLTCU circuitry, as described herein in reference to FIG. 12, may be included in other components used with the trailer, for example an inline connector coupled between a towing vehicle light wiring harness and a light wiring harness of a trailer, or towed vehicle. In another example embodiment, TLTCU circuitry, as described herein in reference to FIG. 12, may be included in an inline connector coupled between the wiring harness of the towed vehicle and the towed vehicle light.

FIG. 12 illustrates a block diagram of an example embodiment TLTCU 1200. TLTCU 1200 is shown in FIG. 12 comprising taillight circuitry 1270, diodes 1271 and 1273, and LED lights 1269 to facilitate a taillight, for example taillight 500 shown in FIG. 5, having two different LED intensities as is typical for a conventional taillight. Continuing with discussion of FIG. 12, TLTCU 1200 is shown comprising processor/modem module 1205, which may comprise GNSS functionality and long-range wireless cellular communication functionality (e.g., 4G, 5G, and the like). The lowest intensity light output may be facilitated by the higher value resistor 1268 that provides to LEDs 1269 an amount of current that causes the LEDs to generate light at an intensity corresponding to “taillight” or “running light” functionality. The highest intensity light output may be facilitated by the lower value resistor 1266 that provides an amount of current to illuminate the LEDs on at the correct intensity corresponding to a “brake light” or “turn signal” functionality, or a combination of both tail/running light and brake light intensities. Most small trailers such as light utility trailers have a single taillight on each side of the trailer that provides taillight, brake light, and turn signal indications, while most semi-trailers have two light fixtures on each corner. All four fixtures typically operate in the lowest intensity mode providing a tail/running light function. Normally, one of each corner pair provides brake light indication while another of each corner pair provides a taillight indication. This arrangement typically conforms to government standards, and the normal wiring of each light includes three wires with one of those wires a ground wire while the other two are inputs providing light “on” signals, one for low intensity, normally a running light, and the other for high intensity, normally a turn signal indication or a brake light indication.

Power for processor 1205 may be provided by a battery/regulator 1270 inside taillight 1200. While a non-powered trailer is disconnected from a towing vehicle that may provide power to the trailer and thus to taillight TCU 1200, battery 1276 may provide power to components of TLTCU 1200 (a conventional trailer typically does not contain a power source and thus typically no power source would be available for circuitry of TLTCU 1200). Thus, for example, TLTCU 1200 that may be part of a trailer may facilitate locating a missing or stolen trailer, wherein no powered towing vehicle is attached, and determining the location of the trailer, which is desirable for purposes of recovery of the trailer.

Battery 1276 may be charged by the application of power that results via either low intensity light input or the high intensity input via diodes 1273 and/or 1271, respectively corresponding to operation of the taillight/running light and/or the brake light/turn signal indication. It is desirable for battery 1276 to be capable of being charged as quickly as possible, for example on the order of a few hours, while lasting as long as possible, preferably in the order of months or years.

TLTCU 1200 may comprise several components in addition to components that may facilitate tracking functionality. For example, according to example embodiments disclosed herein, TLTCU 1200 may comprise I2C linear 3-axis hall-effect sensor 1260. In an example embodiment, output from 3-axis hall-effect sensor 1260 may comprise 12 bits representing a measurement of analog magnetic field values with respect to each of the three axes indicating magnetic field strength parallel to each axis. Coupled with a nearby magnet with respect to which sensor 1260 may be positioned within TLTCU 1200 to measure magnetic fields corresponding thereto, wherein the magnet is also positioned within the TLTCU, the hall-effect sensor can detect changes in magnetic field strength(s) generated by the nearby magnet if the magnetic field(s) are affected, modified, disturbed, or otherwise changed. If taillight 1200 is mounted in, or, or near to a ferromagnetic structure, components, or item, then the field(s) of the magnet may be disturbed or modified by the presence of the ferromagnetic structure. Thus, a removal or significant movement of TLTCU 1200 relative to the ferromagnetic structure may result in a change to the magnetic field(s) as the TLTCU is moved or relocated and may be detected by hall-effect sensor 1260. Upon determining, by module 1205 receiving input from sensor 1260 that magnetic field(s) strengths, detected by sensor 1260, have changed relative to strengths that may have been detected when TLTCU 1200 is properly mounted in, on, or to a trailer, or other movable item, may result in a removal or tampering notification being generated by module 1205 and being transmitted to a cloud service and subsequently to an interested end user, for example, a logistics operator that operates the trailer to which, or which, or in which the TLTCU is supposed to be mounted.

Significant ferromagnetic metals may include iron, cobalt, or nickel. There are also some rare earth metals that are magnetic, but that are not likely used in materials used for constructing a trailer. Compounds and alloys can also be magnetic if they contain the above metals. There are a number of non-ferromagnetic metals, most notably aluminum, that typically will not facilitate the desired result of detecting a change to a magnetic field strength of a magnet mounted in, to, or on RLRCU 1200, and thus may not facilitate a desired result of generating, by the TLTCU, a notification that the TLTCU may have been removed from a trailer that may not have a power source when disconnected from a towing vehicle.

In an example embodiment, in addition to hall effect sensor 1260 and a magnet that may both be fixed within TLTCU 1200, the TLTCU may also comprise a radio module 1220 that may comprise a combination of one or more WiFi/Bluetooth radio, a processor, RAM, or flash memory. Combining WiFi/Bluetooth functionality with a taillight tracking device adds significant value and is a major improvement with respect to conventional tracking devices.

The WiFi functions are, of course, the easiest functions to describe. In a tracking device, outdoor locations are easily determined by the use of a GNSS or GPS as long as the device has at least a partial view of the sky with an antenna in an acceptable orientation. It is well known in the industry that GNSS or GPS receivers provide marginal or no results if the receive antenna is under a concrete or metal roof. Further, GNSS signals are significantly attenuated by tree canopy or a wood construction roof. A GNSS will rarely work inside of a home or office unless it is near a window. GNSS signals are severely attenuated by metal buildings and metal objects, like semi-trailers. Since most buildings contain at least one WiFi hotspot, when a device containing a WiFi radio turns the WiFi receiver on and scans the spectrum, the received MAC addresses can be resolved to latitude and longitude locations using third party databases operated by Skyhook, Combain, Google, Here, and others.

A database used to resolve MAC addresses into geographic locations may be created by crowdsourcing information. For example, Android user equipment devices periodically sniff the WiFi spectrum in the background and if MAC addresses are discovered they are paired with a GNSS location from the Android device and sent to Google's cloud. Once a few different devices have received and provided associated location to Google's cloud, Google adds the MAC address to the working database.

Any time a vehicle equipped with a taillight tracking device with a WiFi receiver is nearby a WiFi hotspot and a location is requested, the WiFi can provide a fast and relativity accurate location using minimal power. WiFi locations usually provide locations with accuracies of less than 30 meters. Although not as accurate as GNSS, the WiFi locations work in places where GNSS reception is not possible.

Bluetooth module 1220 facilitates new functionality with respect to conventional techniques. In addition to providing “private” location tags similar to WiFi hotspots, Bluetooth module 1220 can provide gateway functionality by relaying messages between the short-range Bluetooth radio to the long=range cellular radio corresponding to module 1205. Combining a Bluetooth gateway module 1220 in a light assembly with a long-range wireless radio gateway, as described in reference to various example embodiments disclosed herein, adds significant functionally to various trailers from boat trailers to semi-trailers.

According to at least one example embodiment disclosed herein, Bluetooth gateway module 1220 may receive at least one Bluetooth beacon (“BTB”) message signal 1290 that can be directed by module 1205 to a cloud-based server (e.g., TOC 147, shown in FIG. 1, for processing. Although cloud-based server 147 can sort BTB messages and manage information corresponding to the BTB messages, essentially using gateway module 1220 as just a simple “frequency and protocol” translator, this could cause a problem insofar as a typical BTB device sends messages at intervals as short as 100 ms to as long as 10 seconds. The amount of long-range radio (e.g., cellular) traffic that would likely be consumed by module 1205 in transmitting these messages would likely overwhelm spectrum available with respect to a RAN node 105. Accordingly, cither gateway module 1220, or module 1205, may be configured according to embodiments disclosed herein to perform BTB message filtering and processing.

BTB message can be filtered to eliminate BTB messages that are unrelated to a vehicle comprising a light device 1200. At any given location, there may be BTB messages available from numerous devices ranging from simple temperature sensors, tools, televisions, cellphones, laptops, tablets, and the like. Nearly all those messages are uninteresting to a tail light TCU 1200 used with respect to a vehicle according to example embodiments disclosed herein. Bluetooth beacons use many different message formats but there are a few basic items that are generally common among most Bluetooth beacons. A Bluetooth Device Address/MAC address is usually readily available and identifiable in a BTB message. The Bluetooth Device Address (sometimes referred to as a Bluetooth MAC address) is a unique 48-bit identifier assigned to each Bluetooth device by the manufacturer. The Bluetooth address range is assigned to a specific company. The Bluetooth Core Specification says: The BD_ADDR shall be created in accordance with Section 9.2 (“48-bit universal LAN MAC addresses”) of the IEEE 802-2001 standard (http://standards.icec.org/geticee802/download/802-2001.pdf) and using a valid Organizationally Unique Identifier (OUI) obtained from the IEEE Registration Authority. This means that every BTB address will be universally unique.

One easy filtering scheme would be to search for and ignore any BTB messages that contained Bluetooth addresses that were outside of a prescribed range of addresses. For example, manufacturer Broadcom was assigned the “00:04:61” address range, and as example: “00-04-61-02-AA-FF” is a Broadcom manufactured device. Thus, only devices that were broadcasting within the Broadcom address range could be evaluated.

However, just filtering based on manufacturer address range may not be practicable because if a manufacturer is a very large manufacturing company with many devices in service, the manufacturer's devices could be deployed in large numbers in an area where they might also be received along with messages of interest to TLTCU 1200 so other filters might be desirable. BTB messages can optionally have Company IDs incorporated in them so the very simple method of filtering might include using Company ID. This method is generally preferred due to the fact that if the Company is a prolific manufacturing company, it may have more than one Bluetooth address range. For example, Broadcom has the Company ID of 0x000F. Messages could be filtered to be limited to only those containing the Company ID of the manufacturer of interest.

In addition to filtering based on Company ID, filtering based on another ID called Universally Unique Identifier (“UUID”) may also be used. A UUID is typically used for uniquely identifying information. A UUID is generally used for identifying a service corresponding to a Bluetooth device. The service may be known to the manufacturer of the Bluetooth device and may not be specified by the Bluetooth Core Specification. Broadcom has two UUIDs 0xFED6 and 0xFED7. A logical solution might be to filter on a Company ID and a UUID.

Bluetooth 4.0 messages may be defined to have an advertising payload of 31 octets. With such a short message, and a requirement for certain fields, a limited amount of information may be sent in each 31 octet message. The newer Bluetooth 5.0 specification allows for 254 octets of advertising payload. Although all messages could be extended to the maximum length, doing so may result in significant disadvantages. First, longer messages require more wireless resources to transmit and based on the random nature of BLE beacon messages, a significant decrease in number of devices that can be supported in a given area is likely. Furthermore, sending longer messages requires use of more wireless resources/airtime and subsequently more battery energy, resulting in a possible reduced device battery lifetime. It is possible to support a mixture of shorter and longer BLE beacon messages.

According to example embodiments disclosed herein, a GNSS tracking device may be enclosed in a taillight that comprises a Bluetooth module and a long-range wireless module to facilitate delivery of services with the taillight being installed on or into a non-powered vehicle.

Features delivered by example taillight Bluetooth gateway embodiments disclosed herein may be facilitated by security aspects that protect against tampering. Protecting example embodiments disclosed herein against a malicious actor being able to disable, remove from an unpowered vehicle/trailer, or destroy the embodiments may facilitate the example embodiments being used as theft protection with respect to an unpowered vehicle(s)/trailer(s) to which the example embodiment(s) correspond.

A conventional taillight tracking device attached to a trailer provides location information corresponding to the trailer as long as the device is installed semi-permanently on the trailer. According to example embodiments disclosed herein, an almost foolproof method of removal notification using an advanced feature solves problems and provides improvement with respect to conventional techniques.

A switch of some kind can provide an indication or device input that alerts internal circuitry of at least one embodiment disclosed herein that a change has been made to external installation of the at least one embodiment on a trailer. The problem with merely a switch is readily apparent-a simple switch and a determined thief will eventually show that the solution can be defeated. Although nothing is completely foolproof, protecting against all but the most determined thief is likely adequate in the context of a trailer carrying anything but extremely sensitive or expensive cargo.

Most trailers are constructed with ferromagnetic materials. An I2C hall-effect switch/sensor, such as sensor 1242 shown in FIG. 12, can detect changes to the mounting a of taillight-equipped GNSS tracking device with a Bluetooth gateway (e.g., TLTCU 1200). Additionally, to prevent destruction of TLTCU 1200 that a nefarious actor may perform instead of outright removal of the TLTCU from a trailer, the TLTCU may optionally be equipped with a barometric pressure 1245 sensor to detect random or targeted penetration or destruction of the housing, for example, with hammers or drill bits. As a result of an incursion into or unintended movement or TLTCU 1200, the determination of which may be facilitate by accelerometer 1230 or hall-effect detector 1260, a rapid change in pressure as detected by the pressure sensor 1245 may result in TLTCU 1200 instantly, or substantially instantly reporting a tampering event that would be subsequently report to the trailer/vehicle operator or perhaps a trailer alarm service center. It will be appreciated that such instantaneous reporting of incursion into or movement of TLTCU 1200 may be facilitated, even without the trailer being connected to a towing vehicle that supplies power to the TLTCU, by battery 1276. In an example embodiment, a housing and lens of TLTCU 1200 may be manufactured together in such a way as to prevent water intrusion. Pressurizing or vacuum depressurizing the housing in the manufacturing process and including sensor 1245 may add a de minimis cost and complexity to TLTCU 1200, but the added benefit of the removal and destruction detection facilitated by pressure sensor 1245, which may send an interrupt to module 1205 upon a change in internal pressure of a tailing/housing lens combination, significantly increases the value and functionality of TLTCU 1200 with respect to conventional techniques.

Thus, according to example embodiments disclosed herein, theft of a TLTCU 1200 may be rendered a self-defeating proposition. Each taillight gateway TLTCU 1200 may be individually identified by a permanently attached SIM card, eSIM, soft SIM, SIM profile, and the like, coupled with, or stored by, module 1205, that may comprise unique identification and encryption keys that may be installed at a factory and that may be unchangeable in the field. Accordingly, the only thing that a stolen taillight gateway TLTCU 1200 can do is report exactly where the TLTCU is located if powered, and if the battery 1276 is destroyed the TLTCU becomes useless except perhaps as a light, but the TLCU will still report its location, at least until battery 1276 is destroyed or removed.

FIG. 12 highlights novel hardware implementation 1200 that may facilitate example embodiments disclosed herein. At the heart of the implementation 1200 is wireless modem and GNSS module 1205. Module 1205 may comprise crystals, filters, amplifiers, and other components that facilitate performing connectivity of a TLTCU. Connectivity technology used by module 1205 may comprise LTE CAT M, but it will be appreciated that other possible communication techniques may be used, from unlicensed LPWA such as Sigfox or LoRa, to licensed technologies such LTE, LTE CAT M, NBIoT, 2G GPRS, 2G EDGE, 3G, 4G, 5G, LPWA, LORA, HaLow, WiFi, or a multitude of other licensed or unlicensed existing technologies, or any future wireless technology that operates in a long range data communications mode. Implementation 1200 is shown in FIG. 12 as comprising a single device communication device, manifested as communications module 1205, but the implementation could easily be implemented as an arrangement of semiconductor ICs and associated support components. Module 1205 may comprise an application processor known as a System-in-Package (“SIP”) containing an ARM core processor with flash memory for application software, ram memory for application software and various I/O peripherals typical of ARM core processors; I2C, I2S, UARTs, analog-to-digital converters, SPI, PDM, PWM among other features. Alongside the application processor in the SIP is a multiprotocol modem processor supporting various communication methods, including LTE CAT M and NB-IOT. SIP communication chips may comprise or facilitate GSM 2G, 3G, 4G, 5G, GSM, UMTS and LTE or other similar communications protocols.

In addition to the communications and applications functions, the SIP may comprise a GNSS receiver and processing engine to facilitate the SIP determining a location corresponding to the SIP using one or more of the worldwide Global Navigation Satellite System (“GNSS”) solutions be facilitated by one or more satellite constellations to provide positioning, navigation and timing (“PNT”) services on a global or regional basis. A consideration worth understanding is that GNSS is the preferred method for PNT services at the present time, but satellite service is by no means the only method to facilitate PNT services. In the 1980's and the 1990's terrestrial PNT services such as Loran were popular. With the significant geopolitical challenges around the world, PNT services may soon return to terrestrial based PNT services, perhaps based on cell tower triangulation methods or variants thereof. In no means should this disclosure be limited to a PNT solution based on satellites.

Outside of, and communicatively coupled with, the SIP are antennas 1210 and 1215 that may facilitate GNSS and long-range cellular communication. A future SIP implementation could include those antennas as part of the SIP. Additionally, Subscriber Identity Module (“SIM”), may comprise a SIM functionality, a soft SIM, SIM profile information, an cSIM that is soldered to a circuit, or unique SIM information that is stored in a memory coupled with module 1205. Future implementations could include a SIM inside the SIP, known in the industry as an integrated SIM (“iSIM”). Other implementations could also use a virtual SIM, a SIM integrated inside the SIP using software methods including ARM “Trust Zone”, or similar method that insolates security critical components in a system by hardware separating a rich operating system from a much smaller secure operating system. The SIP and ancillary components with communications and PNT antennas and SIM fundamentally perform the bulk of the processing in the preferred embodiment, but some example embodiments may comprise more integration or less integration of discrete components, that may include other processing component, with respect to module 1205.

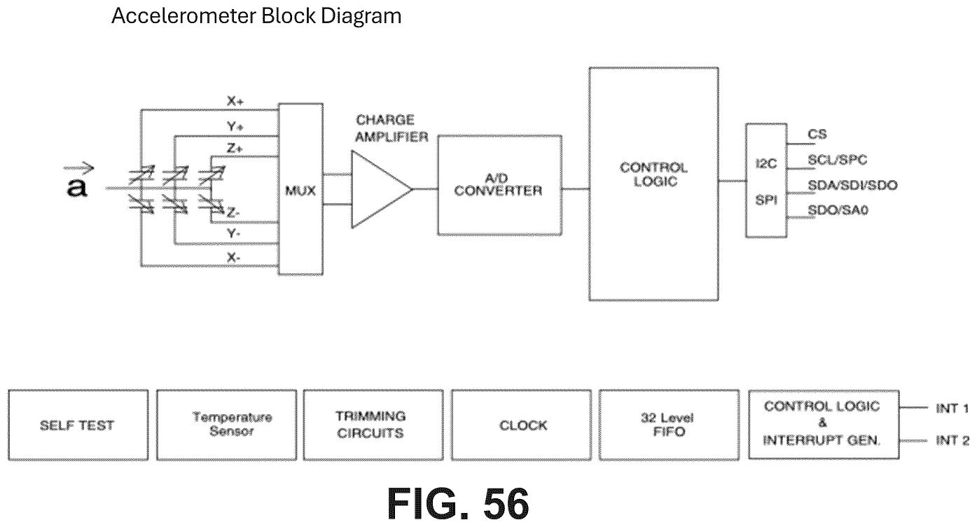

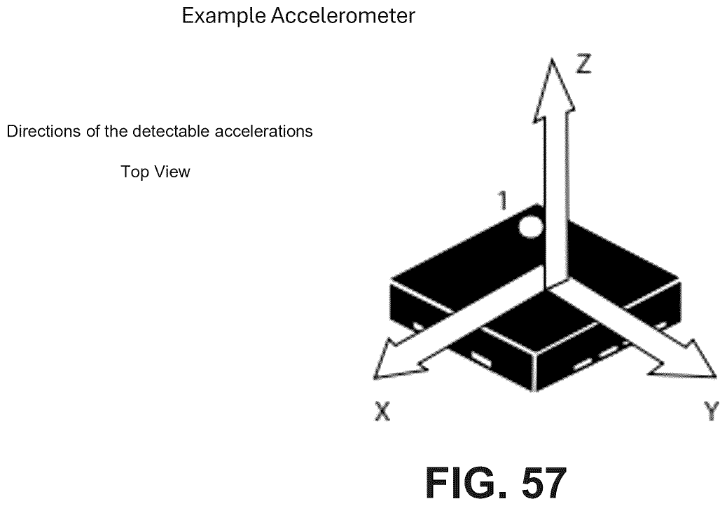

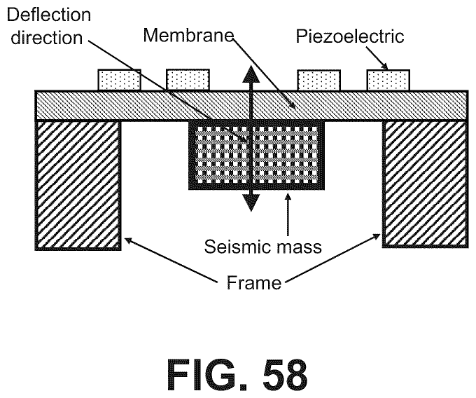

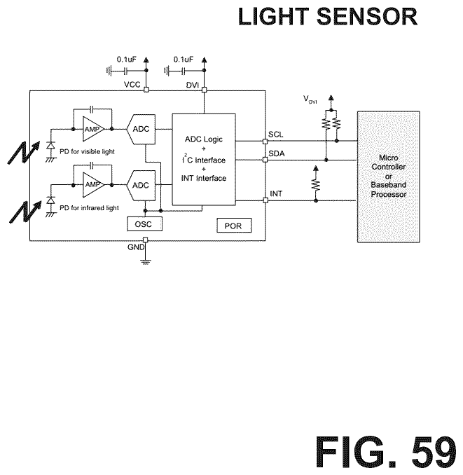

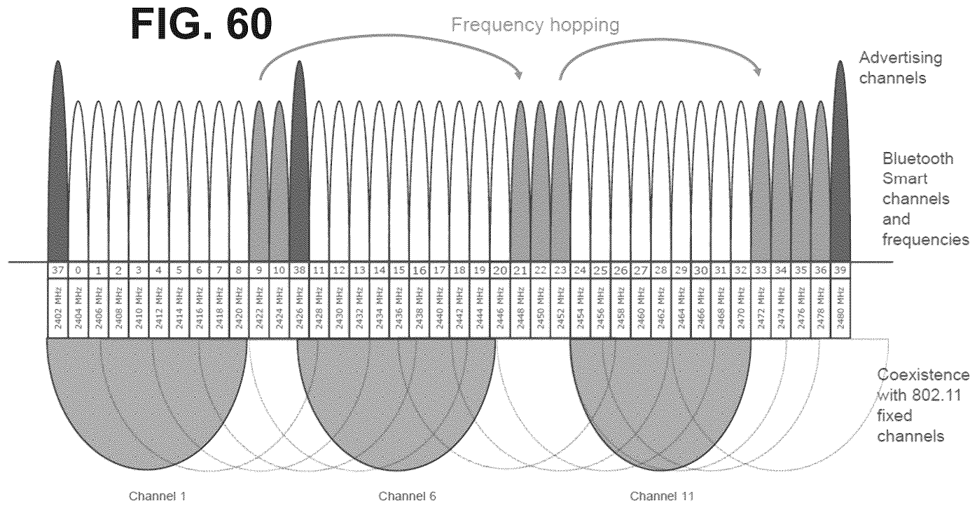

Alongside the SIP, example implementation 1200 may comprise discrete sensors. For example, accelerometer 1230 can provide three-axis movement indications and notification of movement to the central processing unit of the SIP (e.g., module 1205). FIG. 57 illustrates the typical directions of the forces measured by accelerometer 1230. Orientation of accelerometer 1230 may vary based on convenience of construction of TLTCU that comprises implementation 1200. FIG. 56 illustrates typical circuitry inside an accelerometer. Circuitry shown in FIG. 56 should not be a limiting design, nor should it be considered the minimum design. FIG. 58 illustrates construction details of an example accelerometer from a sensing physics perspective.

Continuing description of FIG. 12, temperature and humidity sensor 1235 may be optionally included in implementation 1200. In some situations, temperature sensor 1235 may measuring heat generated by LEDs 1269 that may provide tail light, brake light, marker light functionality when part of a tail light that comprises implementation 1200. Circuitry corresponding to implementation may be sealed to the outside environment and humidity measured by sensor 1235 may be indicative of humidity present when a TLTCU comprising implementation 1200 was manufactured, thus possibly being indicative of a break or crack of the TLTCU or lens thereof if humidity measured by sensor 1235 changes.

As shown in FIG. 12, implementation 1200 may comprise three-axis hall effect sensor 1242 as, for example, a peripheral with respect to TLTCU central processing unit/module 1205. Hall-effect sensor 1242 may comprise a low-power linear 3D Hall-Effect sensor with an I2C interface. Sensor 1242 may integrate three independent Hall-effect sensors corresponding to X, Y, and Z axes, a precision analog signal chain, and an integrated 12-bit ADC digitizing the measured analog magnetic field values. Sensor 1242 may provide an interrupt to the central processing unit 1205 that is indicative of a change at least one magnetic field value. An I2C interface may provide communication to central processing unit 1205. A typical hall effect sensor may be exemplified by a Texas Instruments TMAG5273. The linear 3D Hall-effect sensor 1242 may facilitate theft detection, with respect to a TLTCU, as described elsewhere herein.

FIG. 12 illustrates pressure sensor 1245 and light sensor 1240. Pressure sensor 1245 may also facilitate theft detection with respect to a TLTCU that may comprise implementation 1200. Pressure sensor 1245 may comprise a low-power, high-precision MEMS nano absolute pressure sensor with an operable range of approximately 260-1260 hectoPascals (“hPa”) and may provide a digital output. Sea Level pressure is 1013 hPa or about 14.7 pounds per square inch (“PSI”). Pressurizing a sealed tracking device, such as, for example, a TLTCU that comprises implementation 1200, with about 3.3 PSI higher than sea level pressure (e.g., about 18 PSI) means that the internal absolute pressure sensor would read about 1241 hPa, which is within the operable range of sensor 1245. Pressure sensor 1245 may be capable of providing an interrupt based upon pressure condition or based on configured pressure condition trigger level, or value. If a TLTCU comprising implementation 1200 is sealed and is pressurized with a positive pressure, then the desired interrupt function could provide notification (e.g., an interrupt) to module 1205 of pressure dropping below the factory pressurized value by a configured threshold. For example, if the TLTCU is pressurized to 18 PSI, an interrupt indication could be provided if the pressure inside the TLTCU drops below 16 PSI. If the TLTCU uses a negative pressure or vacuum, considering the highest practical land location for a trailer, an internal pressure of about 4 PSI, well within an operable range of the pressure sensor, may trigger an interrupt to module 1205. If the internal pressure is 4 PSI, a change to 6 PSI could be configured to provide an interrupt indication to central processing unit 1205. Thus, desired pressure sensor 1245 may be configurable to have preset/configured pressure values and to report interrupts when triggered by measured positive or negative pressure, which triggering may be determined based on configurable criterion/criterion which that may be based error limits, or tolerances, which may be based on an initial, pressure/vacuum value. In an example embodiment, module 1205 may continuously monitor/read internal pressure, reported by sensor 1245, at a configured interval, for example, some interval, 100 ms, and may determine that a TLTCU pressure envelope (e.g., an initial pressure or vacuum to which module 1205 has been configured, or calibrated, to recognize as a baseline value that corresponds to the TLTCU not having been breached, broken, unsealed, etc., which could occur if the TLTCU is removed or stolen from a trailer. Theft detection system using pressure sensor/detector 1245 is described further elsewhere herein.

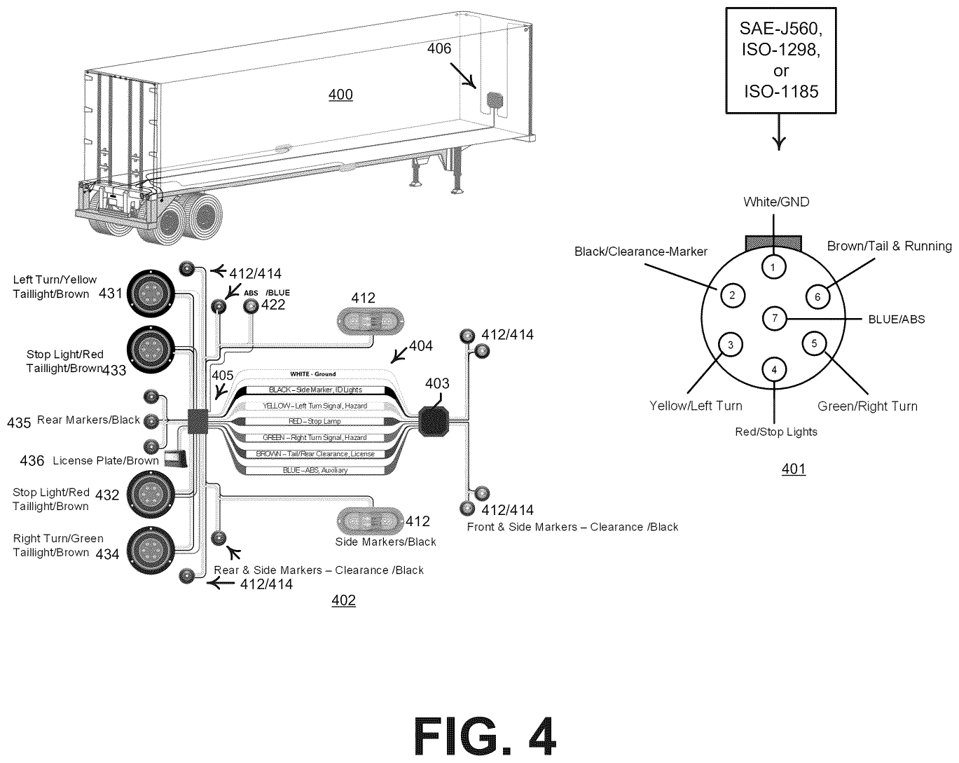

FIG. 12 illustrates an example embodiment power system 1270 for a taillight telematics control unit (“TLTCU”) that comprises implementation 1200. Power system 1270 may provide power to circuitry corresponding to implementation 1200 when the TLTCU has access to external power or when that TLTCU does not have access to external power. External power may be provided via light inputs 1262 and 1264, which may be coupled to, and which may be energized by, at least one conductor carrying current corresponding to operation of a tail light or brake light. For example, if one of pins 1-8 corresponding to conductor 401 shown in FIG. 4, or if one of conductors 404 that may receive power via connector 401 being plugged into connector 406 of trailer 400, is energized due to an operator of a tractor that is mechanically or electrically coupled to trailer 400 performing a braking operation/action, a turn signal operation/action, a running light operation/action, a tail light operation/action, or any other operation/action that is intended to cause at least one light, for example LED's 1269 shown in FIG. 12 of a TLTCU that comprises implementation 1200 to illuminate, power system 1270 may provide power to circuitry or sensors coupled with module 1205 as well as to module 1205.

Most non-powered vehicles are exactly that: non-powered. There is a class of trailers that have electric brakes to meet regulatory requirements, and those trailers have constantly charged batteries to provide brake power in the event of a breakaway/separation of the towing vehicle and the trailer. This power system is limited to a small subset of utility trailers which represents a small subset of the trailers in the US. The lights of almost all non-powered vehicles use a positive voltage to operate. The best source of power is the longest running light power, (e.g., a taillight). A taillight is desired, or required, for nighttime operations and many commercial trucks/trailers operate taillights any time, day or night, while the vehicle is in motion. A challenge may arise when a trailer is only used during the daytime. For example, landscapers typically only cut grass during the day and typically do not operate running lights or taillights during the daytime. Accordingly, if used with a trailer that may not operate during the nighttime, power system 1270 shown in FIG. 12 may receive power via inputs 1262 and 1264 from a turn signal conductor, for example, conductors 206 or 208 shown in FIG. 2A, or a brake light signal, which may be simultaneously present on turn signal light conductors 206 and 208 as well as tail light conductors 204 shown in FIG. 2A.

An shown in FIG. 12, inputs 1262 and 1264, which may be coupled to conductors that may provide power to a typical taillight, assembly, may be combined or “OR′d” together with diodes 1266 and 1268 to facilitate power that may be present at either input being usable to provide power to circuitry, sensors, or processor corresponding to implementation 12 and to simultaneously charge battery 1276. Battery 1276 may provide power when a TLTCU that comprises implementation 1200 is not receiving power from brake-light, turn-signal, or taillight inputs (e.g., inputs 1262 or 1264) via regulator 1272 and regulator 1278. Battery 1276 may also provide power when a trailer that comprise a TLTCU that comprises implementation 1200 is disconnected from a towing vehicle and/or sitting idle and thus not having access to power via inputs 1262 or 1264. Battery may be specified to provide power for many days or months to the TLTCU and may be capable of being recharged to a full charge by a single daily trip, assuming adequate application of brakes, turn signal(s) or brake lights by an operator of a vehicle that is towing the trailer.

Implementation 1200 illustrated by FIG. 12 may comprise WiFi/Bluetooth central processing unit 1220 to facilitate novel functionality with respect to a taillight assembly. Processing unit 1220 adds functionality to a taillight that is equipped with a tracking device such that a taillight that comprises or incorporates implementation 1200 can function as a telematics control unit (“TCI”) (e.g., thus the reference herein to ‘taillight TCU’ or ‘TLTCU.’ Bluetooth communication radio module 1220 may enable a TLTCU that comprises implementation 1200 to communicate with myriad sensors, which may comprise Bluetooth slave/peripheral devices, corresponding to a non-powered vehicle (e.g., a trailer without a power source). Instead of Bluetooth, other example embodiments may comprise module 1220 being a module, or modules, that facilitate other short-range radio technologies, for example, Wi-Fi, NearLink, near-field communications (“NFC”) ultra-wideband (“UWB”), LPWAN, Zigbee, LoRa, Z-Wave, Thread, IEEE 802.15.4, and numerous other low powered radio technologies implemented with discrete RF circuits, generally, but not necessarily, that may use unlicensed spectrum.

In an example embodiment, Wi-Fi functionality of module 1220, communicatively coupled with module 1205, could provide short range communications with respect to onboard sensors as well as offboard access points to facilitate communication to corporate WLANs and/or internet located wherein a trailer might stop for periodic refueling, overnight stays, and other stop points. Wi-Fi communications could be used to communicate trailer weight to regulatory highway weight stations. In an embodiment, Wi-Fi functionality could be used in a listen-only mode, listening for third party access points, capturing MAC addresses, to resolve locations using third party databases such as Google, Here, Skyhook, Combain or others at times where the trailer might not be within ‘sight’ of the sky (e.g., not with an unobstructed wireless path to at least one satellite), such as in garages, in tunnels, or under bridges. WiFi can be used to indicate to a TLTCU that the TLTCU is within range of a freight terminal and that certain internal operations and functions might not be necessary based on an assumption that being within range of a freight terminal likely corresponds to the trailer might be in a loading or unloading condition. Such operations may comprise inventory collection of Bluetooth tag IDs, corresponding to freight item(s), in an internal memory of the TLTCU.

Another example embodiment illustrated by FIG. 12, digital Hall-effect sensor 1242 may be used to provide enable or configuration signaling to central processing unit 1205 without breaking the envelope of a housing (e.g., of a taillight assembly) that may comprise implementation 1200. A user could use a handheld magnet to cause an indication, generated by a magnetic field of the magnet being proximate sensor 1242 causing sensor 1242 to generate a signal) to indicate to internal processor 1205 an enable signal and receive acknowledgement feedback by a special LED located within the housing but visible thru a lens of the taillight. After a TLTCU may be initially enabled via passing a handheld magnet near a TLTCU such that a magnetic file produced by the magnet causes initialization of the TLTCU, normal operation of the TLTCU would not typically require that a user use a magnet for further operation of the TLTCU.

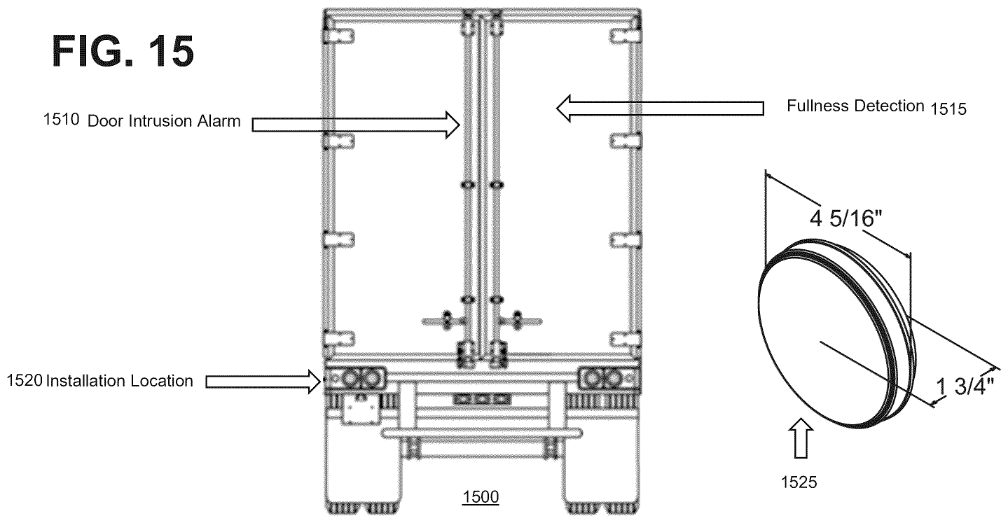

FIGS. 14 and 15 show locations 1401. 1402, 1403, 1404, and 1405 on semi-trailer 1400 and locations 1510, 1515, 1520 on semi-trailer 1500, respectively, usable for possible locating of Bluetooth sensors. Sensors, and combinations of different types of sensors, may be optional but may be included into the TLTCU ecosystem depending on the interest of operator of trailer 1400 or trailer 1500. A sensor may be at location 1401, which may correspond to a “kingpin” associated with trailer 1400, and a kingpin is typically a pivot point between a tractor and semi-trailer, for example trailer 1400 or 1500. The kingpin is the component used to connect a semi-tractor and semi-trailer. The kingpin keeps the trailer and the tractor together while allowing the tractor to turn and pivot around its fixed point ensuring semi-trucks to facilitate the tractor towing the trailer loaded with freight. Kingpin locks may be used in the trucking industry to prevent a semi-tractor from attaching to the semi-trailer by blocking the pin attaching to the “fifth wheel” or hitch plate. The fifth wheel/hitch plate is the plate above the tractor's back wheels where the kingpin hooks the trailer to the tractor.

A trailer 1400 or 1500 may comprise at least one taillight having form factor 1525. A TLTCU 1200, comprising components described in reference to FIG. 12, may be enclosed by a taillight housing and lens having taillight form factor 1525.

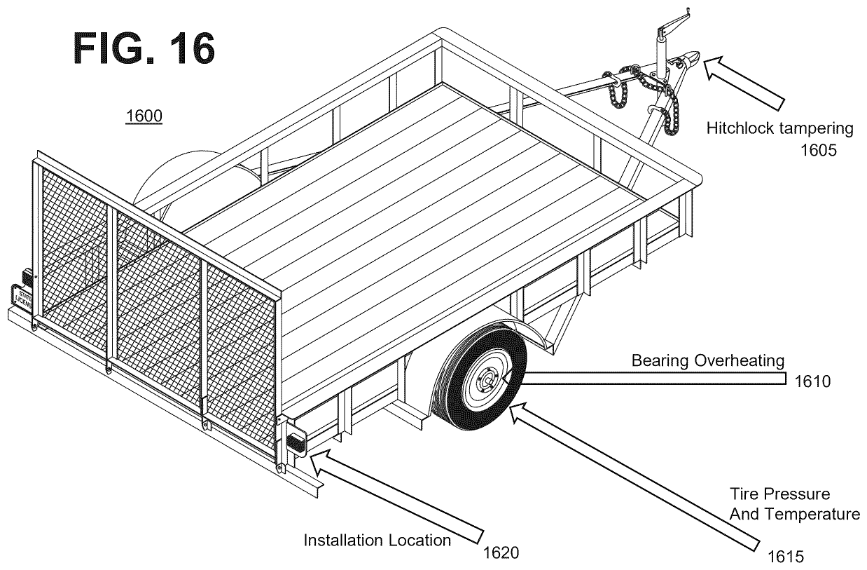

FIG. 16 illustrates locations 1605, 1610, 1615, and 1620 on a light duty trailer 1600 that may be used, for example, by a landscaper to haul landscaping equipment.

Sensors with Bluetooth radio capabilities that are designed to measure parameters corresponding to a location where the sensor is placed, for example a sensor placed at location 1610 may be designed to measure bearing temperature and a sensor placed at location 1615 may be designed to measure tire pressure. Accordingly, in an example embodiment, a heat sensor placed at 1610 may transmit measured temperature values corresponding to temperature of a bearing located at location 1610 to Bluetooth radio 1220 module via Bluetooth radio signals 1290. Similarly, other sensors located on trailers 1400, 1500, or 1600 may measure and detect measured parameter values corresponding to parameters for which the sensors are designed to measure and may transmit signals representative of the measured values via Bluetooth radio signals 1292 Bluetooth radio module 1220.

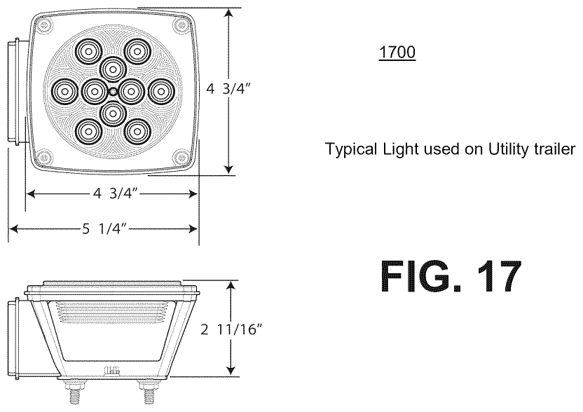

FIG. 17 illustrates a typical form factor for a taillight 1700 that may be used on a light utility trailer. A TLTCU 1200, comprising components described in reference to FIG. 12, may be enclosed by a taillight housing and lens having taillight form factor 1700.

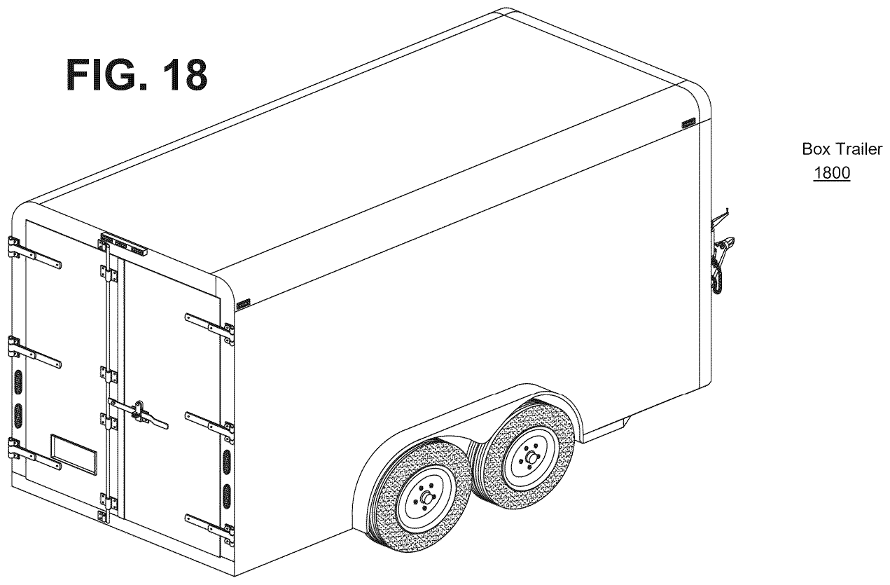

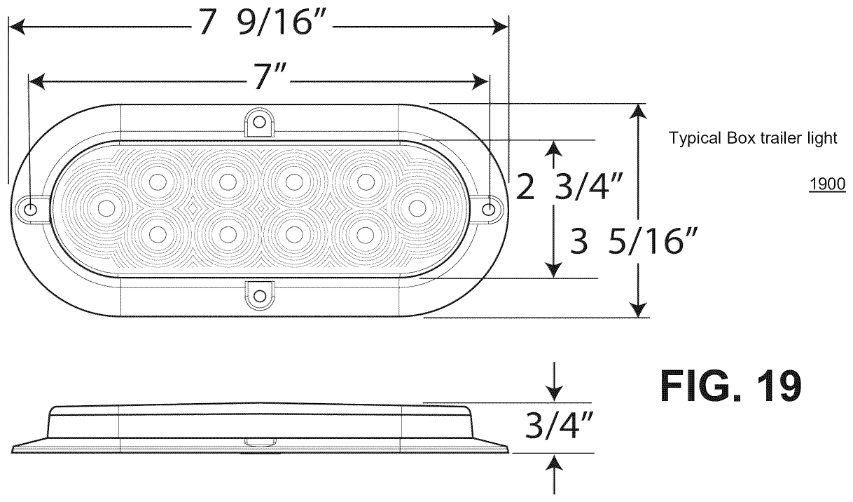

FIG. 18 illustrates box trailer 1800 that may be used 2 haul a variety of item types, and FIG. 19 illustrates a typical form factor for a taillight 1900 that may be used on a box trailer. A TLTCU 1200, comprising components described in reference to FIG. 12, may be enclosed by a taillight housing and lens having taillight form factor 1900.

A single light on each side of the rear of small trailers, such as, for example, light duty trailer 1600 or box trailer 1800 is typically used, whether the trailer is open, a boat trailer, or a small utility trailer. Replacing one of those lights with a taillight with TLTCU 1200 functionality may provide multiple advantages. An important function is theft protection. These small trailers are used by many different businesses and individuals alike. Almost every landscaper has at least one of these trailers with his landscaping tools. They are frequently stolen, even from the street while the landscaper is working. The covert nature of the tail light tracking capability adds significant value. Once a small utility trailer is stolen, there is only very a very small chance that the trailer or the equipment will be recovered. There are not many “Be On the Lookout” alerts for small trailers that are successful like that of a truck or car. Unfortunately, these are difficult to describe and identify is a few words.

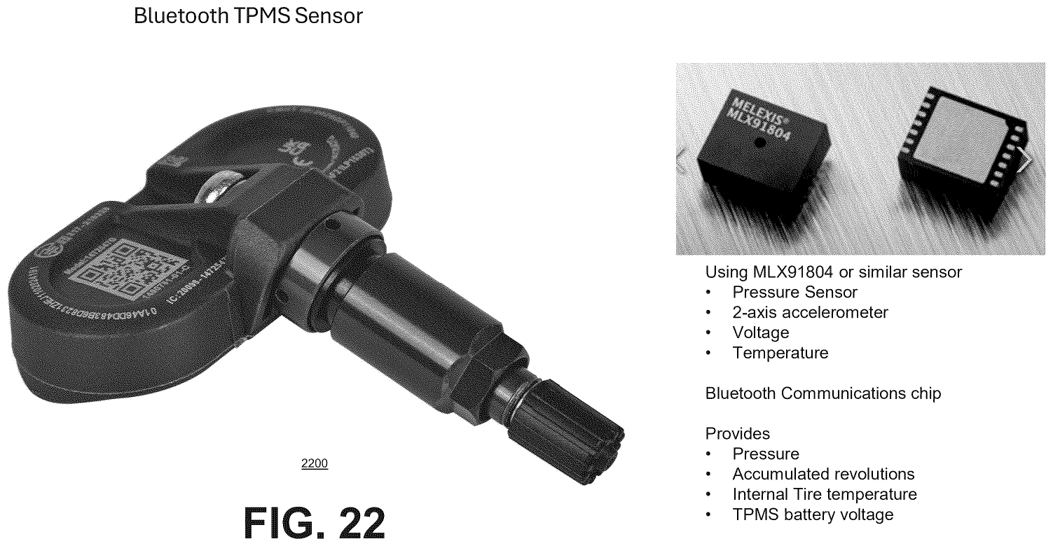

Use of these trailers is varied and available sensors specific to a small trailer owner/operator is small. As described in reference to FIG. 22, Bluetooth enabled sensor 2200 may facilitate tire pressure, temperature, battery voltage and tire revolution counting, all of which would be extremely useful to an owner/operator providing maintenance reminders and alerts for important things like low tire pressure. Another feature that the Bluetooth-enabled sensor 2300 might facilitate is theft alert. Monitoring the revolutions of the tires is a way of being determining that a trailer is moving. It is possible to create a mobile application that provides a “Set Alarm” function when the trailer should not be tampered with. If the tires are stolen or tampered with, the mobile application can provide an alert notification.

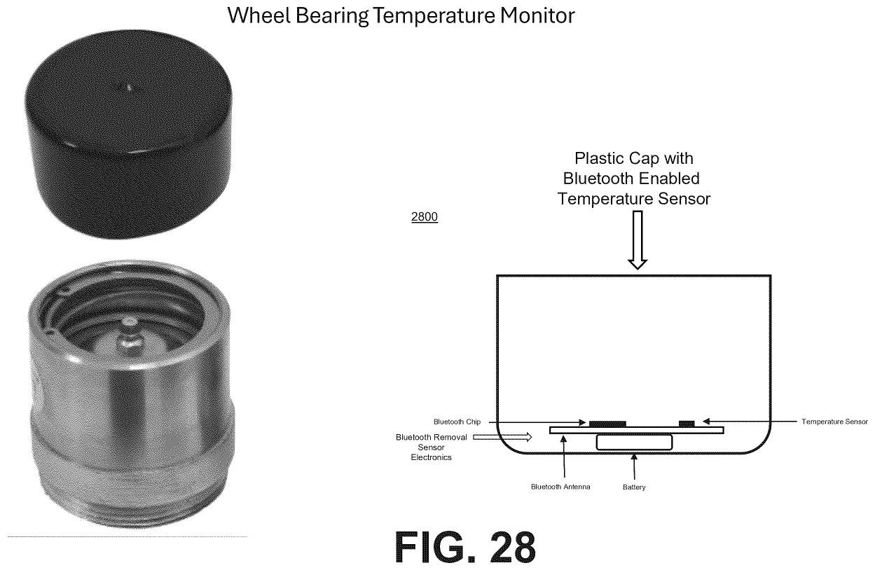

Frequently the failure mode for small trailers is wheel lockup. Frequently, especially with boat trailers, small trailers end up on the side of the roadway with a frozen bearing due to lubrication issues and wheel lockup. FIG. 28 illustrates a simple, low-cost wheel bearing sensor 2800 solution when used with the TLTCU. The Bluetooth-enabled Wheel Bearing Temperature monitor can report any unusual temperature rises that could lead to a frozen wheel bearing. The sensor can report a temperature and event and the TLTCU can report that event to the cloud for relaying as an alert to a smart phone. The hardware to provide bearing temperature notifications is simple and low cost and may comprise a Bluetooth transceiver and temperature sensor. Each wheel of a small trailer can be equipped with a sensor 2800 on the grease cap of an axle.

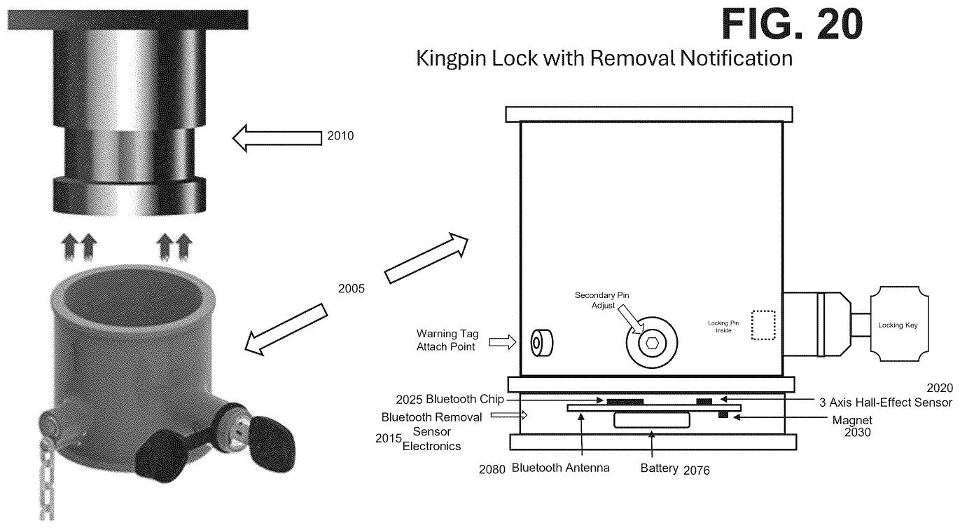

FIG. 20 illustrates a Bluetooth equipped and enabled kingpin lock 2005, designed to receive kingpin 2010. Kingpin locks are well known to the trucking industry. If a kingpin lock is removed, and it is the only theft protection on a trailer, then the trailer can be stolen. According to embodiments disclosed herein, notification of theft of a kingpin lock may be provided to TLTCU 1200, as described in reference to FIG. 12, which may be housed by a tractor trailer taillight form factor, and the TLTCU may wirelessly transmit the theft notification to a cloud-based computer server to inform an owner/operator of the trailer, from which the kingpin lock was stolen, of the theft of the kingpin lock. Basic operation of a kingpin lock depends on a sturdy metal sleeve with retractable locking pins that prevent the sleeve from being removed from the kingpin itself. Bluetooth kingpin lock 2005 may comprise circuitry 2015 that may comprise three-axis hall effect sensor 2020 included as a peripheral with respect to Bluetooth central processing unit 2025. Sensor 2020 may be a low-power linear 3D hall-effect sensor with an I2C interface. Sensor 2020 may integrate three independent hall-effect sensors in the X, Y, and Z axes. A precision analog signal chain along with an integrated 12-bit ADC may digitize measured analog magnetic field values. A feature of three-axis hall effect sensor 2020 is an interrupt to the Bluetooth central processing unit indicating a change in magnetic field values. The I2C interface provides communications to the central processing unit. A typical implementation is exemplified by the Texas Instruments TMAG5273. Sensor 2020 may be configured to be an integral part of Bluetooth-enabled, kingpin lock 2005, featuring theft detection functionality, to measure at least one magnetic field generated by magnet 2030 to determine removal of kingpin lock 2005 from kingpin 2010. (An owner of a trailer having kingpin 2010 may park the trailer, unconnected to a towing vehicle, and may place kingpin lock 2005 on kingpin 2010 to prevent theft of the trailer and receiving a notice of the detecting of unauthorized removal of kingpin lock 2005 may facilitate stopping theft of the trailer or at least recovery of the kingpin lock. As described in reference to FIG. 12, removal of kingpin lock 2005 from kingpin 2010 may be detected by sensor 2020 because magnet 2030 and kingpin 1201, presumable made from ferrous material such as steel, create a magnetic field pattern such that sensor 2020 measures field produced by the magnet and modified by the steel kingpin, and when the kingpin lock is removed from the kingpin, the magnetic field pattern changes and thus the measured magnetic field strength corresponding to the magnetic field pattern changes and may trigger Bluetooth module 2025 transmitting a lock removal message to a Bluetooth radio module (e.g., module 1220 shown in FIG. 12) of a TLTCU that is part of the trailer corresponding to the kingpin from which the kingpin lock is removed. In response to receiving the lock removal message, module 1205 of the TLTCU, powered by battery 1276 (because the trailer is not connected to a towing vehicle to supply power to the TLTCU), may transmit an alert message, directed to an owner of the trailer, via a long-range wireless, via a Wi-Fi link, or via a Bluetooth link. Bluetooth-enabled kingpin lock 2005 may comprise Bluetooth antenna 1280 coupled with Bluetooth module 2025 and battery 2076 that provides power to components of circuitry 2015.

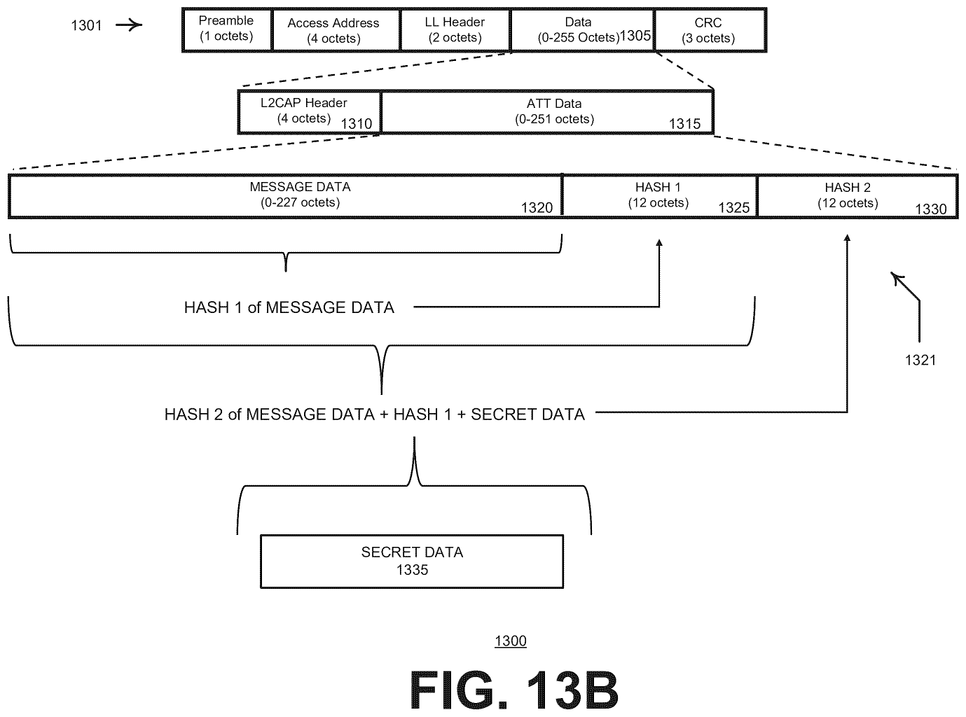

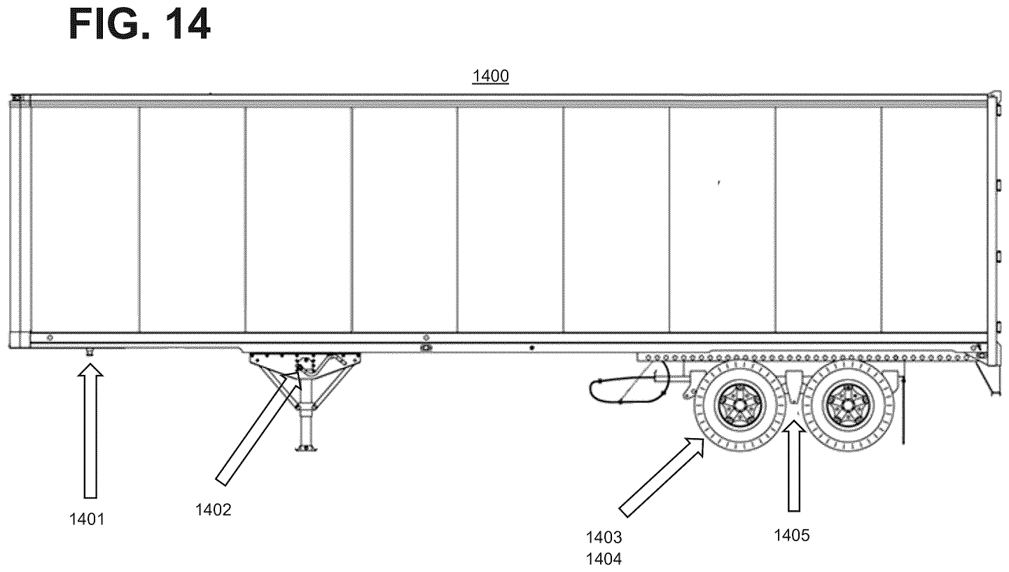

In an example embodiment, since the Bluetooth messages sent by kingpin lock 2005 may be designated as critical alarm messages, the messages may be constantly changed, or changing, with respect to time, periodically, sporadically, according to configuration, or according to other information or data, and may be encoded with, or accompanied by, at least one hash function result, and preferably two different hash function results, that may be usable to perform at least one authentication action to facilitate preventing message spoofing by the thief or other malicious actor. As shown in FIGS. 13A and 13B, the two different hash results may enable a local taillight TCU 1200 to authenticate a message received by module 1220 from Bluetooth module 2025 using an internal hash computation with respect to a first hash value, while the second hash result, that may have been generated by Bluetooth module 2025, may be sent to a cloud server (e.g., TOC server 147 shown in FIG. 1) to be validated against unique private keys ‘known’ only by, or uniquely configured into, kingpin lock module 2025 and the cloud server or a cloud hardware security module (“HSM”). Kingpin lock module 2025 may use the hash value(s) to create example embodiment secure Bluetooth beacon technology, as described in greater detail in reference to FIGS. 13A and 13B, which may be referred to herein as secure Bluetooth beacon, or simply secure beacon.

Returning to FIG. 14, location 1402 may correspond to a landing gear of semi-trailer 1400. The landing gear is typically retractable support equipment that keeps trailer 1400 level when the trailer is uncoupled from a semi-tractor. The landing gear typically consists of two legs near the front of trailer 1400 that can support the weight of the trailer. A leg with an internal gearbox and crank is typically referred to as a driving leg and the other leg is typically referred to as a driven leg. The two legs are typically connected by a central transmission rod known as a cross shaft. To raise or lower both legs at the same speed, an operator/driver rotates the crank clockwise or counterclockwise. The crank and input shaft engage a low gear to add a mechanical advantage when raising the trailer with cargo weight.

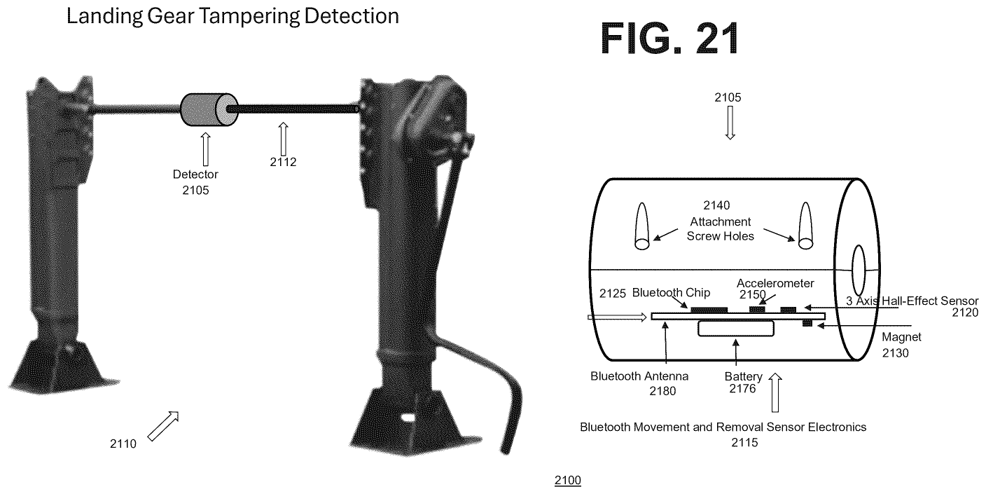

FIG. 21 illustrates a Landing Gear Tampering Detection System (“LGTDS”) 2100. System 2100 may detect movement or removal of the landing sensor/detector 2105. Detection sensor 2105 may be attached to cross shaft 2112 and secured screws through attaching screw holes 2140. Sensor 2105 and shaft 2112 may create a friction, or interference, fit so that the sensor will not slide or rotate with respect to the cross shaft. Thus, movement or rotation of cross shaft 2112 is detected by accelerometer 2150, and removal of sensor 2105 from shaft 2112 will trigger hall-effect sensor 2120 to provide notification to a TLTCU 1200 corresponding to a trailer associated with landing gear 2110 when a magnetic field generated by magnet 2130 is disturbed because of sensor/detector 2105 being moved away from shaft 2112.

LGTDS 2100 may comprise battery powered Bluetooth transceiver 2125, accelerometer 2150, three-axis hall effect sensor 2120 included as a peripheral, which may be hard-wired to Bluetooth central processing unit 2125. Sensor 2120 may be a low-power linear 3D Hall-Effect sensor with an I2C interface. This device integrates three independent Hall-effect sensors in the X, Y, and Z axes. A precision analog signal chain along with an integrated 12-bit ADC digitizes measured analog magnetic field values. A feature of the three-axis hall effect sensor is an interrupt to the Bluetooth central processing unit 2125 indicating a change in measure magnetic field values. The I2C interface provides communications to the central processing unit. A typical implementation is exemplified by the Texas Instruments TMAG5273. The linear 3D Hall-effect sensor may be an integral part of the LGTDS theft detection system and with 2130 magnet shown to set up a magnetic field, will indicate removal of the LGTDS detector 2105 from cross shaft 2112.

In an example embodiment, since the Bluetooth messages sent by LGTDS detector 2105 may be designated as critical alarm messages, the messages may be constantly changed, or changing, with respect to time, periodically, sporadically, according to configuration, or according to other information or data, and may be encoded with, or accompanied by, at least one hash function result, and preferably two different hash function results, that may be usable to perform at least one authentication action to facilitate preventing message spoofing by a thief or other malicious actor. As shown in FIGS. 13A and 13B, the two different hash results may enable a local taillight TCU 1200 to authenticate a message received from Bluetooth module 2125 using an internal hash computation while the second hash result, that may have been generated by Bluetooth module 2125, may be sent to a cloud server to be validated against unique private keys known only by the local TLTCU 1200 and a cloud server (e.g., TOC 147 shown in FIG. 1) or cloud hardware security module (“HSM”). LGTDS detector module 2125 may use the hash value(s) to create example embodiment secure Bluetooth beacon technology, as described in greater detail in reference to FIGS. 13A and 13B, which may be referred to herein as secure Bluetooth beacon, or simply secure beacon.

Returning to FIG. 14, location 1403 may correspond to tires of trailer/vehicle 1400. On a typical heavy-duty semi-trailer there are eight tires on two axles carrying about half the weight of the trailer. Some European countries have used much larger tires and European trailers may use only 4 tires or in some cases, for super heavy weight carrying capacity, twelve tires in the United States or six larger tires in Europe. Monitoring trailer tires and regularly checking tire pressure is desirable to ensure safety of the tractor and trailer and to ensure longevity of the tires. Although it may be desirable to monitor tire pressure on all tires of a trailer, pressure is typically measured on only a few tires of a trailer.

FIG. 22 illustrates a Tire Pressure Monitoring System Sensor 2200 (“TPMS”), which may comprise several features. A desirable function of sensor 2200 is to measure the tire pressure. In addition, sensor 22 may be equipped with a temperature sensor, a voltage sensor, and an accelerometer. The temperature sensor may be configured to detect the internal temperature of the tire. Tire temperature may be affected by several factors including friction between the tire rubber and road pavement (e.g., rolling resistance). As tire temperature increases tire pressure also typically increases. Cold tires and potholes can cause the bead between the rubber and the rim to allow air to leak out. Operating tires beyond their maximum speed rating can cause excessive heat buildup which may lead to premature failure. Overloading a trailer can cause excessive heat buildup. With low air pressure in the tires, the sidewalls flex more and heat builds up within the tire causing premature failure. Low air pressure is a phenomenon that a fleet operator seeks to avoid because low air pressure tends to result in increased tire wear and tear, which typically translates into higher repair costs and maintenance-related downtime of a trailer.

FIG. 22 illustrates an MLX91804 provided by Melexis, which may comprise a pressure, temperature, voltage sensor and a 2-axis accelerometer. The voltage sensor is useful to provide condition of a battery of sensor 2200. The accelerometer may be useful for providing tire revolution counting. The internal electronics in TPMS sensor 2200 can provide accumulated revolutions for calculation of mileage. Counting revolutions and known calibration information can provide accumulated mileage for the trailer at a very low cost. Accordingly, using sensor 2200 to count tire revolutions facilitates a useful function for a low cost.

Having tire information (e.g., temperature, pressure, rotation, etc.) associated with each tire of a trailer provides significant insight to the operations of commercial carriers. Having the tire information in real time provides significant information to a driver. Tire pressure alerts can notify a driver in almost real time when pressure drops. Blowouts and excessive heat are data desired by drivers. Maintenance alerts notify a commercial fleet operator or single trailer owner of required maintenance, for example, tire changes, wheel bearing grease and other maintenance, brake inspections, and brake overhaul.

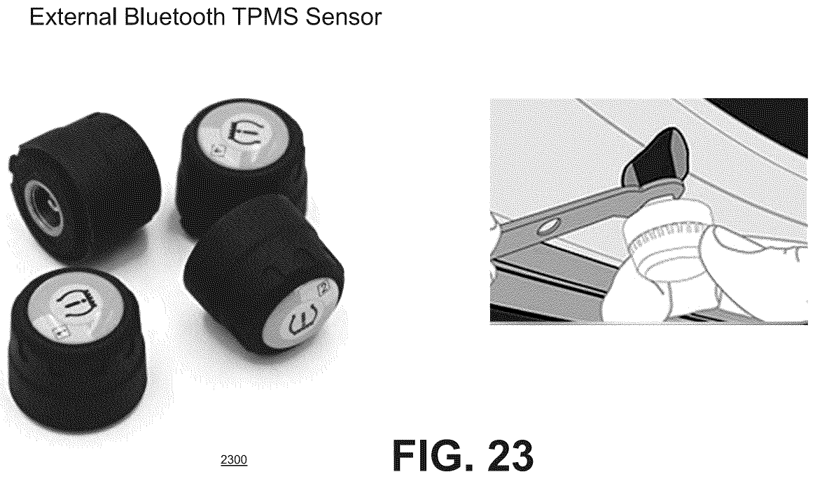

FIG. 23 shows Bluetooth enabled TPMS monitoring sensor 2300 for the outside of the tire. Sensor 230 does not require removal of the tire itself from a wheel. Sensor 2300 can be added to existing tires without much effort by screwing the sensor into a tire inflation valve stem but come with significant disadvantage with respect to sensor 2200 described in reference to FIG. 22. Sensor 2300 shown in FIG. 2300 may be best used by small trailers with one or two axels and only one tire per axle. Sensor 2300 can include revolution counter functionality but a temperature sensor at this location would provide limited functionality. A major disadvantage is that they must be removed to add to or remove air from tires. Because the installation method requires the tire stem valve to be actuated (e.g., opened), sensor 2300 must be completely leak free when mounted on the body of the valve stem. Typically, a special wrench is required to install or remove sensor 2300. Additionally, the off-center weight could cause long term wear issues that tires balanced with internal sensors don't experience.

Location 1404 shown in FIG. 14, illustrates location of the brakes of heavy-duty semi-trailer 1400. Mountainous regions use runaway truck ramps on steep downhill grades for runaway trucks to facilitate stopping vehicles that may be experiencing braking problems. The problem often encountered is brake failure due to brake overheating. Normally a heavy vehicle should use lower gears and engine braking effect to slow the decent of the vehicle on a steep downhill grade. If the brakes are aggressively used, or if the brake pads are installed incorrectly, or if low quality or worn pads or rotors are present, brakes can overheat.

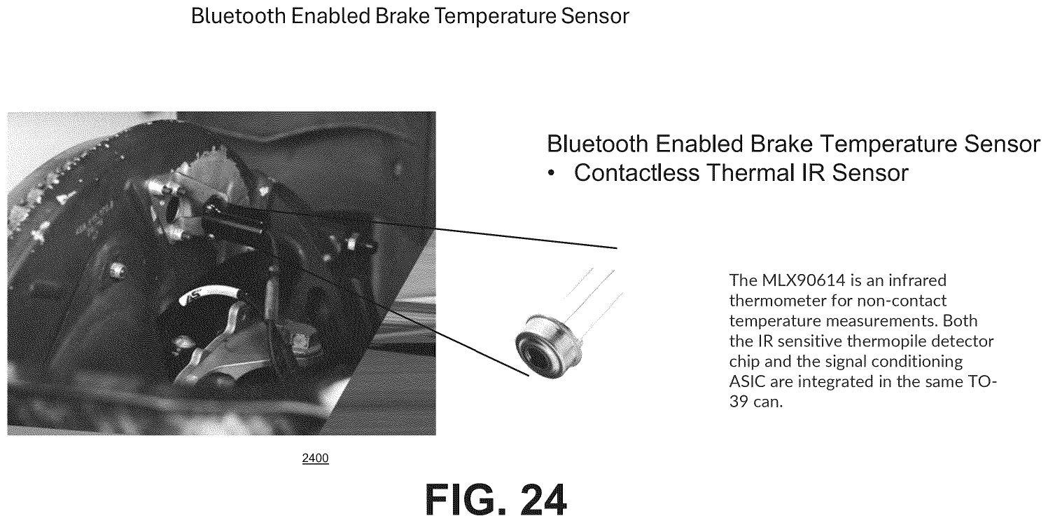

FIG. 24 illustrates a Bluetooth brake temperature monitoring sensor 2400. Sensor 2400 can be installed on one axle or on all brakes on a trailer with case. No wiring is required. Sensor 2400 may use a low power infrared thermometer for non-contact measurements. The IR sensitive thermopile detector chip and the signal conditioning may be contained in a single TO-39 can. The output of sensor 2400, for example a MLX90614 from Melexis, may be I2C and can connect directly to a Bluetooth radio, for example module 1205 that is part of TLTCU 1200 shown in FIG. 12. Sensor 2400 may facilitate a 380° Celsius measuring range that allows accurate temperature measuring of overheated brakes. Low power consumption coupled with periodic readings typically results in many years of battery life with small batteries.

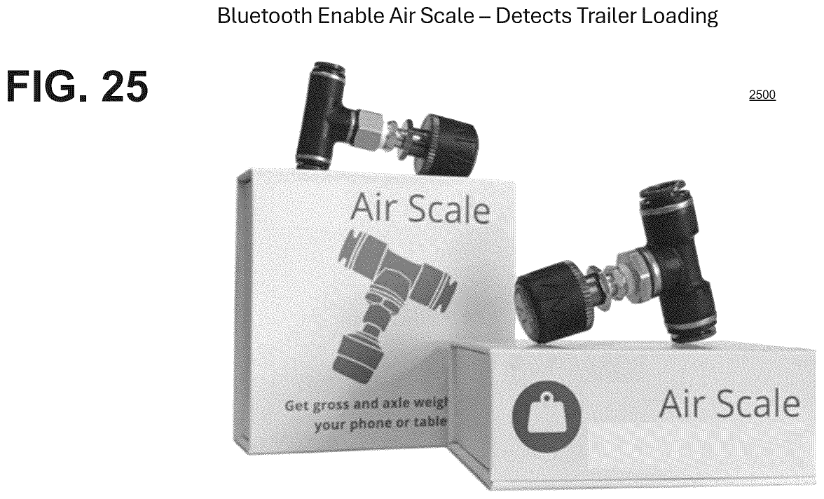

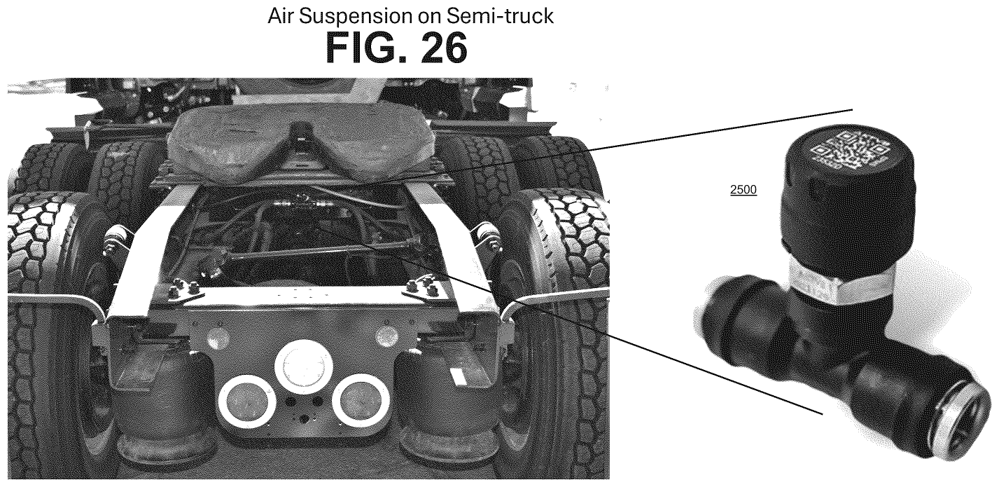

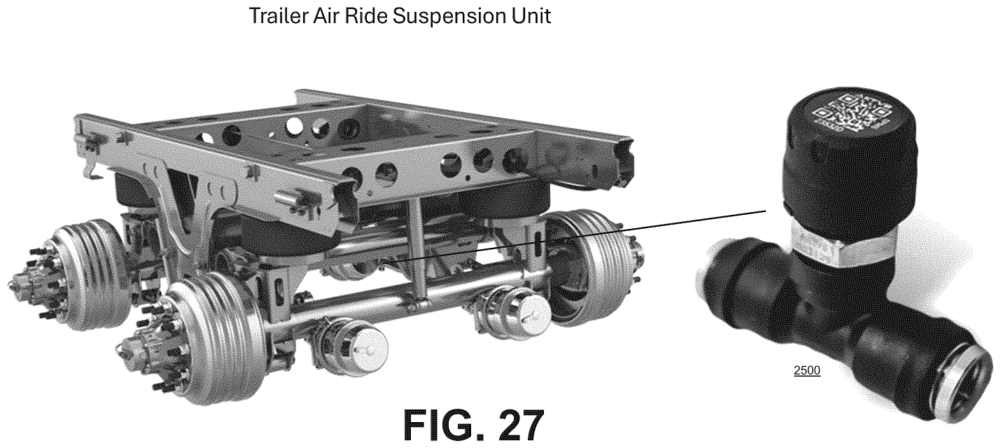

Location 1405, shown in FIG. 14, illustrates a location used to install Bluetooth Enabled Air Scales 2500 shown in FIG. 25-27. As shown in FIGS. 26-27, many heavy-duty trailers have an air ride suspension system. This system is a low technology system that uses air pressure from the semi-tractor (as supplied through a red hose connection) to inflate rubber bladders or bellows or airbags to raise the trailer to level it as cargo weight is added. A lever mechanism adds air as required or drains air as required to keep the rear of the trailer level. The red hose provides between 100 and 130 PSI to the trailer, but the mechanical lever system only pressurizes the air bellows with 40 to 60 PSI. Installing pressure measuring system 2500 as shown in FIGS. 26 and 27 on a lower pressure side of the mechanical lever system allows measuring system 2500 to measure the pressure and transmit it via Bluetooth to a Bluetooth receiver, for example module 1205 that may be part of TLTCU 1200 described in reference to FIG. 12. Using system 2500 system may facilitate determining weight of a load in a trailer using system 2500.

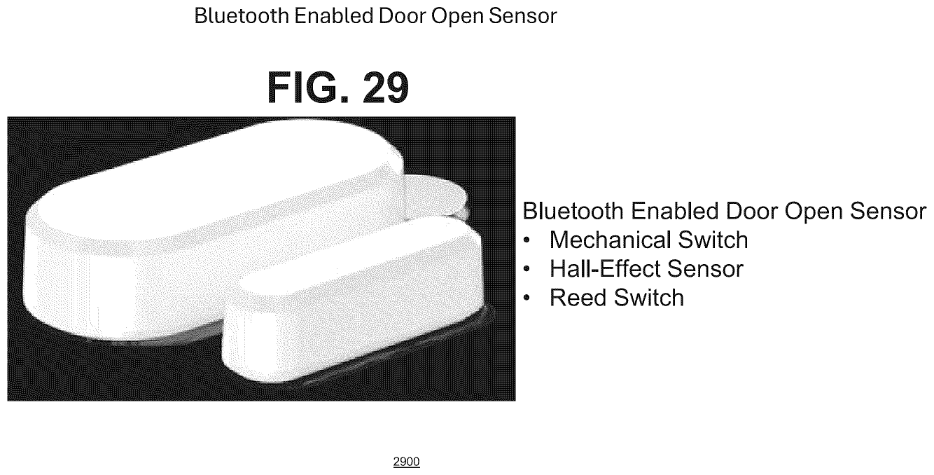

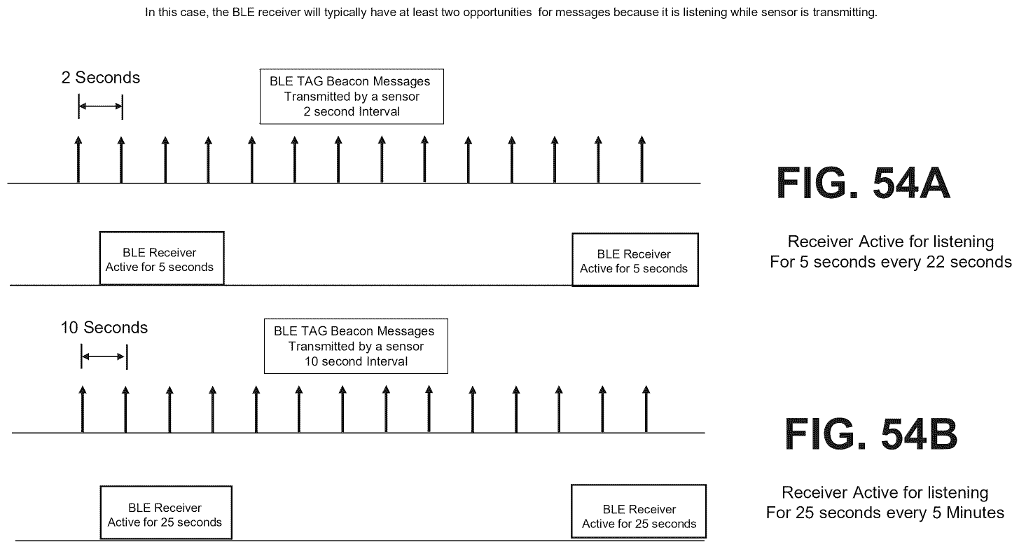

The rear end of a heavy-duty semi-trailer 1500 is shown in FIG. 15. A possible installation location 1520 for a TLTCU 1200 is shown. A TLTCU, or taillight that is not a TLTCU, may have form factor 1525. Taillights, or at least one TLTCU, may be used in four different places on the rear of semi-trailer 1500. A door intrusion alarm can be installed on the inside of the rear door at location 1510. Several different technologies can be used to provide “door open” indications, including mechanical switches, Hall-effect based sensors or reed switch sensors. Hall-effect and reed switch sensors typically use a companion magnet to enable sensing. FIG. 29 shows a Bluetooth enabled sensor 2900 with magnet. When the magnet separates from the sensor a specific distance the sensor indicates an open door. With a Bluetooth-based sensor, the sensor may be used in a beacon mode such that a Bluetooth module may be continuously transmitting a short message as described in reference to FIGS. 13A and 13B. The message may be received the next time module 1220 in the taillight TCU 1200 turns on its receiver and detects the message. If module 1220 receiver is turned on for 5 seconds every 15 seconds, it could take up to 20 seconds, or more, for notification. The timing of operating the BLE receiver and the duty cycles for energy preservation are described in reference to FIGS. 54A and 54B. It should be understood that the notification is not instantaneous (in terms of milliseconds) and the notification after a restoration is also not instantaneous since it is desirable to ensure the quick open-close of the door is fully reported to the vehicle operator. Typically, Bluetooth Low Energy sensor 2900 may be set to constantly broadcast a status message every 2 to 4 seconds. That status message may include a bit that indicates the current door status at the exact moment the message is sent. It may also indicate another bit indicating a previous open, with a timer value indicating the number of seconds since the door was opened, another bit in the case of a close, with a timer value indicating the time since it was closed. So, if a loose door creates a door alarm, then the two timers should indicate the door is closed and a very short difference between the opening and closing. Further, if the door was opened for 2 minutes, then closed, the difference between the two times will indicate a two-minute open period, but the door is closed now. Two minutes is long enough for a thief to enter and remove something. Five seconds might indicate a loose door. The beacon message can broadcast this message for perhaps five minutes or ten minutes to accommodate the wakeup cycle of BLE receiver of module 1220. BLE receiver of module 1220 might only operate once every 5 minutes to save energy for an unpowered and unmoving trailer, whereas the receiver might operate every 30 seconds for a powered and or moving vehicle, since the taillights or brake lights are likely to operate often enough to avoid depletion of charge of battery 1276.

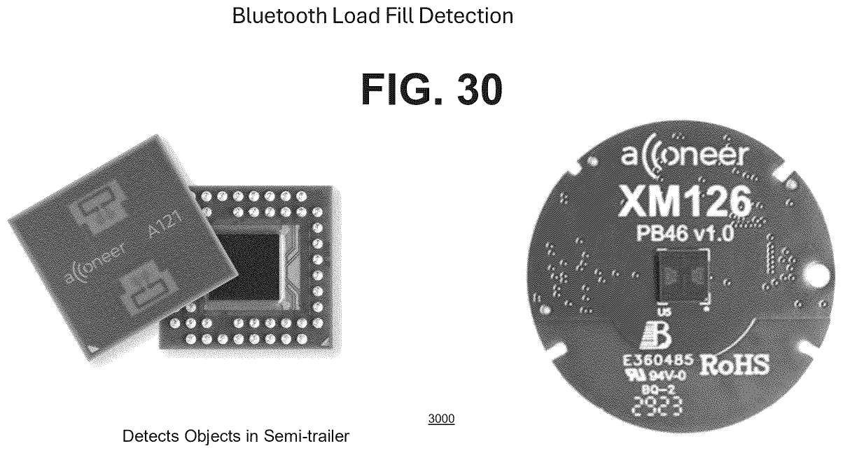

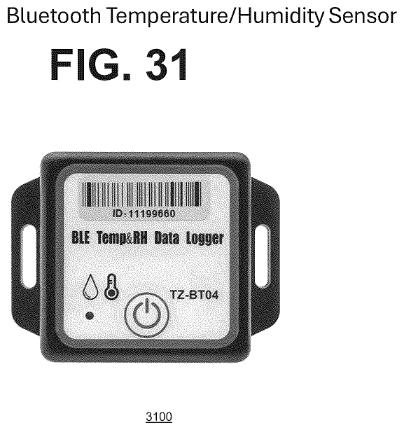

FIG. 15 illustrates a possible location for mounting a Bluetooth-based fullness detector inside the rear door. The fullness detector may use a 60 GHz Pulsed Coherent Radar chip from one of several semiconductor makers. Infineon and Acconeer make such example chips that include complete radar circuitry and antennas on a single package that is mounted to the Printed Circuit Board [PCB] assembly. As illustrated by FIG. 30, XM126 printed circuit board 3000 with A121 from Acconeer may comprise a Nordic Semiconductor Bluetooth transceiver. The Pulsed Coherent Radar chip uses extremely low power and depending on duty cycle, the solution can last up to ten years without a battery replacement. The XM126 uses the A121 pulsed coherent radar chip with a range of around 20 meters, which is long enough for a standard 53-foot semi-trailer. Although it is possible to load the truck so that all the freight is on the floor and additional pallets of freight could be added as a second layer, the A121 can very accurately measure the distance to the first object in the truck. Sensor 3000 can accurately measure the 53-foot length if the truck is empty. Theoretically, the single sensor 3000 could include a door opening sensor (e.g., sensor 2900 shown in FIG. 29), eliminating one additional part for full sensing on a heavy-duty semi-trailer 1500. As shown in FIG. 31, temperature/humidity sensor 3100 could be included with sensitive cargo and the cargo could be monitored with configured thresholds/criteria that may trigger transmitting an alert message if a configured threshold or criterion is not satisfied.

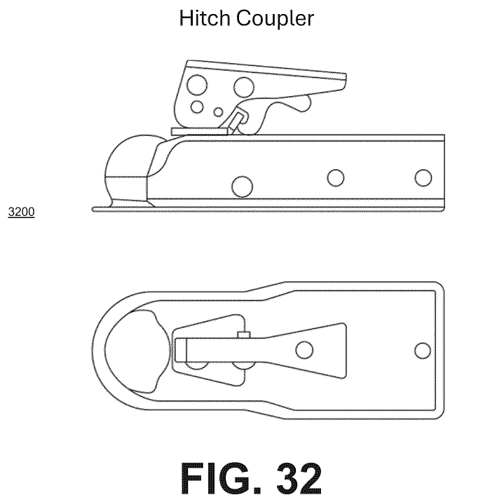

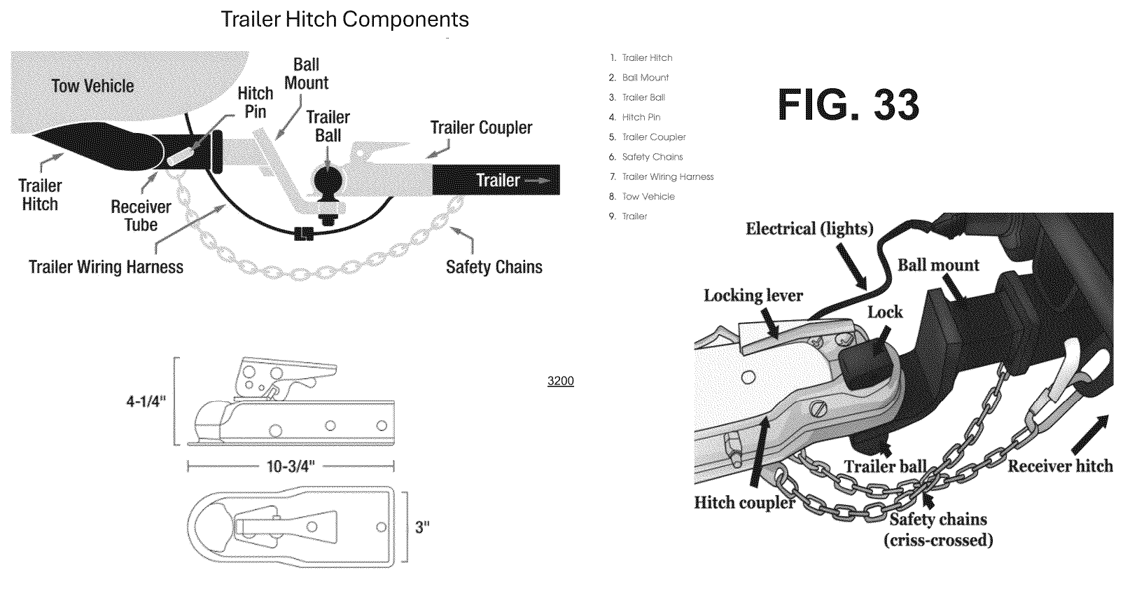

Light-duty utility trailers almost always use a simple well-known hitch 3200 shown in FIGS. 32 and 33 for attachment to light-duty vehicles such as pickup trucks and cars. These hitches involve three different classes of trailer hitches, all among the larger class of “light duty trailers”, that is trailers towed by passenger cars and pickup trucks. The classes are light-duty towing, medium-duty towing and heavy-duty towing. The classes are separated by the ball size of the hitch. The ball sizes are 1⅞ inches, 2 inches and 2 5/16 inches. The hitch attachment on a vehicle is rated in classes and theoretically an operator should not put a heavy-duty towing hitch ball on a vehicle equipped with a light duty hitch assembly. Locking a trailer to prevent another unauthorized vehicle from towing is well-known. If the hitch itself is blocked, then it becomes practically impossible to attach the trailer to the receiving ball of an unauthorized towing vehicle. There are many arrangements to lock the hitch, but the most successful locks fit over the hitch in some manner and are locked into place.

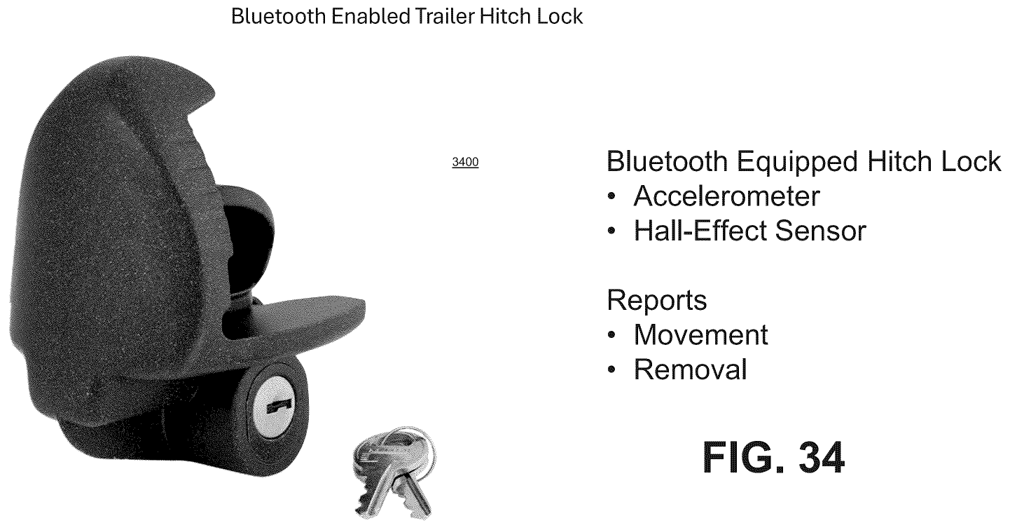

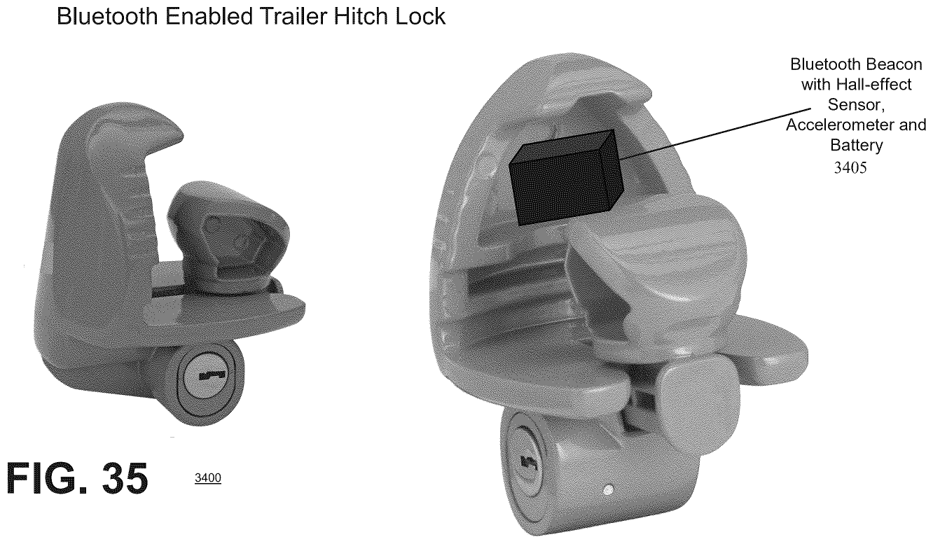

According to example embodiments disclosed herein, a standard hitch lock may be equipped with a detection circuit to result in an example embodiment Bluetooth-enabled hitch lock 3400 as shown in FIGS. 34 and 35. Lock 3400 may provide notification of removal of the lock from a trailer. Since the trailer hitch is almost always constructed similarly, almost all trailers can be locked and almost all Bluetooth enabled hitch locks can provide removal notification.

According to an example embodiment, hitch lock 3400 may comprise electronic circuitry comprising a Hall-effect sensor and a magnet or inductive sensor to detect magnetic field differences and an accelerometer to detect tampering. The Hall-effect circuit and magnet could be replaced by a hitch-lock comprising a mechanical switch, light detector switch, an accelerometer by itself, a passive infrared detector, a motion sensor, a pulsed radar detection circuit, a photo interrupter circuit, ultrasonic, strain gauge, inductive proximity sensor, capacitive proximity sensor, photoelectric, IR time of flight, or any other well-known sensor technology to detect hitch lock attachment and unattachment to a hitch.

According to an example embodiment, hitch lock 3400 may comprise a small waterproof Bluetooth enabled sensor 3405 that fits in the cavity of the hitch lock shown in FIG. 21. This is an example mechanical lock that provides mechanical security. The security of this lock is only as good as the lock cylinder technology to protect against lock picking. The mechanical ability of this lock will stop honest people but does little to stop a determined thief. The hitch “ball” is inserted into the ball receiver of the hitch coupler shown in FIGS. 34 and 35. Detector circuit 3405 may comprise either a hall-effect sensor/magnet combo or an inductive sensor to detect the metal mass of the hitch coupler. It should be clear that different mechanical locks may have different arrangements with respect to the locked hitch coupler and Bluetooth-enabled hitch lock 3400 could be appropriately modified to reflect the different mechanical design of the hitch lock.

In an example embodiment, since the Bluetooth messages sent by sensor 3405 may be designated as critical alarm messages, the messages may be constantly changed, or changing, with respect to time, periodically, sporadically, according to configuration information, or according to other information or data, and may be encoded with, or accompanied by, at least one hash function result, and preferably two different hash function results, to facilitating authentication of the messages to prevent message spoofing by a thief or other malicious actor. In an example embodiment shown in FIGS. 13A and 13B, a first of two different hash results, or hash values, may facilitate a local taillight TCU 1200 in authenticating a message received from Bluetooth module 2125 using an internal hash computation while a second hash result, that may have been generated by Bluetooth module 2125, may be sent by the TLTCU to a cloud server (e.g., TOC 147 shown in FIG. 1) to facilitate authentication of the message by validated against unique private keys known only by the Bluetooth module 2125 and the cloud server or cloud hardware security module (“HSM”). Detector/sensor 3405 may use the hash value(s) to create example embodiment secure Bluetooth beacon technology, as described in greater detail in reference to FIGS. 13A and 13B, which may be referred to herein as secure Bluetooth beacon, or simply secure beacon.

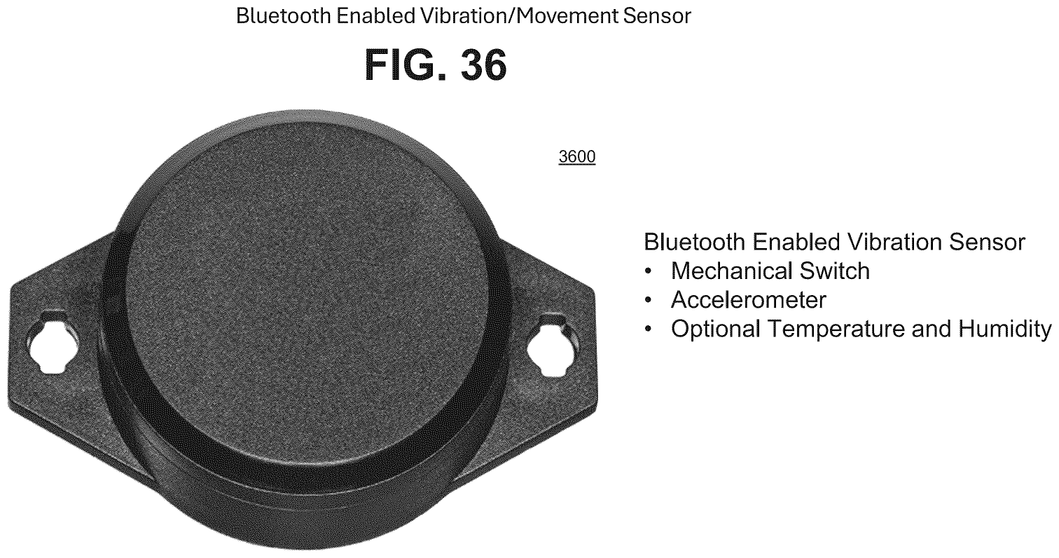

FIG. 36 shows a Bluetooth enabled vibration or movement sensor 3600. Sensor 3600 can be used to report various conditions and may comprise an accelerometer that can be used to detect various conditions to report devices being moved, in the case of theft, unusual vibrations in the case of out-of-balance tires, unusual movements in the case of flat tires and just about any other safety critical event that might occur. The accelerometer could be a simple 3-axis accelerometer detecting movement beyond certain thresholds or it could be an advanced AL/ML accelerometer like ST Microsystem's LIS2DUX12. This accelerometer can be trained to recognize out of balance tires and flat tires.

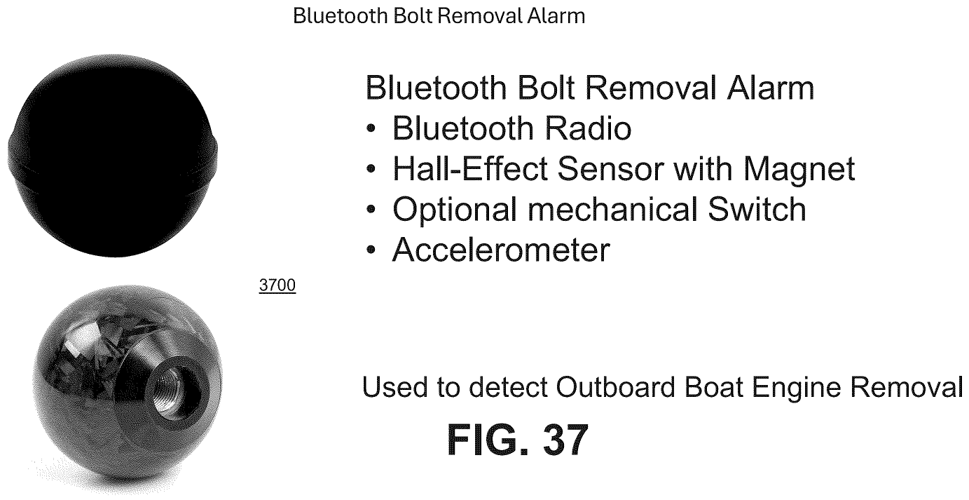

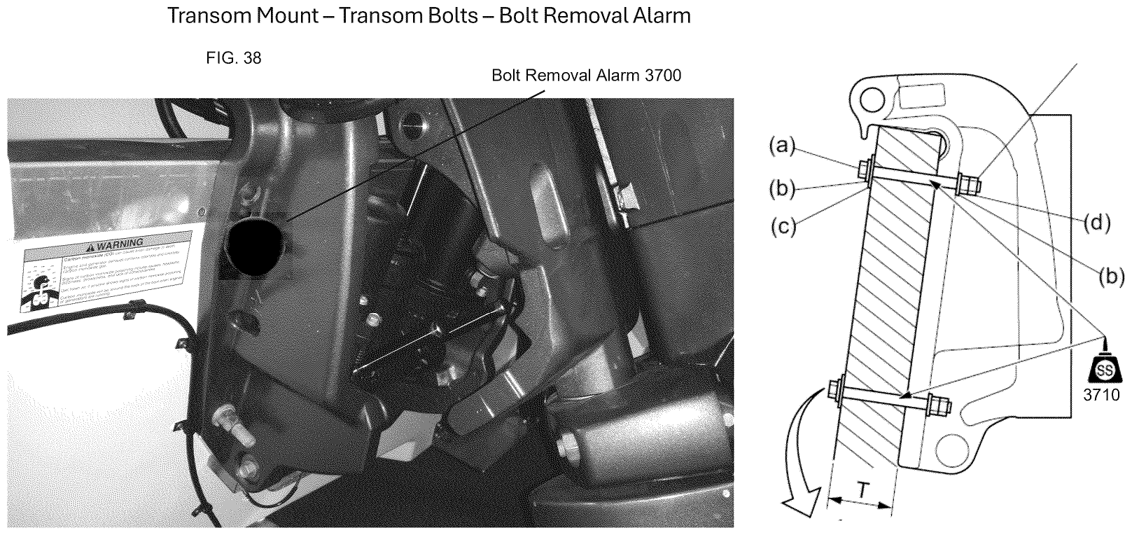

FIG. 37 shows a Bluetooth-enabled bolt removal alert device 3700 that may be used to detect removal of an outboard motor form a boat. Device 3700 may comprise a Bluetooth radio module coupled with an accelerometer and a Hall-effect/magnet or inductive proximity detection circuit. Device 3700 may alert the owner/operator of a possible boat motor, or other type of removable accessory/asset or theft or removal thereof. Principally designed for small boat owners, device 3700 detects and provides an early alert to the removal of an outboard engine on small watercraft. Sensor 3700 may be waterproof and self-contained and may be attached to the end of one of the transom bolts 3710 attaching the boat motor to the boat transom as shown in FIG. 38. If the transom bolt 3710 to which device 3700 is mounted is cut, rotated or removed, sensor 3700 may send, transmit, or direct, a different Bluetooth beacon message than a previously transmitted or directed Bluetooth beacon signal/message. The example embodiment shown in FIG. 37 is principally designed to be used for a boat stored on a trailer but may also be used in other scenarios or with other use cases.

Basic operation of the bolt removal alert device 3700 would have the owner/operator enable the alarm notifications during periods of non-use. The boat and trailer could have numerous sensors and any one of those sensors could indicate a potential theft. For example, bolt removal alert device 3700 could provide a beacon message after the alert is installed. Bolt removal alert (“BRA”) 3700 can be “set” or defined at installation by an installer using a mobile app. The mobile app can enable the installer to wirelessly connect directly to BRA 3700 and the 3D accelerometer values and the 3D Hall-effect sensor readings can be ‘locked-in’ as being ‘normal.’ Any significant changes to the readings during the operational life would cause BRA 3700 to send a modified Bluetooth beacon message. For example, movement of BRA 3700 would not trigger the alert beacon message but rotation greater than 180 degrees would trigger the alert beacon message. Thus, Hall-effect sensor values would be forgiving to movement but not so much that a thief could cut the transom bolt with a saw and remove the end of the bolt without triggering the Hall-effect sensor.

BRA 3700 may double as a proximity alarm. If a boat is unloaded from the trailer (e.g., launched from the trailer on a boat ramp), the Bluetooth beacon from device 3700, coupled to the boat via a transom bolt 3710, separates from the trailer taillight, which may comprise TLTCU 1200, and may trigger notification.

In an example embodiment, since the Bluetooth messages sent by sensor 3700 may be designated as critical alarm messages, the messages may be constantly changed and may be encoded with at least one hash function result, and preferably two different hash authentication results, to prevent message spoofing by the thief. As shown in FIGS. 13A and 13B, the two different hash results may enable a local taillight TCU 1200 to authenticate a message received from Bluetooth module 2125 using an internal hash computation while the second hash result may be sent to a cloud server to be validated against unique private keys known only by the local BRA 3700 and a cloud server (e.g., TOC 147) or cloud hardware security module (“HSM”). Sensor 3700 may use the hash value(s) to create example embodiment secure Bluetooth beacon technology, as described in greater detail in reference to FIGS. 13A and 13B, which may be referred to herein as secure Bluetooth beacon, or simply secure beacon.

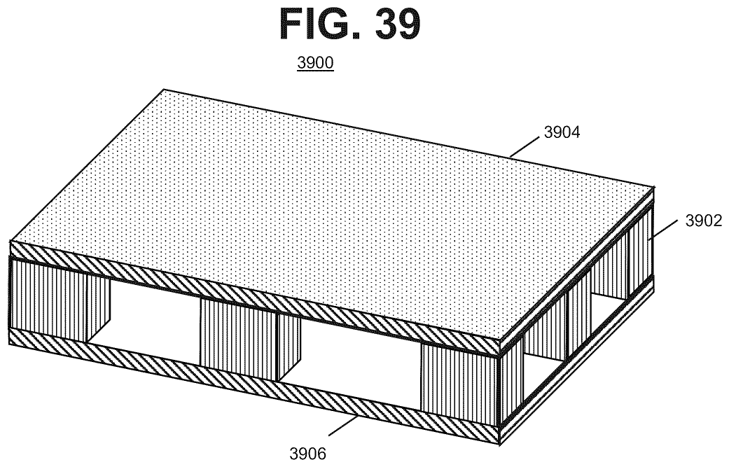

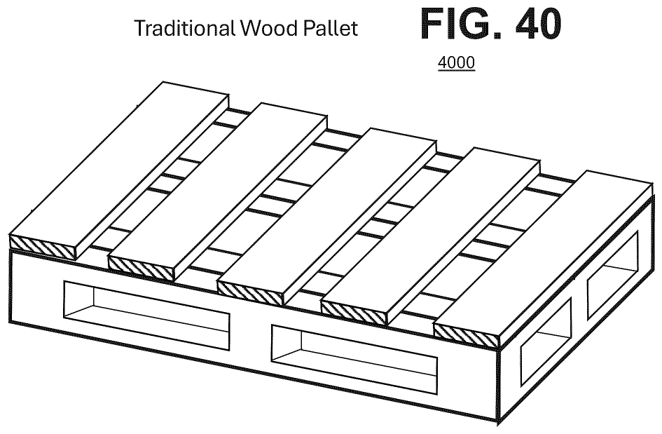

Cargo carried by trailers may vary depending on the trailer type. Large semi-trailers may contain boxes of cargo goods loaded on the trailer or semi-trailers may contain pallets with boxes loaded on the pallets. Most of the cargo carried by a large semi-trailer are loaded with a forklift and if the cargo does not have points for forklift lifting, then pallets are used to facilitate the movement of the cargo from the point of origin to the destination point. FIGS. 39 and 40 show two of many pallet types that are used for cargo to be transported by large semi-trucks. FIG. 39 shows composite pallet 3900. Pallet 3900 may have pylons 3902 that separate upper deckboard 3904 from lower deckboard 3906. Upper deckboard 3904 may carry the weight of cargo while lower deckboard 3906 may contact a trailer floor and maintain alightment and pylons 3902 from getting detached thru rough handling.

FIG. 40 shows traditional wood slat pallet 4000. Typically, wood pallet 4000 has stringers or blocks to separate the upper deckboard from the lower base. The lower base keeps the blocks or stringers from being knocked off due to rough handling and maintains spacing for fork widths.

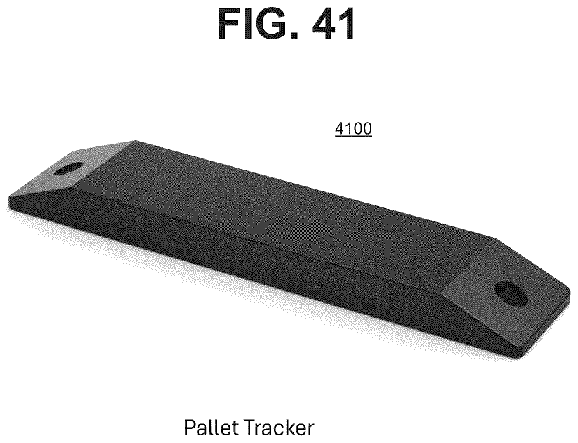

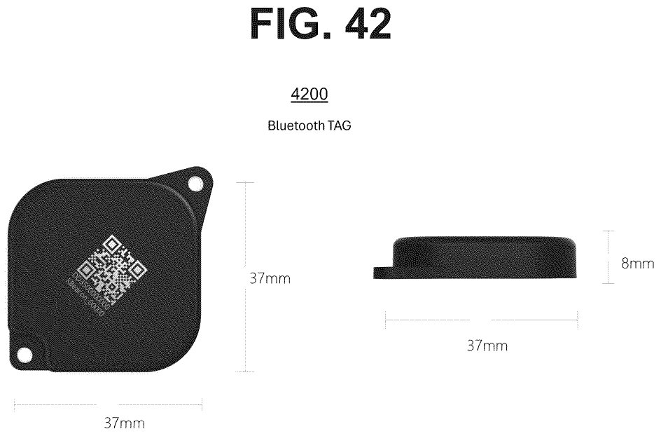

Both pallet types 3900 and 4000 are easily equipped with Bluetooth monitoring beacons. A hole 1-1½ inches and ¾ of an inch deep can easily contain a Bluetooth enabled cargo monitor and beacon. FIGS. 41 and 42 show two types of devices, pallet tracking device 4100 and Bluetooth tag 4200, that might be installed in a pallet and used for monitoring several aspects of the pallet. A Bluetooth-enabled pallet (e.g., a pallet with a tracker 4100 or tag 4200 attached to the pallet, installed in a pocket formed into the pallet can provide location, or otherwise physically connected to the pallet) can transmit information, such as, for example, pickup and drop-off information, temperature and humidity, vibration alerts, shock alerts, and the like. Information related to a pallet and acquired or determined by a tracker 4100 or tag 4200 may be transmitted via various messages broadcast via a Bluetooth beacon and can provide informational and critical alerts to operators of the freight system. A TLTCU 1200 installed in a trailer that is carrying the pallets can provide information received from a Bluetooth enabled pallet (e.g., a pallet with a tracker 4100 or tag 4200) via long-range wireless communication network to a computing server than may be configured to receive the information and provide the information to an operator of the trailer, or to an operator of a towing vehicle that is towing, has towed, or will be towing the trailer comprising the pallet. Information that may be generated to be broadcast via a Bluetooth beacon to a TLTCU 1200 and that may be received by the TLTCU and broadcast to a computing server or to another wireless enabled device (e.g., a device that is enabled for communication via long range wireless communication, short range wireless communication, satellite communication, and the like) may comprise notification information indicative of when or where a pallet is picked up; when or where a pallet is dropped off; temperature, humidity, vibration and shock threshold criterion/criteria may be configurable in either the pallet-based sensor (e.g., tracker 4100 or tag 4200), or in a tail light TCU 1200 Bluetooth gateway module 1220 with respect to a unique identifier corresponding to the Bluetooth sensor associated with the pallet.

In an example embodiment, since the Bluetooth messages sent by tracker 4100 or tag 4200 may be designated as critical alarm messages, the messages may be constantly changed and may be encoded with at least one hash function result, and preferably two different hash authentication results, to prevent message spoofing by a thief, an outsider, a malicious person, or a device configured for malicious intent. As shown in FIGS. 13A and 13B, the two different hash results may enable a local taillight TCU 1200 to authenticate a message received from a Bluetooth module using an internal hash computation while the second hash result may be sent to a cloud server to be validated against unique private keys known only by the local pallet tracker 4100, or tag 4200, and a cloud server (e.g., TOC 147) or cloud hardware security module (“HSM”). Tracker 4100 or tag 4200 may use the hash value(s) to create example embodiment secure Bluetooth beacon technology, as described in greater detail in reference to FIGS. 13A and 13B, which may be referred to herein as secure Bluetooth beacon, or simply secure beacon.

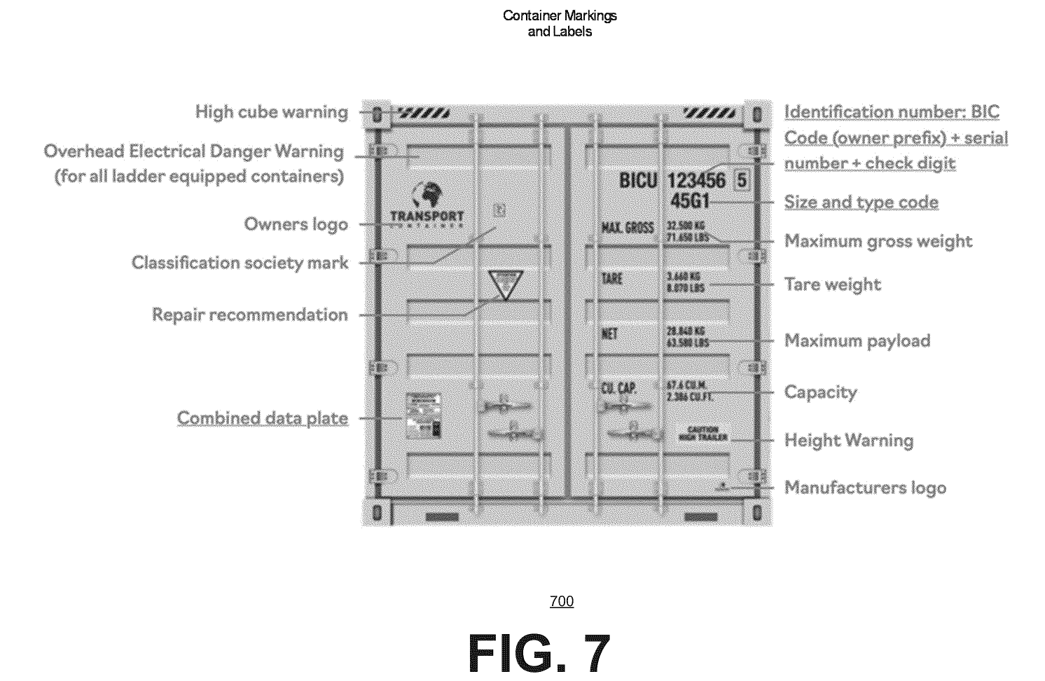

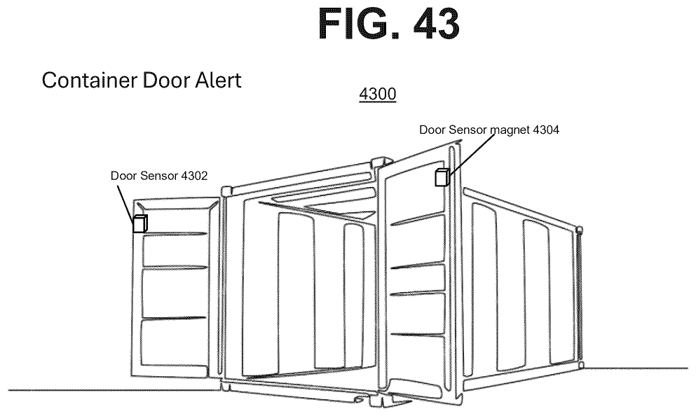

FIGS. 43 and 44 show typical intermodal freight containers 4300 and 4400, respectively. A freight container may be combined with a container chassis 500 shown in FIG. 5 to create a trailer solution to carry intermodal freight. Sensors that may be used by intermodal freight container 4300 or 4400 and chassis 500 may be similar to sensors used by a semi-trailer. One feature that may be advantageous is to equip each of a fleet of intermodal freight containers with a Bluetooth beacon that broadcasts a container identification (e.g., a Bluetooth Container ID (“BCID”)) message. FIG. 7 shows the universal marking standards established by the freight delivery industry to be applicable to marking of intermodal containers. Identification number, size, and type code data that may be marked on a container that facilitate a shipper or freight carrier keeping track of a container and contents being shipped therein. An identifier may comprise a BIC code or owner prefix, a serial number, and a check digit. Size and type code data may be indicative of physical characteristics of the container.

The international register of identification codes for container owners was originated by the Bureau International des Containers (“BIC”) and has been published continually since 1970. It was subsequently adopted by the International Organization for Standardization (“ISO”) in 1972, forming an essential part of the ISO 6346 standard: “Freight Containers—Coding, Identification and Marking”. This standard also describes technical markings such as size and type code, country code and various operational marks.

According to current standards, an owner/operator code is always 3 letters. A fourth letter is used as an equipment identifier. The serial number is a six-digit number plus one check digit to verify accuracy. This identification is worldwide unique per container. It allows identification of the owner or principal operator. Encoding the BIC-Code identification into a Bluetooth beacon message may facilitate determining a location of an intermodal container and may facilitate further utility with respect to a container and chassis combination by facilitating a certain chassis/TLTCU 1200 combination reporting at least one maintenance alert to an operator associated with the chassis or associated with the trailer that may comprise the TLTCU. Instead of a maintenance technician having to search every chassis identification in a parking lot comprising many container/chassis combinations to locate a physical chassis that needs maintenance, a Bluetooth beacon may facilitate rapid location of the container via a device, such as, for example, a smart phone that may be configured to receive the beacon or that may be configured to receive a message that corresponds to the beacon.

A BCID broadcast beacon can double up features and include a door open notification to provide owner/operators of an open-door alert. As shown in FIG. 43, a beacon device 4302 configured to broadcast a beacon comprising a BCID may be installed in the inside of the door for the container, for example, in a recessed space between door frame members, such that it will not be located where it is likely to be damaged through normal operations. Magnet 4304 may be installed on an opposing door such that when the doors are closed magnet 4304 may create a magnetic field that may be distorted by one or both of the doors and in cooperation with a hall effect sensor or transducer corresponding to device 4302 may be usable to generate an indication that the doors have been opened, or are loose, which indication may be transmitted by device 4302 via a Bluetooth beacon to a TLTCU 1200 that may be part of a trailer that is carrying container 4300.

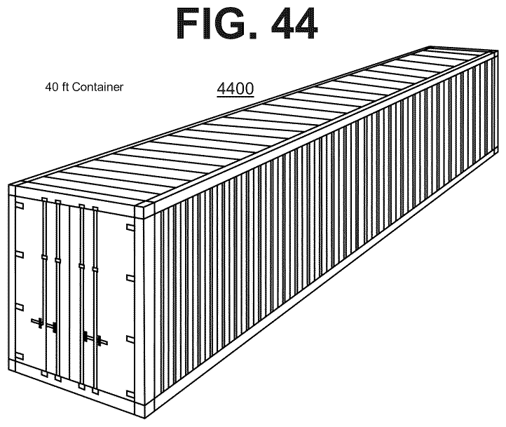

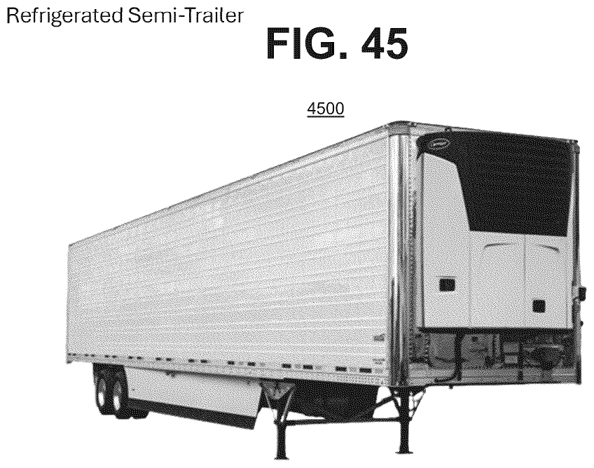

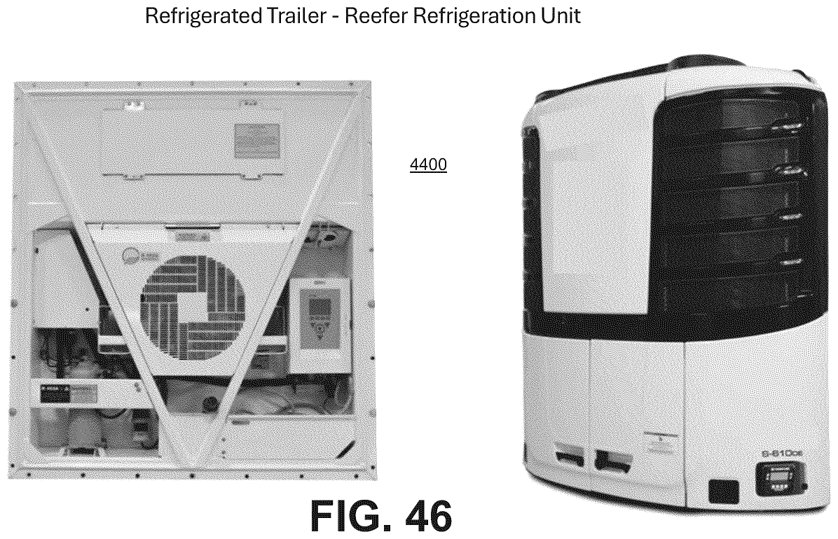

FIG. 45 shows semi-trailer 4500 equipped with a refrigeration cooling unit(s). FIG. 46 shows a typical refrigeration cooling unit 4600. Cooling units 4600 are typically standalone machines that contain diesel powered engines and cooling systems to chill the interior of a typical 53-foot insulated semi-trailer, to facilitate transporting cargo that must remain frozen or refrigerated. Many refrigeration trailers have different temperature zones to support both refrigeration and freezing. The cooling unit draws fuel from a tank under the deck of the trailer, typically holding several days or a week worth of fuel.

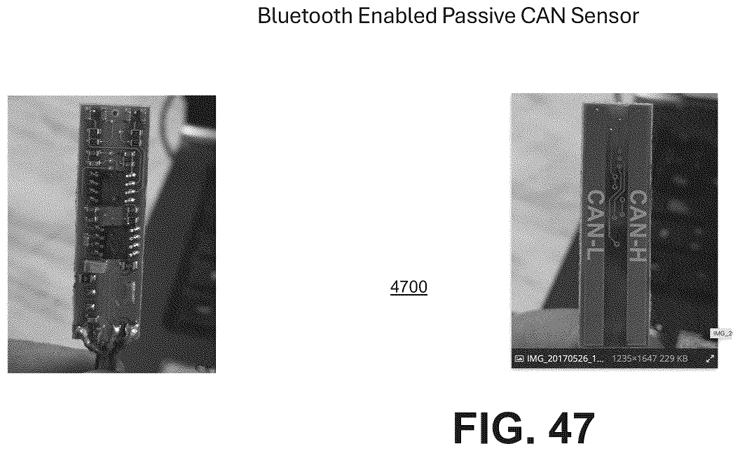

Many refrigerated trucks/trailer have telematics system that facilitate operators monitoring and controlling the refrigeration system and the internal trailer temperature. Refrigerated trailers that are equipped with telematics systems may be able to report location and facilitate remote starting of the refrigeration unit. However, not all reefers, as trailers comprising refrigeration units may be referred to, have telematics systems, but it is nevertheless desirable to at least monitor the temperature inside the trailer. This can be done by use of a Bluetooth enabled sensor, such as, for example, sensor 3100 shown in FIG. 31. Optionally, a controller area network (“CAN”) bus monitor can be created to passively monitor a CAN bus that most refrigeration units use for internal communication and maintenance messaging. FIG. 47 shows a device 4700 and circuit designed to passively ‘sniff’ a CAN bus of refrigeration trailer/refrigeration unit combination to read messages that indicate fuel available, operating conditions, warnings and alerts, and cargo area temperatures. This information can be coded into a Bluetooth message and transmitted in the beacon for receiving by a TLTCU 1200 that may be part of the trailer comprising a refrigeration unit, and for sending by the TLTCU to a cloud server.

FIG. 16 shows a typical open light-utility trailer 1600 and FIG. 18 shows a typical closed light-utility trailer 1800 used by many tradespersons, hunters, farmers, sportsman and homeowners. Trailers 1600 or 1800 may be used by construction workers to transport and store tools and equipment. Trailers 1600 or 1800 may be used by hunters to transport four-wheelers and ATVs. Trailers 1600 or 1800 may be used by farmers to transport equipment to remote fields and to transport feed and other supplies from suppliers. Trailers 1600 or 1800 may be used by homeowners to transport garden equipment and supplies from stores, move fertilizer, plants, landscaping materials and just about anything else that one can imagine. Equipping a trailer 1600 or a trailer 1800 with a TLTCU 1200 may facilitate locating the trailer in case of theft, or tradespeople and others can equip assets carried by the trailers for theft notification and accidentally loosing tools equipped. Both Milwaukee Tool Company and DeWALT Tool Company equip many of their power tools with internal Bluetooth tags. These Bluetooth tags have various purposes, including assisting tool owners in locating and managing their collection of tools. For example, large commercial sites that have hundreds of tools need to ensure that the tools remain on site and are not left in locations where they are subject to weather damage and theft. Tools that are not equipped with Bluetooth tags can easily be equipped with tags, for example a tag 4200 shown in FIG. 42, that are very low cost and facilitate tracking of whatever the tag is attached to or part of.

A trailer equipped with TLTCU 1200 as at least one taillight can enable mobile workers like plumbers, carpenters, landscapers and electricians to receive notifications when the trailer leaves the jobsite and doesn't contain the known tools that it should contain. If a carpenter leaves a drill or saw at a jobsite, as soon as a trailer, for example an enclosed trailer 1800, is moved enough for an onboard accelerometer (e.g., accelerometer 1230 shown in FIG. 12, corresponding to TLTCU 1200 that may be at least one taillight of the trailer) to trigger awakening TLTCU processor 1205 and determining, by the processor, that a Bluetooth beacon emitted by a Bluetooth tag corresponding to the drill or saw is not being received via module 1220 (e.g., because the drill or saw is beyond a Bluetooth low energy beacon range with respect to the TLTCU), the TLTCU can notify a cloud server, which may in turn direct a notification to the carpenter that the drill or saw is not loaded on trailer 1800. In an example embodiment, TLTCU 1200 can direct a message, such as, for example, a short message service message (“SMS”) directly to the carpenter.

### Taillight Telematics Control Unit Comprising Bluetooth Gateway Technology.

According to one or more example embodiments disclosed herein, a taillight GPS tracker, which may be referred to as a taillight telematics control unit, or a TLTCU, may comprise circuitry shown in FIG. 12 that is embodied in a taillight that may be used on a trailer or other transportation equipment and may be equipped with a Bluetooth gateway (e.g., module 1220 shown in FIG. 12). Combining a taillight, a GPS tracking device, and a Bluetooth gateway are novel techniques usable according to various embodiments disclosed and described herein. Example embodiment disclosed herein may facilitate various advantages, for example, theft detection and alerting. By itself a TLTCU without theft detection is very useful but functionality facilitated by a TLTCU becomes more advantageous with the capability to provide notification that the TLTCU itself is tampered with or removed from a vehicle or trailer that uses the TLTCU as a taillight. Moreover, providing notification that a trailer that the TLTCU is part of is being stolen, or at least being moved, while not connected to a towing vehicle is advantageous and desirable.

As described herein, there are several detection methods for detecting tampering with a TLTCU itself. An accelerometer 1230 as shown in FIG. 12 may provide indication of, or trigger indicating, unusual movement of the TLTCU, which movement may correspond removal of the TLTCU itself from a trailer or which movement may correspond to movement of a trailer that the TLTCU is part of. Pressure sensor 1245 can facilitate providing of alerts if a housing/lens of a TLTCU is breached. Hall-effect sensor 1242, in combination with a magnet that may be part of the TLTCU, or that may be independent of the TLTCU and affixed to the mounting frame of an aluminum mounting frame, can facilitate providing of removal notification indicative that the TLTCU may be removed from a trailer. Removal detection, which may be facilitated by one or more sensors shown by FIG. 12, may transmit at least one proximity alert or at least one non-proximity alert notifying a cloud server that TLTCU may have been removed from a trailer or other vehicle. of a device removal. Hall-effect sensor 1242, or an inductive sensor, for example Texas Instruments TI LDC0851, which may be used in an example embodiment instead of a hall-effect sensor, are both accurate sensors and also difficult to defeat. Locating a large magnet, or magnetic-field-generating-device, next to or proximate hall-effect sensor 1242 could potentially cancel, minimize, or overpower the detecting of a smaller magnetic field produced/generated by a magnet that may be fixed inside of TLTCU 1200 internal magnet field that sensor 1242 is configured and calibrated to recognize and trigger an alert if the calibrated and recognized field is disturbed, but the larger field would likely result in a different field strength being detected by sensor 1242 than the sensor is calibrated to ‘expect’ and thus would cause sensor 1242 to trigger alerting because a magnetic field strength that sensor 1242 detects will be different than the field that it is calibrated to ‘expect. Thus, an attempt by a malicious actor to use a large magnetic field to overpower the detecting of a magnetic field produced by a magnet fixed inside of TLTCU will trigger an alert instead of suppressing the indicating of an alert that the TLTCU is being tampered with or removed from a trailer.

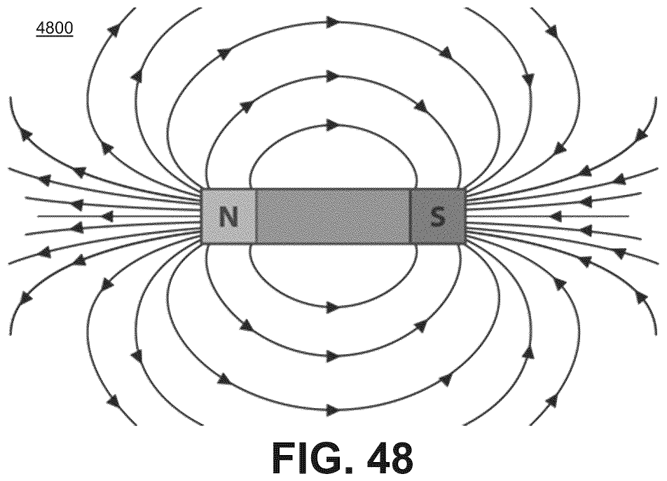

FIG. 48 shows a bar magnet 4800 and magnetic field B (e.g., a scaler magnetic field) or B field (e.g., boldface to indicate a vector magnetic field). For purposes of simplification, ‘B’ (e.g., non-boldface) may be used herein to refer to either a scaler or magnetic field unless one or the other scaler or vector magnetic field is specifically noted. Local magnetic fields produced by magnet 4800 may be measured with an instrument such as a magnetometer. There are several classes of magnetometers, including induction magnetometers, which measure only varying magnetic fields, rotating coil magnetometers, Hall-effect magnetometers, NMR magnetometers, SQUID magnetometers and fluxgate magnetometers. Some instruments and sensors are more sensitive than others.

Magnetometers formed onto silicon chips are typically sensitive down to around +/−0.1 microTesla, which is sensitive enough to detect the Earth's magnetic field and to operate as a compass. Hall-effect sensors, for example sensor 1242, are much less sensitive, for example, having sensitivity in the range of a few milliTeslas. Exposing a chip magnetometer to a strong magnetic field runs a risk of destroying the magnetometer's ability to read magnetic fields properly. Various example embodiments disclosed herein may comprise using a very small bar magnet, and placing a bar magnet nearby to a chip magnetometer would subject the magnetometer to a magnetic field that would be very strong and would risk destroying a sensitive magnetometer. However, example embodiments disclosed herein do not rely on detecting magnetic field strength(s) with a sensitivity facilitated by a magnetometer. Accordingly, a sensitivity level facilitated by a linear Hall-effect chip is desirable.

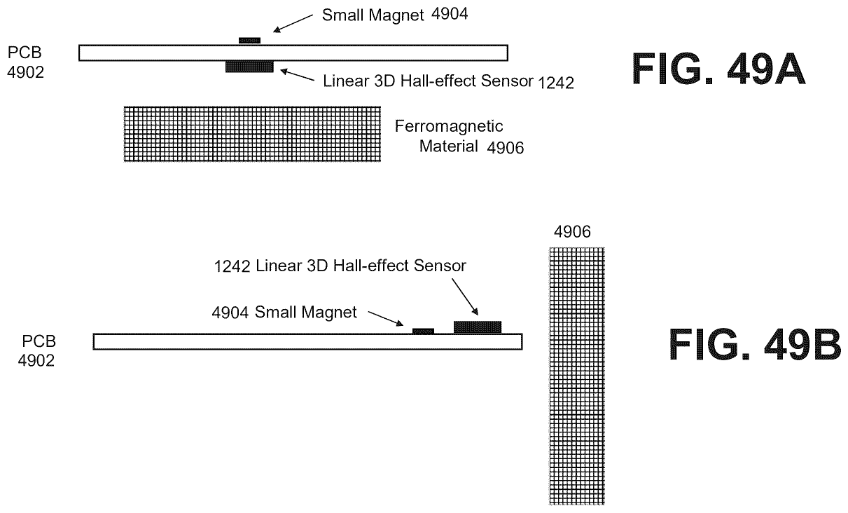

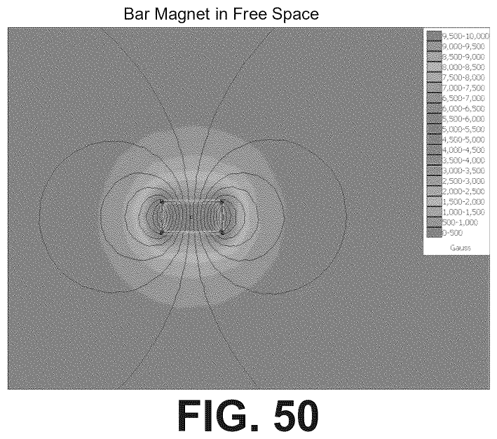

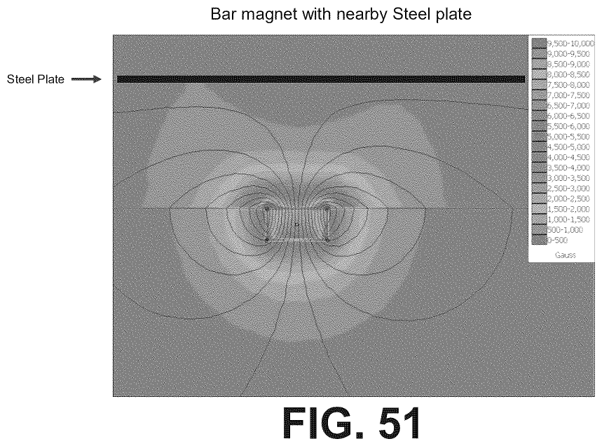

FIGS. 49A and 49B illustrate arrangement of hall-effect chip sensor 1242 on a printed circuit board 4902 with respect to small magnet 4904. Printed circuit board 4902 may be a circuit board used to mount and connect components of TLTCU 1200 shown in FIG. 12. According to at least one example embodiment disclosed herein, magnet 4904 may be located beside, behind, under, or proximate hall-effect chip sensor 1242 to provide a fixed field B that is measured by the hall-effect chip sensor. As used according to example embodiments disclosed elsewhere herein, a field B, or a magnitude corresponding thereto, produced by magnet 4904 may be measured after installation of a TLTCU 1200 comprising sensor 1242 and magnet 4904 such that a strength of field B measured by the TLTCU is used to calibrate the TCU ‘as-installed.’ As described elsewhere herein, after a TLTCU is installed as a taillight of a trailer, for example, sensor 1242 and magnet 4904 may be located such that a ferrous material 4906, such as a trailer frame member, a trailer door, and the like may disturb field B, but a measured field strength of the disturbed field B may be used as a ‘baseline’ or ‘calibrated’ signal strength. Thus, if the TLTCU is moved relative to the ferrous material (e.g., the TLTCU is removed from a trailer such that a frame member no longer disturbs field B) sensor 1242 may determine a field strength corresponding to field B that differs from the calibrated/baseline field strength of B. Based on a determined deviation of a measure strength of field B from a calibrated/baseline field strength of field B, sensor 1242 may trigger transmitting, but module 1205, an alert that the TLTCU may have been removed from a trailer. FIG. 50 shows a field B created by a small magnet in free space. FIG. 51 shows field B modified, or ‘disturbed’, by a ferromagnetic material, for example a steel component or member that a trailer is constructed of.

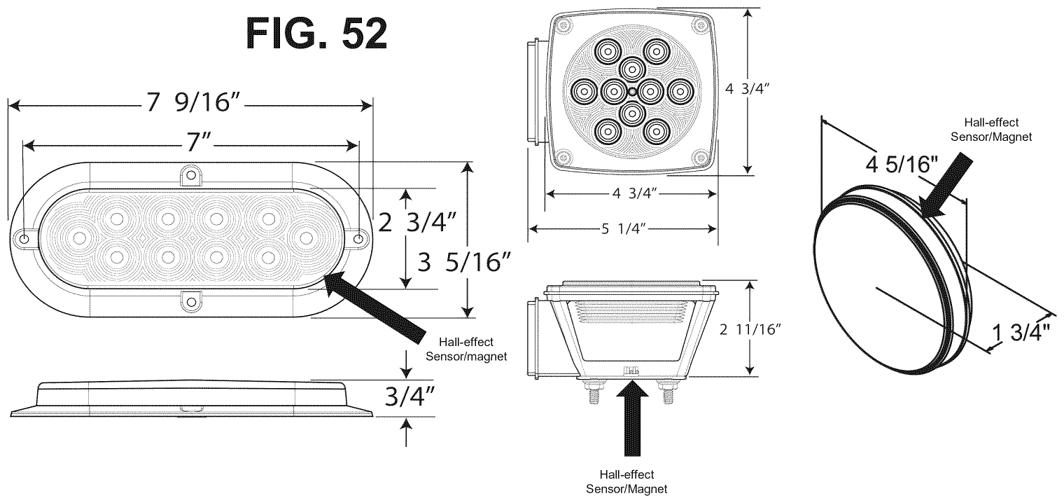

Removal detection for taillights equipped with TLTCU 1200 is desirable to facilitate successful operation of various features of the TLTCU. FIG. 52 shows approximate locations of hall-effect sensor 1242 and magnet 4904 combination. Depending upon the mounting configuration, the hall-effect sensor and magnet combination may be located near the mounting points. The light utility trailer fixture 1700 shown in FIG. 17 may be configured to comprise a hall-effect sensor 1242 and magnet 4904 combination mounted on printed circuit board 4902 (“PCB”) assembly such that the hall-effect sensor will be on the back side of the PCB while the small magnet may be mounted on the top side of the PCB as shown by FIG. 49A. An arrangement as shown in FIG. 49A may facilitate hall-effect sensor 1242 being close to Ferromagnetic material 4906, which may comprise, for example, a steel or iron member that fixture 1700 is mounted to.

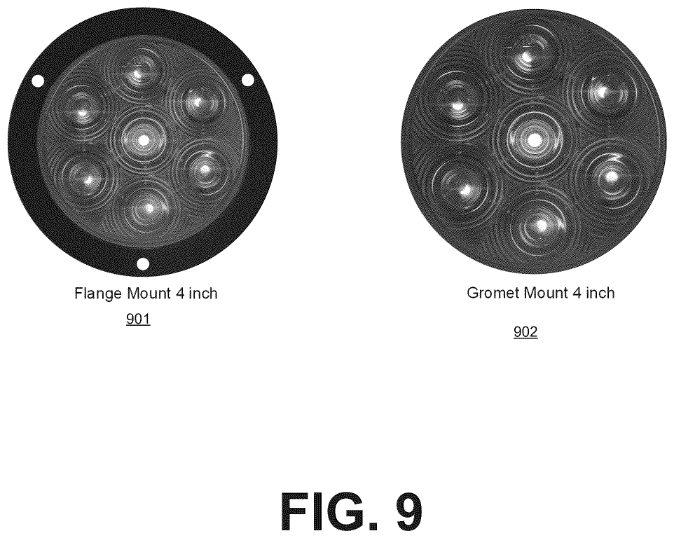

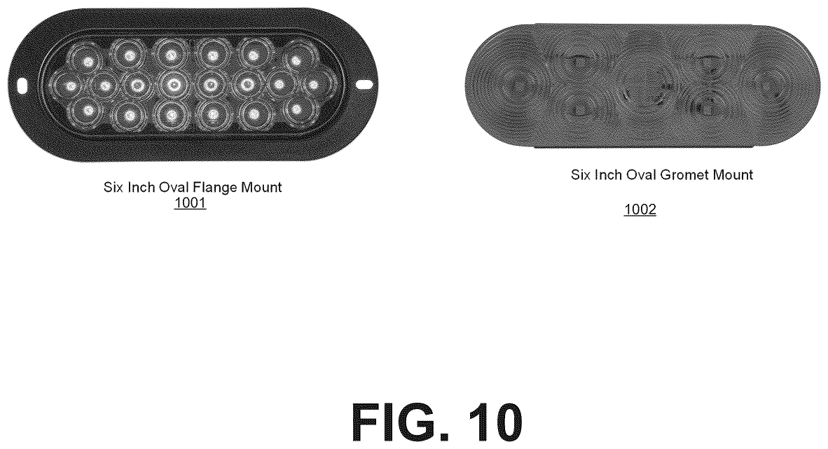

Heavy duty trailers or box trailers using the lights FIG. 9 or FIG. 10 may have hall-effect sensor 1242 mounted near the edge of PCB assembly 4902 as shown by FIG. 49B. Magnet 4904 may be mounted further inside PCB 4902 essentially behind hall-effect sensor 1242 as shown in FIG. 49B. Sensor 1242 may be a 3-axis sensor, particular arrangement of magnet 4904 and the sensor is not important as long as the hall-effect sensor is mounted closest to the Ferromagnetic material that the tail light fixture/assembly is mounted to (e.g., preferably with the taillight installed, the sensor is closer to ferromagnetic material 4906 than a distance from magnet 4904 to the ferromagnetic material).

Additional removal detection may comprise tampering notification being indicated by, or triggered by, movement that causes accelerometer 1230 to output a signal. Typically, orientation of a taillight on a trailer is selected to comply government trailer lighting requirements (e.g., regulations promulgated by the United States Department of Transportation). A typical installation of taillights and corresponding orientation thereof may result in a plane of a PCB generally facing the back of a trailer so that the light projects behind the trailer for a tail light. According to example embodiments disclosed herein, TLTCU electronic hardware could be installed in a light fixture used in another location of a trailer, such as, for example, a marker light on the front or side of a vehicle/trailer. In an example embodiment, TLTCU circuitry could be installed in, or as part of, an ABS indicator on the left side of a trailer (e.g., North American trailers). Regardless of installed orientation, a light will typically be installed in a specific, fixed orientation. If the orientation changes significantly, either the trailer has been involved in an accident or the light is being removed and possibly stolen, in which cases example embodiments disclosed herein may report a possible theft indication to a cloud server for alerting an owner/operator of the trailer of the possible accident or theft activity. The technical solution described herein using a hall-effect chip and at least one magnet may be used by many possible peripheral sensors of the TLTCU system to indicate removal of critical parts that would otherwise be necessary for theft alarm reporting.

Bluetooth features and functionality.

Regarding the Bluetooth gateway functionality and solution disclosed herein, the Bluetooth gateway (e.g., module 1220 shown in FIG. 12) may filter and report the presence or absence of various received Bluetooth beacon signals. Bluetooth radio module 1220 may use Bluetooth Low Energy protocol (“BLE”) for transmitting or receiving messages. Module 1220 may be capable of transmitting short messages up to around 250 octets of information. The Bluetooth module 1220 may be capable of receiving raw data from one of the three normal (e.g., standard Bluetooth) advertising channels. There are several advantages to using BLE technology to facilitate communication from various sensors and other devices that may be deployed on a trailer or other vehicle. An advantage of using BLE may include low power consumption, thus making BLE desirable for battery-powered devices and sensors. Implementing BLE is relatively simple and uses minimal hardware. Another advantage of BLE is that no connection is required (e.g., no wireless connection wherein a connection is established via a multistep procedure before information is transmitted). Thus, remote devices (e.g., sensors, such as, for example, tire pressure sensors, that are remote from a TLTCU) can broadcast information without the need for a connection thus facilitating discovering of the devices in the vicinity by module 1220, wherein a discovered signal may comprise information or data that a remote device may be transmitting/broadcasting. Another advantage of BLE that makes use of BLE energy desirable for use with respect to various example embodiments disclosed herein is fast discovery. BLE advertisement channels can be used to quickly discover nearby devices without the need for complex scanning algorithms.

According to example embodiment disclosed herein, using Bluetooth may facilitate providing of features that may be facilitated by Bluetooth messaging, which features and functionality corresponding thereto may be as “over-the-top” features, which may relate to the tracking and sensor management functionality that may facilitate operation in the logistics and transportation industries.

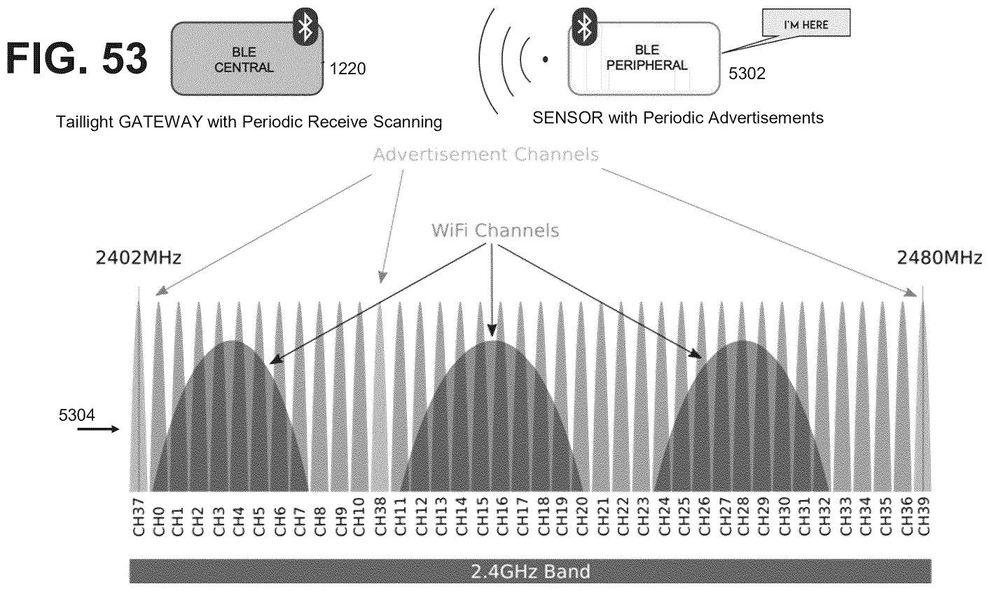

FIG. 53 illustrates a simple system architecture according to embodiments disclosed herein. Bluetooth module 1220, as shown in FIG. 12, may receive BLE message signals 1290 from at least one sensor 5302, such as, for example, a tire pressure sensor, a wheel bearing sensor, a door open sensor, an outboard motor bolt sensor, and other sensors as described herein with respect to example embodiments. Advertising by a sensor 5302 is preferably unidirectional from the sensor to module 1220. A remote sensor 5302 equipped with Bluetooth, as previously described in this disclosure may be a one-way message sender. A remote sensor 5302 may broadcast messages on a random basis at approximately two second intervals. The randomness of the interval allows for multiple sensors sending messages to shift their sending time so that if a first device 5302 transmits a message at the same time a second device 5302 transmits a message, the first sensor does not forever send messages the same time as another device, thus avoiding message collision which might result in all messages being blocked, not received, or partially received by module 1220. The interval of approximately two seconds is, on a system basis, a value that can be set to another time, whether it is 1 second, 2.5 seconds, 4 seconds, or 10 seconds. The message interval may be a time chosen to maximize battery life of a remote sensor device 5302 and the gateway module 1220. Choosing a longer time for a sensor 5302 results in gateway 1220 ‘listening’ for a longer time, periodically, to ensure that the gateway does not miss a message. Choosing a shorter time interval between messages may result in remote sensors 5302 consuming more energy to transmit more messages while gateway 1220 may consume less energy because the gateway may not ‘listen’ as long to capture messages.

Selection of advertising/broadcasting intervals used by one or more remote sensor devices 5302 may depend on a source of energy for gateway 1220. If TLTCU 1220, and thus gateway 1220, receives external power regularly and does not have to depend upon the battery 1276 very often, (e.g., a trailer comprising TLTCU 1200 is being towed and a driver of a towing vehicle is regularly applying turn signals or brakes, or tail lights/running lights are on, thus resulting in a regular source of 12V power at terminals 1262 or 1264), then a periodic interval used by sensors 5202 can be longer. If the size of battery 1276 is small, or if a charge level of the battery is low, then a tradeoff may be made and more frequent transmitting of messages by one or more sensors 5302 may be selected. Another factor that may be considered in determining a message broadcast rate is that with a higher message transmit rate, fewer nearby sensor devices 5302 may be able to successfully transmit message due to higher likelihood of messages transmitted by one device colliding with at least one message transmitted by another remote sensor device. Channel assignment 5304 shows channel assignments/frequencies used by BLE for avoiding Wi-Fi access points and client devices that also share the same frequency band. BLE beacon messages broadcast by a remote sensor device 5302 and received by TLTCU 1200 have latency and in some cases the latency may matter, for example, for a critical alarm, but in other cases the latency does not matter, for example on cargo monitoring tags that do not change during a trip.

FIG. 13A illustrates a typical message format 1300 of BLE messages usable to facilitate example embodiments. It will be appreciated that BLE messages are virtually all different. Even though there is a standard applicable to a few octets of BLE messages, the remainder of a BLE message may be very different for nearly every different sensor device. The Bluetooth Specification defines a top-level packet in BLE with two data units. A BLE packet 1301 typically has several parts including a preamble 1302 and access address 1303 as well as a three-byte CRC value 1306. An advertising channel packet data unit (“PDU”) may comprise a 2-octet header 1304 and a variable payload in a data field 1305. The payload length may be defined by a 6-bit field in header 1304 of the Advertising Channel PDU. An Advertising Channel PDU may have an Advertisement Address of 6 octets in data field 1305 and a variable number of advertisement data structures in field 1305. After the address is considered, typical short messages have 31 octets available for actual advertisement data structures. The Bluetooth 5 specification allows extended messages in data field 1305, which can have 255 octets available for advertisement data structures (data that may be transmitted via field 1305 may be reduced by address information). Since the number of data structures is variable, data structures can be combined as desired to facilitate example embodiments. The Bluetooth SIG also has the 0xFF data type which allows the flexibility of defining a custom payload.

Notwithstanding Bluetooth standards, with respect to which various example embodiments as are described herein, other communication protocols may be used instead of Bluetooth to facilitate communication between a remote sensor and TLTCU 1200. With Bluetooth, or with any communications standard protocol selected to implement example embodiments disclosed herein, the physical layer, which may include the actual RF radio, typically oversees sending of wireless signals over the air. The Link Layer defines the air interface packet formats, bit stream processing procedures such as error checking, a state machine and protocols for over-the-air communication and link control. Virtually any of myriad communications standards can send and receive messages. Example embodiments disclosed herein may be explained with respect to message types that are subject to modification by various implementations. Sensors and peripherals 5302, shown in FIG. 53, that communicate with module 1220 corresponding to TLTCU 1200 (e.g., sensors or peripherals 5302 that are remote on a towed vehicle with respect to a TLTCU 1200) may each be associated with an address to be transmitted by the sensor or peripheral via a short range wireless message. In the example embodiment case of a BLE message, the address may be six octets. Other radio interfaces may use more or less octets for addresses.

The present disclosure describes a number of novel sensors and alerting system embodiments. According to a Bluetooth SIG document, referred to as ‘Assigned Numbers’, two octets, or bytes, may be assigned to be usable to convey information indicative of different conditions, characteristics, and services such as, for example, temperature, humidity, pressure, battery level, average voltage, device name, alert level and alert status (over 100 characteristics). The Assigned Numbers document defines units of length in terms of feet and pressure in terms of pound-force per square inch, along with many other predefined values. Accordingly, since Bluetooth, or other message protocols usable to implement example embodiments disclosed herein, allow user-defined messages, message content, instead of specific messages, may be referred to herein when describing example embodiments.

An aspect that may be important with respect to example embodiments described herein may be message priority. A message, or messages, transmitted by a remote sensor 5302 or other BLE clients (e.g., sensors remote with respect to a TLTCU) may be prioritized to assist TLTCU 1200 in handling the messages. Some messages may require TLTCU 1200 to process the messages as presented (may be referred to as ‘raw’ processing) whereas other messages may be preprocessed so that TLTCU 1200 may capture a preprocessed message and/or forward a preprocessed message to a cloud server for additional processing. In an example embodiment, messages can be transmitted to a cloud server as a single raw packet to be processed by the cloud server.

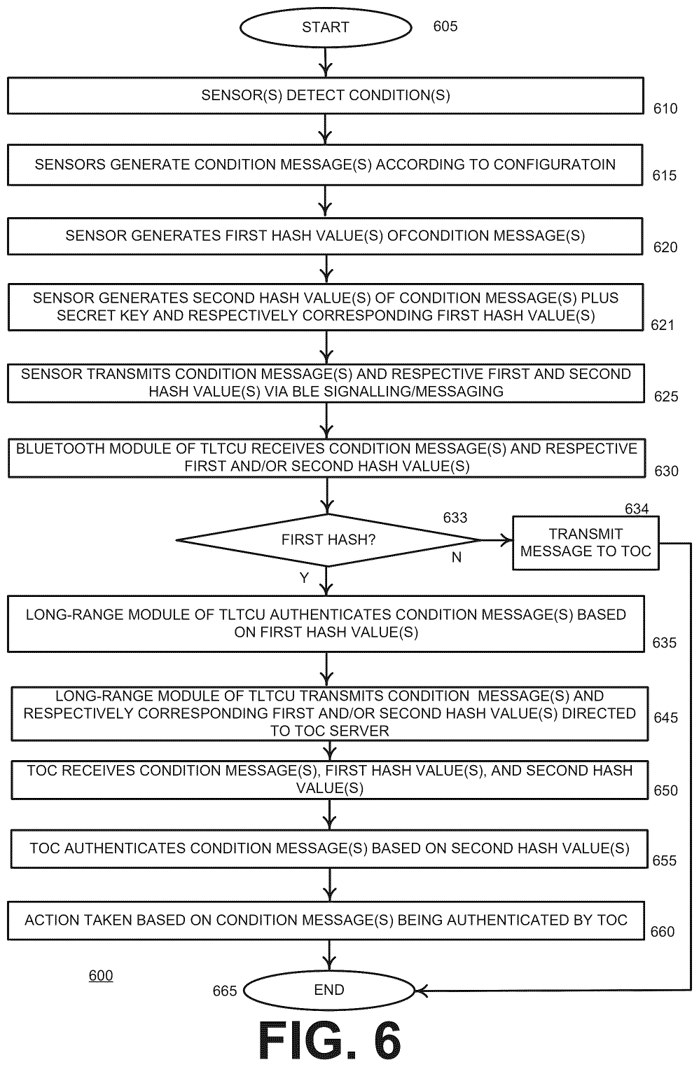

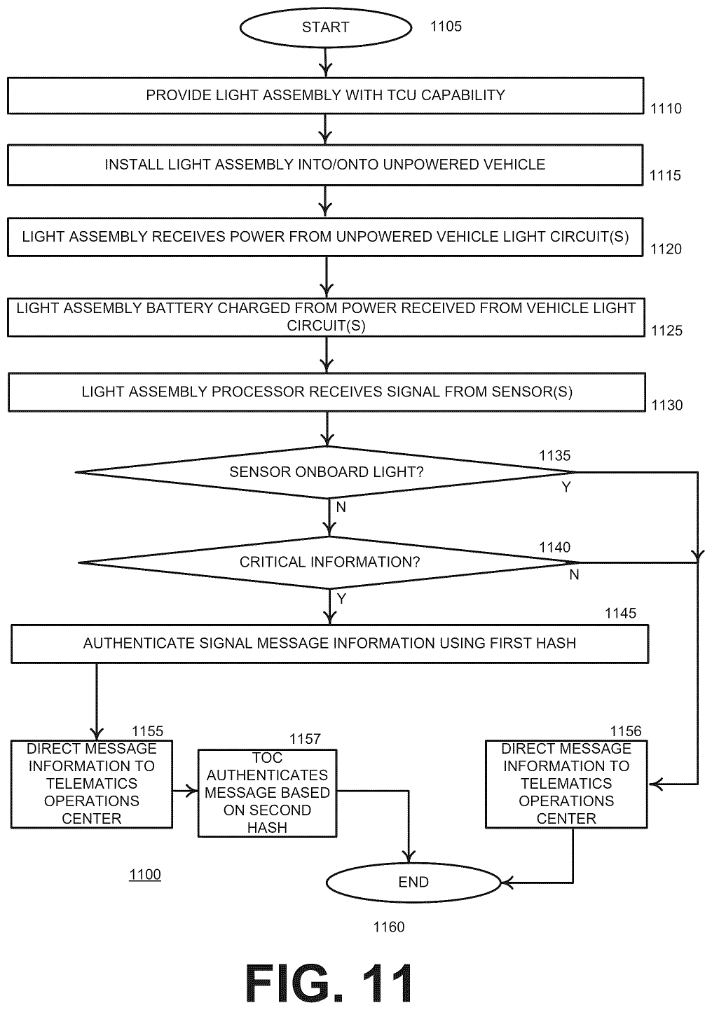

Another aspect that may be implemented by at least one example embodiment disclosed herein relates to message validity and authentication. Service-critical messages and alarms may be transmitted or processed according to two different authentication methods. A first hash value (e.g., value 1325 shown in FIG. 13B) that can be validated by TLTCU 1200 using device-specific information (e.g., information specific to a remote sensor device), including an Advertisement Address, may be applied to a message to be broadcast by a remote device 5302. This first hash value 1325 can use unique information that is inserted into a TLTCU 1200 at time of pairing a remote device 5302. For example, when a hitch lock 3400, shown in FIGS. 34 and 35, is paired to a TLTCU 1200, a Quick Response (“QR”) code associated with the hitch lock may be scanned by a mobile application, which may transmit information represented by the QR code to a cloud server, which, in response to receiving the information represented by the QR code, may transmit to the TLTCU a key to be used to facilitating the pairing. In addition to an Advertisement Address, the QR code may also include a hash seed or key that may be used, in addition to the advertisement address along with secret information 1335 ‘known’ by hitch sensor module 3405 and TLTCU 1200 and a constantly changing value, to create a hash used by the TLTCU to validate that a message, received by the TLTCU, originated from the hitch lock module 3405. Because the QR code information transfer is relatively insecure, a second hash seed, or key, or other secret information 1335, may be installed in hitch module 3405 at time of manufacture that is only ‘known’ by a cloud server (e.g., TOC 147), or a cloud HSM, and the hitch module. Use of different salt and keys results in second hash 1330 being different from first hash 1325 and not being easily forged or spoofed. This double security embodiment (e.g., using first hash value 1325 and second hash value 1330), with respect to a message broadcast from the hitch lock 3400, provides a high confidence that TLTCU 1200 will not waste data resources sending useless, spoofed, or forged messages and that a spoofed or forged message that makes it through a TLTCU hash filter will not alert an owner/operator/driver of a message that is not genuine. The double security embodiment feature may be applicable to multiple example embodiments disclosed herein, not just with respect to hitch lock 3400. For example, secure messages according to the double security feature may be used with respect to sensor message sent from other remote sensors, such as, for example, kingpin lock 2005 shown in FIG. 20, landing gear tamper device detector 2105 shown in FIG. 21, and door open sensor 2900 shown in FIG. 29, which are examples of sensors that need a high level of security with respect to an important, sensitive, or critical nature of information that the sensors may broadcast via BLE to be received by TLTCU 1200. (Message information transmitted via the double security embodiment feature may be referred to herein as critical information, at least with respect to description of FIGS. 6 and 11.)

Information broadcast by sensors such as tire pressure, temperature, voltage and wheel ticks, brake or bearing temperature, typically have no significant useful value to a malicious actor and thus messages that broadcast such information may be secured with no security or with only one level of security according to example embodiments described herein (e.g., a Bluetooth sensor may only generate one hash value of message information to be transmitted along with the message information itself to a TLTCU). However, such information could be used to spoof, for example, a tire blowout with no security so at least one level of authentication may be desirable for transmitting of tire pressure information by sensors 2200 or 2300 shown in FIG. 2200 or FIG. 2300, respectively. Informational messaging that may comprise information such as the distance to the front of a 53-foot semi-trailer or trailer weight do not have much value to a malicious actor in spoofing so these types of information may not require significant security other than CRC, checksum, or like to validate message integrity.

FIG. 13A illustrates an example BLE packet 1301 that may be used to convey messages information, generated by sensors remote from a TLTCU, to the TLTCU. BLE packet 1301 can be used to carry up to 227 message octets and two security hash values to check and validate authenticity of a message represented by data octets 1305. FIG. 13B illustrates example embodiment format of a message 1321 usable to transmit messages by remote sensors to be received by a TLTCU. Message 1321 is illustrated in FIG. 13B as comprising first hash value 1325 and second hash value 1330, which are referred to elsewhere herein, to facilitate authenticating message data 1320, which may comprise, convey, or represent condition information, corresponding to a towed vehicle, measured or determined by a remote sensor that may be remote from a TLTCU. Message data 1320, first hash 1325 value, and second hash value 1330 may be conveyed via ATT data portion 1315, which may be part of data field 1305. Data field may comprise L2CAP Header field 1310.

In an example, ATT Data message information field 1315 may comprise sensor condition information 1320: 0x8c, 0x89, 0xbe, 0xd6, 0x1e, 0x20, 0xde, 0x12, 0x34, 0x56, 0x78, 0x02, 0x01, 0x06, 0x0b, 0xaa, 0xfe, 0x21, 0x00, 0x03, 0x0c, 0x30, 0x1a, 0x23, 0x2c, 0x19, 0x4d, 0x14, 0xd1; which may be referred to as Advertising Packet Payload. In the example, the payload may be broken down as: Access Address 0x8e89bed6 and Packet Header 0x1e20; Advertising Address de:12:34:45:78, which may be a typical MAC address. ‘de’ may represent a locally administered MAC address, which typically may be part of a manufacturer assigned address. 0x02, 0x01, 0x06 may compose an advertising header (Length=0x02, Type Flags=0x01, 0x06=No BR/EDR, Discoverable). Typical Manufacturer Data may comprise 0x0b (Length), 0x16 (advertisement type), 0xaa, 0xfe (UUID), 0x21 (frame type), 0x00, 0x03 (sensor mask, temperature and humidity), 0x0c, 0x30 (battery voltage), 0x1a, 0x23 (temperature-fixed point 8.8 format), 0x2c, 0x19 (humidity-fixed point 8.8 format). Message Count information may comprise 0x00, 0x00, 0x24, 0x16, 0x73, 0x49. A CRC value may comprise 0x4d, 0x14, 0xd1.

First hash value 1325 may be generated by a secret algorithm, contained in software code within a BLE tag/remote BLE sensor, and TLTCU 1200. First hash value 1325 may be computed using over-the-air data message (e.g., message information 1320) plus a fleet-wide shared random value (e.g., a value used by multiple devices corresponding to a trucking/shipping company) and optionally a unique device value that may be shared by a QR code. Example hash algorithms could be SHA-1, SHA-256, SHA-512, MD5. In an example embodiment, a Hash Seed=0xaa, 0xbb, 0xcc, 0xdd, 0xcc, 0xff, 0x11, 0x22; a QR Key=0x11, 0x22, 0x33, 0x44, 0x55, 0x66, 0x77, 0x88; and Secret Salt=0x01, 0x23, 0x45, 0x67, 0x89, 0xab, 0xcd, 0xef. First hash value 1325 may be calculated on Advertising Address de:12:34:45:78; Advertising header 0x02, 0x01, 0x06; Typical Manufacturer Data: 0x0b (Length); 0x16 (0advertisement type); 0xaa, 0xfe (UUID); 0x21 (frame type); 0x00, 0x03 (sensor mask, temperature and humidity); 0x0c, 0x30 (battery voltage); 0x1a, 0x23 (temperature—fixed point 8.8 format); 0x2c, 0x19 (humidity-fixed point 8.8 format); Plus QR Key=0x11, 0x22, 0x33, 0x44, 0x55, 0x66, 0x77, 0x88; Plus Hash Seed-0xaa, 0xbb, 0xcc, 0xdd, 0xee, 0xff, 0x11, 0x22; Plus Secret Salt=0x01, 0x23, 0x45, 0x67, 0x89, 0xab, 0xcd, 0xef; Plus a value of a message counter that increments with every new message: Message Count: 0x00, 0x00, 0x24, 0x16, 0x73, 0x49.

In an example, if SHA-256 is applied to the data just mentioned, the result might be: E870c0cda1f57380d1170fe953c166cc0dbc6c434b78b04486518127b92d6789. Since this SHA-256 result is large, sending a BLE message comprising data as long as a SHA-256 output may be undesirable. Thus, a truncated version of the hash value may be used as first hash value 1325 and transmitted by the BLE transmitter.
E870c0cda1f57380d1170fe953 [symbol] 518127b92d6789
Result value 1.

Any random subset and length of the original hash function may be chosen/selected and embedded into BLE message 1301 as first hash 1325. In the example result shown in Result value 1, twelve octets are selected as HASH 1 SUBSET=0xc1, 0x66, 0xcc, 0x0d, 0xbc, 0x6c, 0x43, 0x4b, 0x78, 0xb0, 0x44, 0x86. Accordingly, ATT Data Message field 1315 may expand by the selected twelve octets to comprise EXAMPLE ATT Data information 1320+HASH 1 SUBSET first hash value 1325.

After first hash value 1325, which may result from applying a hash algorithm to condition information 1320 plus other information as described above, another hash algorithm may be applied to the condition information 1320 plus first hash value 1325 to result in second hash value 1330 (e.g., another hash algorithm may be applied to 0x8c, 0x89, 0xbe, 0xd6, 0x1c, 0x20, 0xde, 0x12, 0x34, 0x56, 0x78, 0x02, 0x01, 0x06, 0x0b, 0xaa, 0xfe, 0x21, 0x00, 0x03, 0x0c, 0x30, 0x1a, 0x23, 0x2c, 0x19, 0x4d, 0x14, 0xd1, 0xc1, 0x66, 0xcc, 0x0d, 0xbc, 0x6c, 0x43, 0x4b, 0x78, 0xb0, 0x44, 0x86). It will be appreciated that the hash algorithms applied to data to result in first hash value 1325 and second hash value 1330 may be the same or different hash algorithm(s). It will be appreciated that the generating of first hash value 1325 may correspond to act 620 described in reference to FIG. 6 and that the generating of second hash value 1330 may correspond to act 621 described in reference to FIG. 6.

A unique random key 1335 (e.g., a hash seed) may be stored in BLE tag/sensor at time of manufacture and may also be stored in a Hardware Security Module associated with, or corresponding to, a cloud server, for example TOC 147 shown in FIG. 1. An example of a stored secret random number 1335 may be: STORED SECRET RAND: 0xd8, 0xb2, 0x44, 0xcd, 0xc3, 0xd5, 0xc2, 0x55, 0xb1, 0xc0, 0x8d, 0x5c, 0x5a, 0x8c, 0xaa, 0x33, 0x83, 0x5c, 0xc2, 0xd3, 0xc4, 0xa0, 0xbc, 0x1f, 0x16, 0x61, 0x59, 0x76, 0xbe, 0xcb, 0xc3, 0x04. Second hash value 1330, shown in FIG. 13B, may be generated by applying a hash algorithm (e.g., SHA-256) to a value that comprises example ATT Data 1320+HASH 1 SUBSET 1325+STORED SECRET RAND+ (optionally other secret data if desired). (E.g., compute SHA-256 of [0x8c, 0x89, 0xbe, 0xd6, 0x1c, 0x20, 0xde, 0x12, 0x34, 0x56, 0x78, 0x02, 0x01, 0x06, 0x0b, 0xaa, 0xfe, 0x21, 0x00, 0x03, 0x0c, 0x30, 0x1a, 0x23, 0x2c, 0x19, 0x4d, 0x14, 0xd1, 0xc1, 0x66, 0xcc, 0x0d, 0xbc, 0x6c, 0x43, 0x4b, 0x78, 0xb0, 0x44, 0x86, 0xd8, 0xb2, 0x44, 0xcd, 0xc3, 0xd5, 0xc2, 0x55, 0xb1, 0xc0, 0x8d, 0x5c, 0x5a, 0x8c, 0xaa, 0x33, 0x83, 0x5c, 0xc2, 0xd3, 0xc4, 0xa0, 0xbc, 0x1f, 0x16, 0x61, 0x59, 0x76, 0xbe, 0xcb, 0xc3, 0x04].

The result of applying SHA-256, or other similar algorithm, to message information 1320, first hash value 1325, and secret data 1335 may result in Result value 2.
2b4a950d66d5ea9a07a4c79d4612c2de [symbol] 366eb
Result value 2.

As described above with respect to result value 1, any random subset or length of original hash function result value 2 may be chosen/selected and embedded as second hash value 1330 into BLE message 1321. As shown in result value 2, twelve octets are selected in the example such that second have value 1330 may be HASH 2 SUBSET=0x74, 0x68, 0x80, 0x8b, 0x88, 0xbc, 0x5b, 0x27, 0x18, 0x98, 0xb9, 0x8d. Accordingly, message 1321 may comprise example ATT Data message information 1320+HASH 1 SUBSET 1325+HASH 2 SUBSET 1330. (E.g., message 1321 may be 0x8c, 0x89, 0xbe, 0xd6, 0x1c, 0x20, 0xde, 0x12, 0x34, 0x56, 0x78, 0x02, 0x01, 0x06, 0x0b, 0xaa, 0xfe, 0x21, 0x00, 0x03, 0x0c, 0x30, 0x1a, 0x23, 0x2c, 0x19, 0x4d, 0x14, 0xd1, 0xc1, 0x66, 0xcc, 0x0d, 0xbc, 0x6c, 0x43, 0x4b, 0x78, 0xb0, 0x44, 0x86, 0x74, 0x68, 0x80, 0x8b, 0x88, 0xbc, 0x5b, 0x27, 0x18, 0x98, 0xb9, 0x8d.)

In an example embodiment, resulting message 1321 described above may be a BLE message transmitted by a tag/sensor device (e.g., the message transmitted at act 625 described in reference to FIG. 6). Since the message count is constantly changing, contents and included hash values may change with every message 1301 transmitted at act 625. Message 1321 can be validated at TLTCU 1200 by comparing first hash value 1325 HASH 1 SUBSET with a hash value generated inside the TLTCU based on message information 1320. If the message is found to be valid (e.g., TLTCU 1200 computes a hash value based on message information 1320 that matches first hash value 1325), then TLTCU may forward message 1321 to a cloud server (e.g., TOC 147) for further potential action. The cloud server can validate the message by comparing second hash value 1330 HASH 2 SUBSET to a value generated by the cloud server and determining a match wherein the cloud server calculates a hash value based on information 1320, first hash value 1325, and secret information 1335 stored in a Hardware Security Module (or other secure storage) corresponding to the cloud server.

Bluetooth beacon-emitting tags or sensors can be installed on pallets and inside freight boxes and would be a special class of message handling. These beacons would be recognized at pickup and delivery points principally and may not be recognized while the trailer is in motion. This would prevent random trucks driving by or trucks parked nearby from appearing as freight in the trailer. A special algorithm inside TLTCU 1200 may facilitate the TLTCU reporting its location based on a “Location Tag” permanently affixed to and at a freight terminal. The location tag would be uniquely identified by UUID or similar message tags and could be one of many at a freight terminal. Alternatively, Wi-Fi access point location could identify freight terminals and freight destination points.

Freight tags would have a unique “freight” indicator UUID or other flag embedded into the BLE message to differentiate the tag from tags like tire pressure, temperature, door sensor or other operational status flags. Freight that is added to a truck/trailer and that is present when the truck/trailer moves the first 5 to 10 minutes is considered to be on the truck until the truck/trailer stops for an extended period. Freight that is present after the truck/trailer starts moving may be reported to a cloud server using an Advertisement Address corresponding to the BLE tag attached to the freight and a location corresponding to the location of where the freight was added to the trailer. It is added to a database onboard the TLTCU the along with time and loading location. This allows the TLTCU to report new freight tags only when they are added or when they disappear from the scan. When freight is removed from truck/trailer as determined by the Advertisement Address associated with the tag on the freight disappearing from the scan at or after the next start, that freight is reported as dropped off at the address where the trailer stopped. Freight can be recognized by the pallet class of a BLE beacon, or it could be recognized by the tag class of a BLE beacon. If the class of beacon indicates that it includes temperature, humidity, vibration or other environmental feature, TLTCU 1200 may query a cloud server to determine if the beacon has an environmental “watch” criterion and if it does, those parameters may be loaded into a database in the TLTCU and if metrics corresponding to the parameters fail to satisfy a “watch” criterion for a specific tag, an immediate report may be generated by TLTCU 1200 and sent to a cloud server upon the triggering event (e.g., criterion not being satisfied), and the unsatisfactory condition may be noted in a database and reported when the cargo/freight is offloaded, or an alarm may be generated to the driver to check equipment operation (such as refrigeration unit operation). Dropoff pre-alerts can be calculated in the cloud and updated periodically by knowing the destination of the freight and the periodic location of the trailer. A cloud server can calculate the distance and time to a destination assuming no stops or if the cloud knows of other freight to be offloaded, the cloud server can determine a delivery time by considering and estimating the additional time.

If a trailer is a refrigerated trailer, operation of the refrigeration unit can be reported as well as non-operation. Various detection methods can be used to determine refrigerated truck refrigeration unit operation. As described herein, a passive CAN bus listener 4700 shown in FIG. 47 may be used to listen to messages to determine useful parameters. Bluetooth-enabled CAN bus listener 4700 may apply double security to ensure integrity and authentication of messages that might be sent to the cloud and subsequently to an owner/operator.

Small trailers can use the features generally described above. Known tools can be paired with a TLTCU 1200 based on either previously equipped tools from major tool companies and small tags 4200 as shown in FIG. 42 can be attached to non-equipped tools like rakes and shovels. A special BLE tag that monitors operating hours of spark based internal combustion engines can be attached to any gasoline powered tool such as lawn mowers, leaf blowers, weed trimmers etc. Such a BLE tag can determine and report accumulated operating hours via a cloud server to facilitate providing maintenance reminders for owner operators.

A feature of TLTCU 1200 can be to notify operators of missing tools when the vehicle is put in motion. As described herein, once a vehicle TLTCU takes “inventory” based on expected BLE tags received and onboard the trailer, any missing BLE tags (e.g., missing with respect to the inventory of expected tags, may cause TLTCU 1200 to send a message to a cloud server to provide an SMS or push notification to the owner's/operator's smartphone indicating the tool or tools that are missing from the trailer.

An advantage of a fleet of BLE-tag-equipped freight is that freight terminals can be equipped with stationary gateways and freight can be tracked end-to-end. Low-cost tags can be added to boxes and pallets to track an entire shipping path of cargo or freight. Potentially even aircraft and airline freight terminals can be equipped with gateways for complete logistics chain tracking.

A feature of example embodiments disclosed herein is a priority level used to ensure that messages are handled as they should be handled. Certain safety critical messages, theft alerts, and inoperable components (refrigeration) equipment require immediate notification. Tire pressure, temperature, battery voltage, wheel tick and similar messages have a lower priority unless the tire pressure goes to zero. A message from a sensor may comprise a flag or unique UUID indicative of whether the message must be sent immediately to the cloud or the message is an informational message or status message. Cargo may be added to an onboard database or manifest and transmitted to the cloud when it is added to the trailer and again when it is removed from the trailer. Tools may be compared to the tool manifest or “tool” database. The tool manifest can be static, meaning that the same tools are present in the vicinity of the trailer every time it starts moving or the tool manifest may be dynamic, meaning that the manifest will automatically be generated when the trailer leaves a designated “home” or “office” location. Notification for missing tools may be sent at a high priority but perhaps not according to a critical priority.

An automatic pairing mechanism can be incorporated to “capture” freight and containers onboard. If taillights of a trailer are activated and the trailer/vehicle is put into motion for 5 minute, TLTCU 1200 may scan for freight tags and container tags. A freight manifest may be automatically created based on the tags that were captured during the scan.

FIG. 54A and FIG. 54B show the effect of stretching out the time between sensor advertisements. FIG. 54A shows a two-second advertisement interval while FIG. 54B shows a ten-second advertisement interval. The two-second interval may use battery 1276 roughly five times faster than the ten second interval. However, a BLE receiver module 1220 may be operated for a much longer period, in this case, perhaps 25 seconds, to ensure that the receiver module does not miss advertisements from the sensor. Operating receiver module 1220 uses significant power at TLTCU 1200. If gateway module 1220 is powered by battery 1276, the battery lifetime must be calculated and considered. Since gateway module 1220 is installed in a taillight TCU 1200, there will be periods when the tail light is not powered, for example when the trailer is sitting unattached to a towing vehicle and neither the tail light or the brake light or turn signal is active and thus power to charge battery 1276 may not be present at terminals 1262 or 1264 for long periods.

Managing operation is critical to battery life. During periods of power absence at TLTCU 1200, the interval between BLE receiver module 1220 being active can change. Sensor intervals typically are not easily changeable without reprogramming. However, a sensor's report time can be modified based on movement. As an example, a sensor can report once every ten seconds if no movement has been detected over the last hour. This will conserve power at the sensors. Movement can be detected by an accelerometer connected to the CPU inside a wireless sensor. When movement is detected, sensors can report every two seconds. This will use more power in the sensors. If a sensor's beacon interval changes, then gateway BLE receiver module 1220 may need to be changed accordingly. Alternatively, when a sensor is moving, the sensor can report every ten seconds because the gateway module 1220 will be powered when the vehicle/trailer that TLTCU may be part of is moving, and power may be applied to the TLTCU as a result of the taillight circuit, or other lighting circuit, being powered and thus the gateway module 1220 can sample for longer periods. Gateway module 1220 can perform other functionality. For example, based on idle time or long periods of no movement, the gateway module 1220 can cease all or nearly all BLE receiver intervals since it is possible a trailer that TLTCU may be part of is being stored and is not being used to transport goods. Adjusting a BLE receiver interval or turning off module 1220 altogether will conserve energy that can be used by long range radio module 1205 for responding to location requests or for reporting location information periodically.

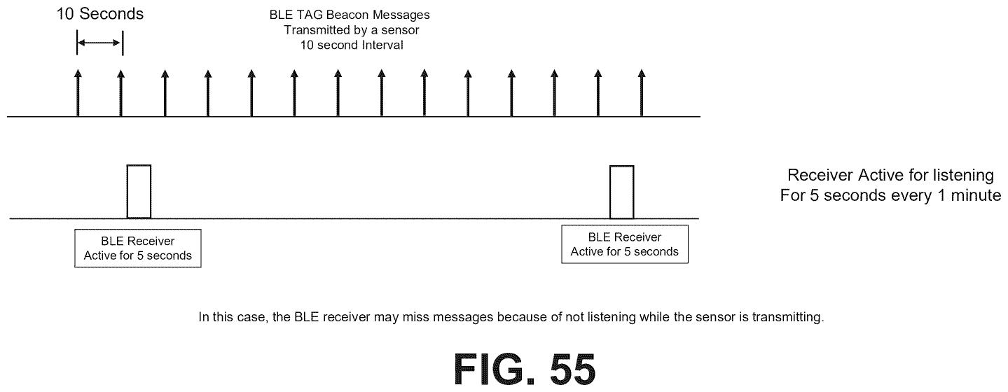

FIG. 55 shows an example of a poor selection of intervals for sensors and BLE receiver module 1220. In this example, TLTCU 1200 would exhibit very slow detection times or no detection of sensors. This is because receiver 1220 is rarely active during periods of BLE beacon advertisements. The receiver does not listen long enough to capture an advertisement/broadcast message because the advertisements are spaced too far apart.

Turning now to FIG. 6, the figure illustrates a flow diagram of an example embodiment 600. Method 600 begins at act 605. A light assembly, for example a taillight telematics control unit that comprises circuitry 1200 as described herein, may be configured to receive sensor signals from sensors that are not part of the light assembly. For example, the light assembly may be configured to receive, from at least one remote sensor, short range wireless communication protocol signals, for example Bluetooth low energy beacon signals that convey information corresponding to an unpowered vehicle, for example a trailer, onto which or into which the light assembly may be installed. At act 610, at least one remote sensor may detect at least one corresponding condition corresponding to at least one component associated with the unpowered vehicle. For example, the at least one remote sensor may detect a low tire pressure of at least one tire corresponding to the trailer, the remote sensor may detect an overheated wheel bearing corresponding to the trailer, the remote sensor may detect an open door or tailgate of the trailer, the remote sensor may detect a refrigeration unit failure corresponding to a refrigeration unit of a reefer semi-trailer, and the like. The remote sensor may detect removal of the trailer from a towing vehicle. For example, the towing vehicle or trailer may be parked overnight, or for a longer period, during which time a malicious actor attempts to disconnect, uncouple, or unhitch the trailer from the towing vehicle and steal the trailer, or the malicious actor may attempt to operate a landing gear of a trailer that is parked without being coupled to a towing vehicle, or the malicious actor may attempt to steal the component associated with the trailer, for example an outboard motor that may be mounted to a boat that is loaded onto the trailer. The at least one remote sensor may comprise a battery, thus facilitating detecting of the at least one condition even if the trailer is not coupled to, or powered by, a towing vehicle.

At act 615, the at least one sensor may generate at least one condition message, comprising condition information, corresponding to, and indicative of, the at least one condition detected at act 610. At act 620, if information to be conveyed via the at least one condition message comprises sensitive or critical information, the sensor may generate at least one first hash value corresponding to the at least one condition message. The sensor may also generate at least one second hash value at act 621. In an example embodiment, the first hash value may be generated by applying a first hash algorithm to the condition information. In an example embodiment, the second hash value may be generated by applying a second hash algorithm to information that comprises the condition information, the first hash value, and secret information, which secret information may be a secret key, that may be unique to the sensor that generates the hash value(s), that may not to be ‘known’ by a processor of a TLTCU, and that may be ‘known’ to a cloud server, for example, TOC 147 described in reference to FIG. 1. If information to be conveyed via the at least one condition message does not comprise sensitive or critical information the sensor may avoid generating at least one first hash corresponding to the at least one condition message.

At act 625, the at least one remote sensor may transmit the at least one condition message and respective first hash value, or respective first and second hash values, (if second hash values are generated by the sensor), via a short-range wireless communication link signal, for example, a Bluetooth low energy beacon signal. At act 630, a short-range wireless communication module of a light assembly, for example module 1220 corresponding to TLTCU 1200 shown in FIG. 12, may receive the at least one signal transmitted at act 625. At act 633, module 1220 may determine whether a message received at act 630 comprises a first hash value. If the message received at act 630 is determined not to comprise a first hash value, module 1220 may determine that information received at act 630 does not comprise sensitive or critical information and may not need to be authenticated. Accordingly, at act 634, module 1220 may forward the condition message information received at act 630 to a cloud server, for example telematics operation center cloud server 147 described in reference to FIG. 1, and method 600 may advance to act 665 and end.

Returning to description of act 633, if a determination is made that a message received at act 630 comprises a first hash value, at act 635 a processor of the TLTCU, for example Bluetooth module 1220 or long-range wireless module 1205, may authenticate the at least one message that was received at act 630 by generating a hash value based on condition information received at act 630 and comparing the hash value generated at act 635 to the first hash value received in the message at act 630 If the hash value generated at 635 matches, or is representative of, the first hash value included in the message received at act 630, the long range wireless module may determine that the message is most likely valid and the long range module may determine to forward the condition information message, including the condition information, the first hash value, and the second hash value, to the cloud server. At act 645, the long-range wireless module may transmit the at least one condition message and at least one respective first hash value and the at least one respective second hash value via a long range wireless communication link wherein the at least one condition message, corresponding respective at least one first hash value, and corresponding respective at least one second hash value are directed to a cloud server, for example, telematics operation center server 147 described in reference to FIG. 1. It will be appreciated that if the second hash value is based on applying a hash algorithm to the condition message and a respectively corresponding first hash value and the secret information/key, at act 645 the long-range wireless module may transmit the at least one condition message along with the first hash value and the second hash value. In an example embodiment, a first hash algorithm applied to the condition message to result in the first hash value and a second hash algorithm applied to the condition message, the first hash value, and the secret key may be the same hash algorithm. In another example embodiment, the first hash algorithm and the second hash algorithm may be different hash algorithms. It will be appreciated that in some example embodiments, instead of first and second hash algorithms being applied to the condition information and being applied to the condition information, the first hash, and a secret key, respectively, other cryptographic, authentication, verification, or data integrity algorithms may be applied to result in first authentication value(s) or second authentication value(s) instead of first hash value(s) or second hash value(s). In an example embodiment, a Bluetooth sensor may generate a first hash value by applying a first algorithm to condition message information and the Bluetooth sensor may generate a second hash value by applying a second algorithm to the condition information plus a secret value without applying the second algorithm to the condition information, the secret value, and the first hash value, in which case the TLTCU may authenticate the message received at act 630 based on the first hash value and the TLTCU may direct and authenticated condition information message to the cloud server that only includes the condition information and the second hash value.

At act 650, the telematics operations center server may receive the at least one condition message and corresponding respective at least one second hash value and at least one first hash value, and at act 655 the telematics operation center may authenticate the at least one condition message based on the at least one corresponding respective second hash value being determined to match, or to represent, a hash value determined by the TOC by applying a hash algorithm to the condition message information, the secret information, and the first hash value (e.g., the TOC may apply the same algorithm to the condition message information, the secret key, and the first hash value that the Bluetooth sensor applied to the same information to result in the second hash value). At act 660, action may be taken based on the authenticated at least one second message. For example, the telematics operation center may cause notification being directed to an operator of a towing vehicle that may be towing the trailer of an adverse condition such as, for example, an overheated wheel bearing, a low tire pressure, potential theft of the trailer or a component related thereto, or any other condition that may be sensed or detected by the at least one remote sensor. Method 600 advances to act 665 and ends.

Turning now to FIG. 11, the figure illustrates a flow diagram of an example embodiment 1100. Method 1100 begins at act 1105. At act 1110, a light assembly having telematics control unit capability, for example long range wireless communication transceiver capability and short-range wireless communication transceiver capability, may be provided in a light assembly, for example a taillight assembly, that may comprise a housing and lens that compose a sealed assembly that comprises a printed circuit board and circuitry. The circuitry may comprise a long-range wireless communication transceiver and a short-range wireless communication transceiver. The circuitry may comprise various sensors, for example, a hall effect sensor or transducer and a corresponding magnet, wherein the hall effect sensor and magnet are both mounted to the printed circuit board. The circuitry may comprise a pressure transducer, at least one accelerometer, at least one temperature and humidity sensor, and at least one light sensor. The providing of the light assembly at act 1110 may comprise manufacturing the light assembly or selling the light assembly. At act 1115, The light assembly may be installed into or onto a vehicle, such as, for example, an unpowered vehicle such as a trailer.

At act 1120, the light assembly may be provided power from lighting circuitry corresponding to the vehicle. For example, an unpowered trailer may comprise a lighting harness that may be connected to a lightning connector corresponding to a towing vehicle to which the unpowered trailer may be connected, or hitched, and the circuitry of the light assembly may receive power from electrical conductors coupled to the lighting harness that are energized when an operator of the towing vehicle operates a light, for example, applies the brakes of the towing vehicle, operates a turn signal or hazard flasher of the towing vehicle, or operates tail lights or running lights of the towing vehicle. At act 1125, a battery, which may also be part of or may be connected to the circuitry of the light assembly, may be charged when the light assembly receives power at act 1120.

At act 1130, the light assembly, or a processor of the circuitry of the light assembly, may receive at least one signal from at least one sensor. The at least one sensor may be part of the circuitry of the light assembly or the at least one sensor may be external to the light assembly and may be mounted on, in, onto, into, or otherwise located with respect to the unpowered trailer or cargo that may be hauled by the trailer. The at least one signal may be a signal transmitted by the at least one signal according to a short-range wireless protocol, for example the at least one signal may be a Bluetooth beacon signal transmitted according to Bluetooth low energy protocol.

At act 1135, a processor of the circuitry of the light assembly, for example long range module processor 1205 shown in FIG. 12, may determine whether the at least one sensor signal received at act 1130 is received from a sensor that is part of the circuitry of the light assembly. For example, the processor may determine whether the sensor signal received at act 1130 was generated by a hall effect sensor, which generating could be indicative that the light assembly has been removed from, or moved with respect to, the vehicle into which the light assembly was installed at act 1115. The processor may determine at act 1135 whether the signal received at act 1130 was generated by a pressure sensor, which generating could be indicative that the light assembly has been damaged or penetrated, for example by a drill bit drilling through either the lens or housing component that together seals an internal volume of the light assembly that comprises the circuitry and sensor.

If a determination is made at act 1135 that the sensor signal received at act 1130 was generated by a sensor that is part of the circuitry of the light assembly, method 1100 may advance to act 1156. Since the signal was generated by an internal sensor, it is secure and does not require a second securing hash action, at act 1156 the processor may direct the message information conveyed by the sensor signal received at act 1130, to a cloud server, for example, a telematics operation center server via a long-range wireless communication link. The telematics operation center server may evaluate the message information to determine a potential action to take based on the message information. For example, if the message information indicates that the light assembly has been removed from a trailer or has been damaged, the telematics operation center may initiate an operation to locate the trailer or may inform law enforcement entities that the trailer may have been stolen. If the message information transmitted by the light assembly at act 1156 is indicative that an adverse operating condition may be affecting a trailer, for example a wheel bearing is overheating, an operator of the towing vehicle may be alerted to the condition and may be advised of at least one remediation action to take with respect to the condition reported by the message information transmitted by the light assembly at act 1156. Method 1100 may advance to act 1160 and end.

Returning to description of act 1135, if a determination is made at act 1135 that a sensor signal received at act 1130 does not correspond to or was not generated by a sensor on board circuitry of the light assembly, method 1100 may advance to act 1140. At act 1140, the processor of the circuitry of the light assembly may determine whether the at least one sensor signal received at act 1130 corresponds to or comprises sensitive or urgent information. The processor may determine whether the sensor signal received at act 1130 contains sensitive or urgent information based on whether a message transmitted by the signal has a UUID indicative of an urgent message and is accompanied by a hash value, which may be referred to as a first hash value. The processor may determine whether the sensor signal received at act 1130 contains sensitive or urgent information based on content of the message information without regard to whether the first hash value accompanies message information transmitted via the sensor signal received at act 1130. If a determination is made at act 1140 that the sensor signal received at act 1130 does not contain, comprise, or otherwise pertain to critical or sensitive information, method 1100 may advance to act 1156 and continue as described above.

Returning to description of 1140, if a determination is made that a sensor signal received at act 1130 contains, comprises or otherwise pertains to critical or sensitive information, at act 1145 the processor of the light assembly may authenticate message information conveyed via the sensor signal received at act 1130 based on a first hash that may accompany the message information. If the processor of the light assembly authenticates message information conveyed by the sensor signal received at act 1130 method 1100 may advance to act 1155 and direct, to a cloud server, the message information conveyed by the sensor signal received at act 1135 along with at least one hash value, for example a first hash value or a second hash value that may have been generated by a Bluetooth sensor that transmitted the message signal that was received by the TLTCU at act 1130. At act 1157, the cloud server may authenticate the message, directed thereto at act 1155 by a TLTCU, by applying a hash algorithm to at least message information and a secret value, which may be ‘known’ by the cloud server and the Bluetooth sensor that generated the message that was received at act 1130 but that may not be ‘known’ by the TLTCU. Method 1100 advances from act 1157 to act 1160 and ends.

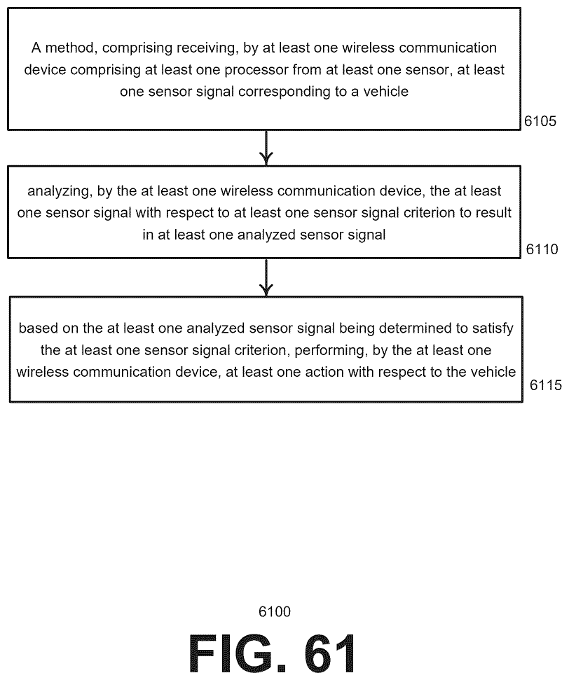

Turning now to FIG. 61, the figure illustrates an example embodiment method 6100 comprising at block 6105 receiving, by at least one wireless communication device comprising at least one processor from at least one sensor, at least one sensor signal corresponding to a vehicle; at block 6110 analyzing, by the at least one wireless communication device, the at least one sensor signal with respect to at least one sensor signal criterion to result in at least one analyzed sensor signal; and at block 6115, based on the at least one analyzed sensor signal being determined to satisfy the at least one sensor signal criterion, performing, by the at least one wireless communication device, at least one action with respect to the vehicle

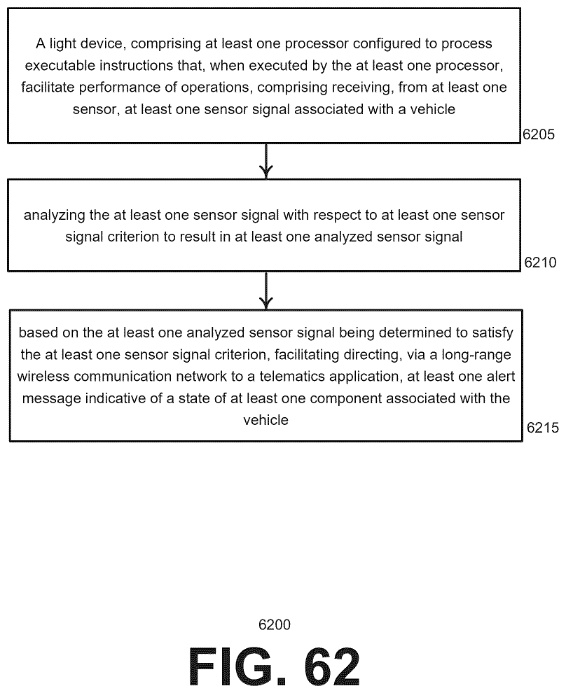

Turning now to FIG. 62, the figure illustrates a light device, comprising at block 6205 at least one processor configured to process executable instructions that, when executed by the at least one processor, facilitate performance of operations, comprising receiving, from at least one sensor, at least one sensor signal associated with a vehicle; at block 6210 analyzing the at least one sensor signal with respect to at least one sensor signal criterion to result in at least one analyzed sensor signal; and at block 6215, based on the at least one analyzed sensor signal being determined to satisfy the at least one sensor signal criterion, facilitating directing, via a long-range wireless communication network to a telematics application, at least one alert message indicative of a state of at least one component associated with the vehicle.

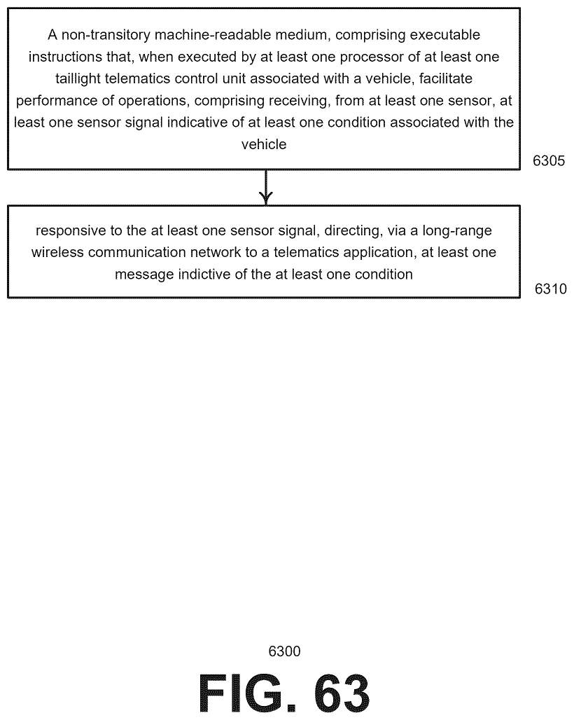

Turning now to FIG. 63, the figure illustrates a non-transitory machine-readable medium 6300 comprising at block 6305 executable instructions that, when executed by at least one processor of at least one taillight telematics control unit associated with a vehicle, facilitate performance of operations, comprising receiving, from at least one sensor, at least one sensor signal indicative of at least one condition associated with the vehicle; and at block 6310 responsive to the at least one sensor signal, directing, via a long-range wireless communication network to a telematics application, at least one message indictive of the at least one condition.

In order to provide additional context for various embodiments described herein, FIG. 65 and the following discussion are intended to provide a brief, general description of a suitable computing environment 6500 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 65, the example environment 6500 for implementing various embodiments of the aspects described herein includes a computer 6502, the computer 6502 including a processing unit 6504, a system memory 6506 and a system bus 6508. The system bus 6508 couples system components including, but not limited to, the system memory 6506 to the processing unit 6504. The processing unit 6504 can be any of various commercially available processors and may include a cache memory. Dual microprocessors and other multi-processor architectures can also be employed as the processing unit 6504.

The system bus 6508 can be any of several types of bus structure that can further interconnect to a memory bus (with or without a memory controller), a peripheral bus, and a local bus using any of a variety of commercially available bus architectures. The system memory 6506 includes ROM 6510 and RAM 6512. A basic input/output system (BIOS) can be stored in a non-volatile memory such as ROM, erasable programmable read only memory (EPROM), EEPROM, which BIOS contains the basic routines that help to transfer information between elements within the computer 6502, such as during startup. The RAM 6512 can also include a high-speed RAM such as static RAM for caching data.

Computer 6502 further includes an internal hard disk drive (HDD) 6514 (e.g., EIDE, SATA), one or more external storage devices 6516 (e.g., a magnetic floppy disk drive (FDD) 6516, a memory stick or flash drive reader, a memory card reader, etc.) and an optical disk drive 6520 (e.g., which can read or write from a CD-ROM disc, a DVD, a BD, etc.). While the internal HDD 6514 is illustrated as located within the computer 6502, the internal HDD 6514 can also be configured for external use in a suitable chassis (not shown). Additionally, while not shown in environment 6500, a solid-state drive (SSD) could be used in addition to, or in place of, an HDD 6514. The HDD 6514, external storage device(s) 6516 and optical disk drive 6520 can be connected to the system bus 6508 by an HDD interface 6524, an external storage interface 6526 and an optical drive interface 6528, respectively. The interface 6524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 6502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 6512, including an operating system 6530, one or more application programs 6532, other program modules 6534 and program data 6536. All or portions of the operating system, applications, modules, and/or data can also be cached in the RAM 6512. The systems and methods described herein can be implemented utilizing various commercially available operating systems or combinations of operating systems.

Computer 6502 can optionally comprise emulation technologies. For example, a hypervisor (not shown) or other intermediary can emulate a hardware environment for operating system 6530, and the emulated hardware can optionally be different from the hardware illustrated in FIG. 65. In such an embodiment, operating system 6530 can comprise one virtual machine (VM) of multiple VMs hosted at computer 6502. Furthermore, operating system 6530 can provide runtime environments, such as the Java runtime environment or the .NET framework, for applications 6532. Runtime environments are consistent execution environments that allow applications 6532 to run on any operating system that includes the runtime environment. Similarly, operating system 6530 can support containers, and applications 6532 can be in the form of containers, which are lightweight, standalone, executable packages of software that include, e.g., code, runtime, system tools, system libraries and settings for an application.

Further, computer 6502 can comprise a security module, such as a trusted processing module (TPM). For instance, with a TPM, boot components hash next in time boot components and wait for a match of results to secured values, before loading a next boot component. This process can take place at any layer in the code execution stack of computer 6502, e.g., applied at the application execution level or at the operating system (OS) kernel level, thereby enabling security at any level of code execution.

A user can enter commands and information into the computer 6502 through one or more wired/wireless input devices, e.g., a keyboard 6538, a touch screen 6540, and a pointing device, such as a mouse 6542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 6504 through an input device interface 6544 that can be coupled to the system bus 6508, but can be connected by other interfaces, such as a parallel port, an IEEE 1394 serial port, a game port, a USB port, an IR interface, a BLUETOOTH® interface, etc.

A monitor 6546 or other type of display device can be also connected to the system bus 6508 via an interface, such as a video adapter 6548. In addition to the monitor 6546, a computer typically includes other peripheral output devices (not shown), such as speakers, printers, etc.

The computer 6502 can operate in a networked environment using logical connections via wired and/or wireless communications to one or more remote computers, such as a remote computer(s) 6550. The remote computer(s) 6550 can be a workstation, a server computer, a router, a personal computer, portable computer, microprocessor-based entertainment appliance, a peer device or other common network node, and typically includes many or all of the elements described relative to the computer 6502, although, for purposes of brevity, only a memory/storage device 6552 is illustrated. The logical connections depicted include wired/wireless connectivity to a local area network (LAN) 6554 and/or larger networks, e.g., a wide area network (WAN) 6556. Such LAN and WAN networking environments are commonplace in offices and companies, and facilitate enterprise-wide computer networks, such as intranets, all of which can connect to a global communications network, e.g., the internet.

When used in a LAN networking environment, the computer 6502 can be connected to the local network 6554 through a wired and/or wireless communication network interface or adapter 6558. The adapter 6558 can facilitate wired or wireless communication to the LAN 6554, which can also include a wireless access point (AP) disposed thereon for communicating with the adapter 6558 in a wireless mode.

When used in a WAN networking environment, the computer 6502 can include a modem 6560 or can be connected to a communications server on the WAN 6556 via other means for establishing communications over the WAN 6556, such as by way of the internet. The modem 6560, which can be internal or external and a wired or wireless device, can be connected to the system bus 6508 via the input device interface 6544. In a networked environment, program modules depicted relative to the computer 6502 or portions thereof, can be stored in the remote memory/storage device 6552. It will be appreciated that the network connections shown are example and other means of establishing a communications link between the computers can be used.

When used in either a LAN or WAN networking environment, the computer 6502 can access cloud storage systems or other network-based storage systems in addition to, or in place of, external storage devices 6516 as described above. Generally, a connection between the computer 6502 and a cloud storage system can be established over a LAN 6554 or WAN 6556 e.g., by the adapter 6558 or modem 6560, respectively. Upon connecting the computer 6302 to an associated cloud storage system, the external storage interface 6526 can, with the aid of the adapter 6558 and/or modem 6560, manage storage provided by the cloud storage system as it would other types of external storage. For instance, the external storage interface 6526 can be configured to provide access to cloud storage sources as if those sources were physically connected to the computer 6502.

The computer 6502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one wireless communication device comprising at least one processor from at least one sensor, at least one sensor signal corresponding to a vehicle;
analyzing, by the at least one wireless communication device, the at least one sensor signal with respect to at least one sensor signal criterion to result in at least one analyzed sensor signal; and
based on the at least one analyzed sensor signal being determined to satisfy the at least one sensor signal criterion, performing, by the at least one wireless communication device, at least one action with respect to the vehicle.

2. The method of claim 1, wherein tampering with, or movement of the at least one wireless communication device with respect to the vehicle, causes the at least one sensor signal to be generated, changed, or altered by the at least one sensor.

3. The method of claim 2, wherein the at least one sensor comprises at least one hall-effect sensor and wherein the at least one sensor signal is generated, changed, or altered by the at least one hall-effect sensor being moved within a magnetic field.

4. The method of claim 3, wherein the at least one wireless communication device comprises the at least one hall-effect sensor.

5. The method of claim 3, wherein the at least one wireless communication device comprises a magnetic component that is configured to produce the magnetic field.

6. The method of claim 1, wherein the vehicle produces or affects the magnetic field, and wherein movement of the at least one wireless communication device with respect to the vehicle and within a changing magnetic field caused by the movement causes the at least one hall-effect sensor to output an electrical signal indicative of the movement.

7. The method of claim 6, wherein the at least one wireless communication device comprises at least one component that produces the magnetic field.

8. The method of claim 1, wherein a vehicle light assembly comprises the at least one wireless communication device.

9. The method of claim 8, wherein the vehicle light assembly comprises a taillight assembly.

10. The method of claim 2, wherein the at least one sensor signal is indicative of at least one pressure corresponding to the tampering with the at least one wireless device, and wherein the at least one sensor signal criterion corresponds to a configured change in the at least one pressure.

11. The method of claim 2, wherein the performing of the at least one tracking action comprises:
transmitting, via a long-range wireless communication network, an alert signal indicative of the tampering with, or movement with respect to the vehicle of, the at least one wireless communication device.

12. A light device, comprising at least one processor configured to process executable instructions that, when executed by the at least one processor, facilitate performance of operations, comprising:
receiving, from at least one sensor, at least one sensor signal associated with a vehicle;
analyzing the at least one sensor signal with respect to at least one sensor signal criterion to result in at least one analyzed sensor signal; and
based on the at least one analyzed sensor signal being determined to satisfy the at least one sensor signal criterion, facilitating directing, via a long-range wireless communication network to a telematics application, at least one alert message indicative of at least one state of at least one component associated with the vehicle.

13. The light device of claim 12, wherein the light device is coupled to the vehicle, wherein the light device comprises the at least one sensor, wherein the at least one sensor comprises at least one hall effect sensor, and wherein the light device is configured to detect removal of the light device from the vehicle based on movement of the hall effect sensor within a magnetic field that is altered by the removal of the light device from the vehicle.

14. The light device of claim 12, wherein the light device defines an inner volume, wherein the inner volume is configured to maintain an internal pressure, wherein the light device comprises the at least one sensor inside the inner volume, wherein the at least one sensor comprises at least one barometric pressure sensor, and wherein the at least one analyzed sensor signal being determined to satisfy the at least one sensor signal criterion corresponds to the internal pressure changing by an amount equal to, or greater than, a configured pressure change value.

15. The light device of claim 12, wherein the at least one sensor signal is received via a short-range wireless signal.

16. The light device of claim 15, wherein the vehicle comprises a trailer, wherein the trailer comprises the at least one sensor, wherein the at least one component is at least one component of the trailer, and wherein the at least one sensor signal is indicative of the at least one state corresponding to the at least one component of the trailer.

17. The light device of claim 15, wherein the vehicle comprises a trailer, wherein a towing vehicle is coupled to the trailer, wherein the towing vehicle comprises the at least one sensor, wherein the at least one component is at least one component of the towing vehicle, and wherein the at least one sensor signal is indicative of the at least one state corresponding to at least one component of the towing vehicle.

18. A non-transitory machine-readable medium, comprising executable instructions that, when executed by at least one processor of at least one taillight telematics control unit associated with a vehicle, facilitate performance of operations, comprising:
receiving, from at least one sensor, at least one sensor signal indicative of at least one condition associated with the vehicle; and
responsive to the at least one sensor signal, directing, via a long-range wireless communication network to a telematics application, at least one message indictive of the at least one condition.

19. The non-transitory machine-readable medium of claim 18, wherein the at least one taillight telematics control unit comprises the at least one sensor, wherein the at least one condition is at least one of: removal of the at least one taillight telematics control unit from being coupled to the vehicle or tampering with the at least one taillight telematics control unit while the at least one taillight telematics control unit is coupled to the vehicle.

20. The non-transitory machine-readable medium of claim 18, wherein the vehicle comprises a trailer, wherein a tow vehicle coupled with the vehicle comprises the at least one sensor, wherein the at least one sensor signal is received via a short-range wireless signal, and wherein the at least one sensor signal is indicative of at least one condition corresponding to the tow vehicle.
